(19) United States
(12) Patent Application Publication
(10) Pub. No.: US 2003/0052564 A1
(43) Pub. Date: Mar. 20, 2003

(54) Bipolar machines-a new class of homopolar motor/generator

(76) Inventor: Doris Wilsdorf, Charlottesville, VA (US)

Correspondence Address: WOODS, ROGERS & HAZLEGROVE, PLC., SUITE 300, 250 WEST MAIN STREET, CHARLOTTESVILLE, VA, 22902-2964, US

(21) Appl. No.: 10/139,533

(22) Filed: May 6, 2002

Related U.S. Application Data
(60) Provisional application No. 60/303,394, filed on Jul. 9, 2001.
(60) Provisional application No. 60/313,001, filed on Aug. 20, 2001.
(60) Provisional application No. 60/329,550, filed on Oct. 17, 2001.

(51) Int. Cl. H02K 1/00; H02K 3/00

(52) U.S. Cl. 310/179

(57) ABSTRACT

A novel homopolar machine, i.e. a device comprising at least one electrically conductive rotatable rotor configured to flow a current in a current path and a magnetic field source configured to apply a magnetic field penetrating the rotor and intersecting the current path when the rotor rotates, including the following inventive aspects:

The source of magnetization is one or more bar-type magnet(s) whose geometric and magnetic axes are parallel and normal to the rotation axis, respectively, so that the magnetic field penetrates the rotor in two separate zones with its direction pointing away from the axis in one zone and towards it in the other.

The current path runs along one of the zones and returns in the other, causing a Lorenz force that acts in the same rotational sense in both zones.

The current path is constrained by means of current channeling means in the rotor.

### CROSS-REFERENCE TO RELATED APPLICATIONS

“Continuous Metal Fiber Brushes”, D. Kuhlmann-Wilsdorf, D. D. Makel and G. T. Gillies, U.S. Pat. No. 6,245,440, Jun. 12, 2001, international patents pending (Canada, Finland, France, Germany, Italy, Japan and United Kingdom filed Oct. 2, 1998).

“Management of Contact Spots Between an Electrical Brush and Substrate”, D. Kuhlmann-Wilsdorf; U.S. and International (PCT) Patent Application, filed Oct. 22, 1999, U.S. Serial No. 60/105,319.

“Holder for Electrical Brushes and Ancillary Cables”, D. Kuhlmann-Wilsdorf, U.S. patent application, filed Apr. 21, 2000, Ser. No. 09/556,829.

“Eddy Current Barriers”, D. Kuhlmann-Wilsdorf Provisional Patent Application Serial No. 60/289,123, Filed May 8, 2001

“Optimizing Homopolar Motors/Generators”, D. Kuhlmann-Wilsdorf, Provisional Patent Application Serial No. 60/297,283, Filed Jun. 12, 2001

“Bipolar Machines—A New Class of Homopolar Motor/Generator”, D. Kuhlmann-Wilsdorf; Provisional Patent Application, Serial .#212657US-20PROV, Filed Aug. 20, 2001

### BACKGROUND OF THE INVENTION

1. Field of the Invention

The present invention relates to “bipolar machines” a new class of homopolar motor/generator, or in general homopolar machine, with increased voltage per current turn, the capability of operating with direct and alternating or three-phase current, and other advantages.

2. Discussion of the Background, Prior Art and Principles

Three basic types of homopolar motors have been identified that are depicted (PRIOR ART) in FIG. 1 (type I), FIG. 2 (type U), FIG. 3 (type E) and a practical example of a type III machine previously reported to have been constructed but without any evidence that in fact it ever operated (FIGS. 4 and 5).

In the past the practical use of homopolar motors and generators has been inhibited by the too large resistance of conventional graphite-based electrical brushes. In principle, multi-contact metal brushes, including fiber brushes, foil brushes and hybrid brushes, i.e. comprising resilient multi-contact metal material that will establish a multitude of electrical contact spots when loaded with light pressure against a slip ring or other smooth metal surface, have removed the previously critical bottleneck that prevented the practical use of homopolar machines. Even so there remain other problems to be overcome. The first and most important problem is less than optimal machine efficiency. To inventor's knowledge, no homopolar motor has yet achieved superior efficiency, e.g. 98% forecast for the motor in FIGS. 4 and 5.

Another obstacle against the widespread use of homopolar machines has been the need for a large number of brushes in brush holders that at the same time permit the application of a substantially constant rather light (typically less than 1N/cm²) brush force while large currents are transmitted (e.g. in the order of 650A/in²≅10⁶A/m²), and permit the almost frictionless, gradual advance of the brushes as they wear in course of time.

A third obstacle is a too low machine voltage, based on the modest voltage per current “turn”, i.e. passage of current through a rotor moving in a magnetic field, typical for known homopolar machines namely rarely exceeding 20 Volts per turn. This condition necessitates the use of several to many “turns”, and hence a multitude of brushes and brush holders, in order to attain a technologically worthwhile voltage of at least 100 Volts and optimally up to many thousands.

Lastly, homopolar motors require direct current and thus more cumbersome power supplies.

### SUMMARY OF THE INVENTION

Overcoming Four Impediments Against the Widespread Use of Homopolar Machines

Accordingly, the object of the present invention is to devise a novel design for homopolar machines, i.e. homopolar motors and generators, that overcomes the four indicated problems, by providing (i) improved efficiency, (ii) improved brush holders, (iii) increased voltage per turn and (iv) the capability of operating, interchangeably if so desired, on DC, AC and 3-phase current.

(i) Improved Machine Efficiency Through Current Channeling Means

The first of the above objects are achieved based on the inventor's recognition that a principal reason for inefficient operation of the conventional homopolar machine is the prior persistent neglect of transverse, unintended voltages in accordance with the Hall effect, and the closely related eddy current effect existing in prior homopolar machines. In fact, such Hall effect and related eddy current effect result in inefficiency which is believed to be a major reason why homopolar machines do not appear to be in practical use except for type I in kilowatt-hour meters in the meter boxes of electrical companies.

The Hall effect and the eddy current effect are the flip sides of the same coin. They arise on account of transverse voltages generated by the Lorentz force. It perpetually drives moving charges in the direction normal to the magnetic flux and their momentary velocity vector, in accordance with the vector cross product [v×B],—which is, of course, the very basis of electric motor and generator action (compare FIG. A). Yet the Hall effect, whereby transverse voltages are generated in horizontal conductors that carry lengthwise currents in vertical magnetic fields, for example, is not widely known. This is so because currents are overwhelmingly conducted through wires, and wires prevent any significant currents in transverse direction. Consequently, the joule losses engendered by the Hall effect are negligible in the coils of conventional machines and thus remain hidden. However, in the locally two-dimensional rotors of homopolar machines at right angles to a strong magnetic flux, the discussed transverse components of the current driven by the Hall effect, with their associated joule heat losses, can be sizeable.

The same effect exists also in the absence of voluntary electrical currents in any conductor that moves in a magnetic field. In this situation the effect is best understood in terms of cyclotron movements of charges in a magnetic field, so well known from high-energy particle accelerators and intensely studied by astronomers as the source of a wide range of cosmic electromagnetic radiation from x-rays to radio wavelengths. To wit, a moving metal in a magnetic field represents equal and opposite currents, one of the positive ions that form the rigid structure of the material, the other of the mobile conduction electrons.

While the Lorentz force acts on all of those potential current carriers, only the conduction electrons are mobile enough to respond with cyclotron movements and in the process generate Joule heat losses. Currents deliberately imposed by EMF's in two-dimensional conductors, such as rotors in homopolar motors, similarly carried only by the conduction electrons, represent only (typically minor) perturbations and do not remove the eddy current effect.

It has been recognized according to the present invention that low-efficiency operation of homopolar motors, as for example the one shown in FIG. 3 reproduced from reference [4], is due to eddy currents circulating in the cylindrical rotor. Namely, as seen from ref. [4], the torque required to externally rotate the axle of the machine when disconnected from the current supply was found to rise by about thirty percent when the magnet current was turned on. Moreover, changing the rotation speed from 2000 rpm to 2500 rpm increased the extra loss with turned-on magnetic field roughly in proportion to the velocity increase, as expected from theory. The combined losses through the discussed Hall and eddy current effects are expected to be no less and quite possibly larger when homopolar machines are operated normally, i.e. with an intended current flow through the rotor(s).

According to the present invention, this problem of less than optimal machine efficiency is addressed by providing “current channeling means”, i.e. structures that constrain the current to flow in the intended path, inhibiting any significant component of the current path at right angles to the intended direction of the current path. In one preferred form, current channeling means are substantially parallel slits or cuts through the thickness of the rotors at right angles to the local direction of motion during normal operation that extend in the intended direction of the current. This form of current channeling means is from here on variously called “eddy cuts” or “eddy current cuts”. Another form of current channeling means that similarly extend through the thickness of the rotors at right angles to the local direction of motion during normal operation and extend in the intended direction of the current path, are assemblies of mutually electrically insulated, substantially parallel electrical conductors that are extended in the intended direction of the current path but have a narrow spatial dimension at right angles to both the intended current path direction and the magnetic field. Particular examples of such current-channeling means are assemblies of substantially parallel metal fibers or wires that are mutually electrically insulated, such as in many composites with insulating matrix material, and extend in the direction of the intended current flow. Another example are assemblies of substantially parallel, electrically mutually insulated metal foils whose short dimension is normal to both the direction of the intended current path and the direction of the magnetic field. The insulating material between the substantially parallel electrical conductors that are extended in the intended direction of the current path and thereby channel the current serve the same function as eddy cuts and, together with these, are called “eddy current barriers” or “eddy barriers” for short.

Thus, according to one embodiment of the present invention there is provided a novel homopolar machine including a stator and at least one electrically conductive rotatable rotor configured to flow a current in a current path when it is driven by the current source; a magnetic field source configured to apply a magnetic field penetrating the rotor and intersecting the current path when the motor is driven by the current source; current channeling means extending through the thickness of said rotor provided so as to be parallel to said current path during rotation of said rotor and thus typically but not necessarily to be at right angles to the local direction of motion of the rotor during normal operation.

According to one aspect of the invention, the rotor includes current channeling means defining the current path.

According to another aspect of the invention, the rotor further includes current channeling means intersecting a circumferential surface.

According to a second embodiment of the present invention, there is provided a novel homopolar generator configured to generate a current when rotated by a mechanical torque, including at least one electrically conductive rotatable rotor configured to flow a current in a current path when the generator is rotated by a mechanical torque; a magnetic field source configured to apply a magnetic field penetrating the rotor and intersecting the current path when the generator is rotated by a mechanical torque; and current channeling means extending through the thickness of said rotor provided so as to be parallel to said current path during rotation of said rotor, and thus typically but not necessarily to be at right angles to the local direction of motion of the rotor during normal operation.

As with the motor of the invention, it is advantageous in the generator of the present invention that the rotor further includes current channeling means defining the current path. As with the motor of the invention, it is advantageous in the generator of the present invention that the rotor further includes current channeling means intersecting a circumferential surface.

(ii) Improved Brush Holders: “Brush Plates”—Holders for Large Numbers of Brushes.

In order to increase the machine voltage, homopolar machines comprise “sets” of mutually electrically insulated but mechanically fused and geometrically similar electrically conductive rotatable rotors through which the machine current is guided consecutively from, say, the stator to rotor 1, consecutively through rotors 2,3 . . . to rotor N, and back to the stator. The advantage herein is the fact that the voltages for each current “turn” (i.e. as the current passes through the magnetic field that penetrates the respective rotor) add much like the voltages in a set of electrical batteries connected “in series”. In fact “current turns” in homopolar motors are the equivalent of wire turns in electric motors with wound armatures as has been recognized already long ago. Thus Langsdorf [1] writes in this regard on his p.89:

. . . higher voltages may be obtained in acyclic (i.e. homopolar) machines by using several inductors (i.e. rotors) in series. Such a machine, built by the General Electric Company [5] was rated at 300 kv at 550 volts at 3,000 rpm; and the Westinghouse Electric and Manufacturing Company [6] built one in 1906 that was rated at 2,000 kw, 260 volts, at 1,200 rpm. However, such multistage designs offer no advantage over conventional commutated types (i.e. conventional motors/generators with coils of many windings) and indeed they introduce formidable new problems of brush maintenance and renewal because of the large number of brushes required to connect the several individual inductors in series. Carbon and graphite brushes tend to disintegrate rapidly when subjected to high current density, especially at the high peripheral speeds which are unavoidable in acyclic machines; when several brushes are in parallel to provide the necessary contact area, they exhibit the undesirable feature of selectivity, one of them tending to take more than its proper share of the total current thus wearing out more quickly than would otherwise be the case, and throwing extra load upon the remaining brushes. Metallic brushes tend to become abraded with resultant undue wear on the surface of the collector ring.

The natural field of usefulness for the acyclic generator is clearly in those applications which require heavy current at low voltage, as in electrolytic and electrometallurgical processes, resistance welding, and in supplying the excitation of cyclotrons and synchrocyclotrons [7] A unit now in process of development by the Allis-Chalmers Manufacturing Company, rated at 80,000 amp at 75 volts is illustrated in FIGS. 2-40 and 2-41 (reproduced as FIGS. 4 and 5). An important feature of the design is the use of liquid metallic collectors consisting of a mixture of 56 percent sodium and 44 percent potassium by weight, as in a patent issued [8] to Dr. A. H. Barnes. It is anticipated that this unit will have a full-load efficiency of 98 percent.

Yet, there is no evidence that any of the three mentioned machines with their apparently superior characteristics has ever been successful. In particular the machine of FIGS. 4 and 5 that (judging by FIG. 5 at 80,000A×75V/750(w/hp)≅8000 hp) would have had an impressive power to weight ratio, is unlikely to have ever been successfully completed. Besides other foreseeable difficulties, the liquid metal Na—K brushes therein presumably posed insurmountable problems. Namely, development of a very similar brush system, also based on liquid NaK, was abandoned at the Annapolis Naval Research Laboratory after many years of intense effort as recently as 1998, when liquid metal leakage through the seals could not be prevented. Additionally, on account of the Hall and eddy current effects already discussed, its efficiency is unlikely to have ever approached 98% even if the liquid metal brush system had worked perfectly.

More importantly yet, a current path with “turns” requires the consecutive passage of the current through at least one brush into and at least one other brush out of any particular rotor, for a total of at least 2N_{R} brushes if N_{R} is the number of nested, stacked or otherwise assembled rotors in a “set” of rotors. Therefore, if the individual rotor (in all significant prior designs accounting for n=1 i.e. one current turn) provides a voltage of ₁V_{R}=10 [V], a desired V_{M}=220 [V] machine voltage requires a minimum of

N_{R}=V_{M}/₁V_{R}=22 (1)

rotors, and requires a minimum of 2N_{R}=44 brushes Moreover, the relatively low voltages in previous homopolar machines (W_{M}) entail correspondingly high currents at same total nominal (i.e. disregarding losses) machine power W_{M}. Thus for a W_{M}=5000 hp=3.8×10⁶ watt homopolar machine of V_{M}=220V (which in fact is already high in terms of previous designs), a current of

i=W_{M}/V_{M}=W_{M}/N_{R1}V_{R}=3.8×10⁶[w]/220[V]=17,300[A] (2)

is required which puts a considerable burden on the external electrical connections (i.e. “buses”) that supply the machine power.

Correspondingly, also, a large number of electrical brushes is needed that, in practice, limits the design and forecast use of homopolar machines. Even though multi-contact metal brushes¹² have in principle removed the previously insurmountable problem of the associated power loss, namely equivalent to roughly IV per traditional graphite-based brush, including electrical and mechanical power loss, as compared to about 0.1V per brush for multi-contact metal brushes, the installation, cost and maintenance of electrical brushes in homopolar machines remain a problem Specifically, the current density in multi-contact metal brushes is, empirically, so far limited to j_{B,max}≅2×10⁶[A/m²]. Moreover, adsorbed moisture is needed for brush operation outside of liquids, and this is depleted unless humidity has access to slip ring areas between brushes. Therefore, again empirically to-date, in the open atmosphere at reasonable humidity or in a moisturized CO₂ atmosphere, only a fraction f_{B} of available slip ring area may be covered with brush foot prints, at maximum, to present best knowledge, f_{Bmax}≅50% of slip ring area (compare ref. [12]). Furthermore, again in order to not deplete adsorbed water, according to present best empirical experience the length of continuous metal fiber brush foot print in sliding direction, L_{BS}, should not exceed, say, L_{BSmax}=5 cm. And finally, with large numbers of rotors with parallel slip rings, one does not want to unduly extend the machine length and therefore will try to make slip ring widths, Δ, as small as possible. But this in turn is limited by the needs of brush construction and to avoid short circuits among brushes on neighboring slip rings. It is therefore tentatively concluded that at a minimum a slip ring width of Δₘᵢₙ≧0.25 cm=2.5×10⁻³ [m] is required.

The result of these considerations is that numerous brushes are needed on a minimum total slip ring area of

A_{S}≧2N_{R}i/f_{Bmax}j_{Bmax}=2W_{M}/(₁V_{R}f_{Bmax}j_{B,max}) (3a)

which, as seen, is independent of N_{R}, the number of rotors used, but is inversely proportional to ₁V_{R}, the voltage per turn. Thus for the present example of a W_{M}=5000 hp 3.8×10⁶ watt machine with ₁V_{R}=10[V], the minimum slip ring area is

A_{S}≧2×3.8×10⁶[w]/{10[V]×0.5×2×10⁶[A/m²}}=0.76[m²], (3b)

while in this example, i.e. with V_{M}=220V, ₁V_{R}=10V and N_{R}=V_{M}/₁V_{R}=22, the minimum total slip ring width, and hence the extra machine length on account of slip rings, is a modest

L_{S}≧2N_{R}×Δₘᵢₙ=2×22×2.5×10⁻³=0.11 m. (3c)

However, the minimum number of brushes (N_{B}) on slip rings of width Δₘᵢₙ, with maximum brush length in sliding direction L_{Bmax}=5 cm and with f_{Bmax}=½ slip ring occupancy, is large, namely

N_{B}≧½A_{S}/(fₘₐₓL_{Bmax}Δₘᵢₙ)=½0.76[m²]/{5×10⁻²[m]×2.5×10⁻³[m]}=3,040 (3d)

This is such a formidable number of electrical brushes that one will prefer to increase the slip ring width to, say, Δ=1 cm, and the working area per brush to A_{B}=5 cm² so as to reduce the number of required brushes for the discussed hypothetical W_{M}=5000 hp motor to

N_{B}=½A_{S}/A_{B}=½×0.76/5×10⁻⁴=760 brushes (3e)

The above example will have made it clear that the future of homopolar motors depends on decreasing the number of brushes and on simplifying their installation and management. As seen, this problem is independent of the number of turns. As it is, a large number of turns, N_{R}, is very beneficial since it increases the machine voltage, thereby inversely decreasing the required current at fixed machine power, and thus the required wiring/busing to and from the machines, but it is no aid in the brush problem.

According to the present invention, the discussed problem of the cumbersome management of large numbers of individual brushes, in individual brush holders, is alleviated by the use of rigid “brush plates,” comprising mutually electrically insulated parallel metal strips, from which, in lieu of individual brushes, protrude segments of multi-contact metal brush strips that slide on correlated parallel mutually insulated slip rings. Between segments of brush strips, gaps ought to be left for the access of moisture where needed. The brush plates are configured to simultaneously conduct current to or from the brush strips, to apply brush pressure to the brush strips, and to geometrically advance the brush strips as they wear.

Thus, according to one embodiment, of the present invention there is provided a novel homopolar machine configured to be driven by a current source when operating in motor mode and to generate a current when operating in generator mode, including a plurality of mutually electrically insulated conductive rotatable rotors configured to flow a current in a path from a stator consecutively through the rotors and back to the stator; a magnetic field source configured to apply a magnetic field penetrating the rotors and intersecting the current path; a plurality of electrical brushes in the form of strips of multi-contact metal material for providing a low-resistance current path between mutually electrically insulated slip rings on said rotatable rotors, and at least one brush plate for providing a low-resistance path between said stator and said electrical brushes in the form of strips of resilient multi-contact metal material, wherein said at least one brush plate is configured to at the same time apply a mechanical force and establish an electrical connection between said multi-contact metal brush strips and correlated slip rings on said plurality of electrically conductive rotatable rotors.

(iii) Increased Voltage Through the Bipolar Design

(a) General Considerations

In line with eqs. 1 to 3, it would be highly desirable to increase the value of ₁V_{R} in order to proportionately increase the machine voltage, V_{M}, at fixed W_{M} thereby to simul-taneously reduce the required current i the number of rotors N_{R}, the total slip ring area A_{S}, and the number of brushes N_{B}. Physically, for a cylindrical rotor of radius R_{R}, that is inter-sected over length L_{R} by a radial magnetic flux B and spins about its axis with angular velocity ω=RPM/60[rad/sec], i.e. surface speed V_{R}=ωR_{R}=(RPM/60) R_{R}, it is ₁V_{R}=n [v_{R}×B] L_{R}. If, as is generally the case, v_{R}, L_{R} and B are mutually perpendicular,

₁V_{R}=nv_{R}BL_{R}=n(RPM/60)R_{R}L_{R}B (4)

Here n is the number of times the flux intersects the rotor (a factor that will be explained below). Similarly, for a circular rotor of radius R_{R} spinning about its rotational axis at circumferential speed v_{R} while intersected by axial flux B between outer and inner radii R_{R} and R_{A}=αR_{R}

₁V_{R}=½nv_{R}R_{R}(1−α²)B=½n(RPM/60)R_{R}²(1−α²)B (5)

Consequently, the desired increase of ₁V_{R} can be accomplished by raising any one or more of n, v_{R} (i.e. RPM), R_{R}, L_{R} and B. Previous designers of homopolar machines have considered the same factors except for n, but opportunities for increasing ₁V_{R} are limited, as follows:

(i) R_{R} and L_{R} are limited by the volume of the intense magnetic flux field, and previously no solution was found to extend R_{R} and/or L_{R} to much above about 1 m

(ii) The magnitude of the flux density B is linked to the magnets used. Very roughly, B=1 tesla for permanent and electromagnets, and B=4 tesla for superconducting magnets. This increase of B and attendant increase of ₁V_{R} is the reason why over the past several years only superconducting homopolar machines have been under serious consideration. However, the requisite cryogenic installations are costly and voluminous and, further, are feasible only for large machines, i.e. are ruled out for use in passenger cars and hand-held tools, for example.

(iii) v_{R} is limited by, firstly, the maximum safe, long-term sliding speed of multi-contact electrical brushes that empirically is about 30 m/sec. Secondly, in order to adapt high rotation speeds of homopolar machines to practical applications, e.g. about 100 to 150 RPM for many naval (shipboard) uses, reduction gears are needed. These add to the cost and volume and, critically for naval applications, are avoided because of noise.

(iv) n has apparently not been considered in the past.

The present invention addresses all four of the above factors, i.e. (i), (ii), (iii) and (iv) above, as follows.

b) Increased Value of L_{R}

In one form of the invention, the stationary magnetic field source is a bar magnet or a plurality of adjoining similar bar-type magnets, in the shape of a flattened rod that is elongated in the direction of the rotation axis and whose axis of magnetization is at right angles to the rotation axis and which is enclosed within a set of nested mutually electrically insulated rotatable cylindrical rotors, as indicated in FIG. B. The cylindrical rotors are provided with axially oriented eddy current cuts or other current channeling means over all of their length except a zone at one end, dubbed the “return end” that extends beyond the length of the source of magnetization. The nested rotatable cylindrical rotors extend beyond the length of the stationary magnetic source also at the opposite end that is provided with eddy cuts or other current channeling means, dubbed the “entry end”.

The strips of north and south poles of the source of magnetization thus generate two stationary diametrically opposite bands of magnetic flux source of length L_{R}, designated as (a) and (b), that extend parallel to the axis, wherein the flux radially penetrates the cylindrical rotors in the same direction on both the (a) and the (b) side. The flux return for the magnetic field between the (a) and (b) sides of the described source of magnetization is a thick-walled tubing of magnetically soft material that surrounds the cylindrical rotatable rotors (see FIG. B).

In order to create the requisite current paths that intersect the magnetic flux at right angles, the cylindrical rotors may be provided with slip rings about both of their ends, and with at least one electrical brush per slip ring that is electrically insulated from all brushes on parallel slip rings, which brushes are positioned in at least one of the zones of magnetization. In such an arrangement, current may be fed into a brush, say brush 1e, sliding on the slip ring on the entry end of the innermost rotor, dubbed rotor #1, and be extracted from rotor #1 by the at least one electrical brush on the slip ring on the opposite side, say brush 1r at the return end of rotor #1.

The voltage difference between brushes 1e and 1r, and in fact any pair of brushes on opposite ends of one rotor, is then given by eq. 4 with n=1 and R_{R} the radius of the cylindric-a1 rotor. Unlike L_{R}, the value of R_{R}, which normally will approximate the separation distance between the poles of the source of magnetization, cannot be almost arbitrarily increased since this requires the corresponding increase of the radius of the flux return cylinder with a weight penalty that rises as R_{R}², whereas at constant current the voltage, and thus the motor power, increases only linearly with R_{R}. By contrast, at same current and other parameters, to a first approximation the motor power as well as the weight rise proportionally with L_{R}.

A second “turn” may be added by electrically connecting brush 1r to brush 2e sliding on the entry end of rotor #2 in the same zone, e.g. (a), whence the current flows to brush 2r on the return end, on to brush 3e and so on. The advantage of this arrangement will be a possible almost indefinite increase of L_{R}, to potentially much larger values than the previously achievable maximum of up to 1 m, e.g. in podded ship drives perhaps up to 12 m or even more.

(c) Flux Density

In the present patent application, the use of permanent magnets is envisioned. A companion patent application that is in preparation, adapts the invention also to super-conducting magnets as given in “Bipolar Machines with Superconducting Magnets”, Doris Kuhlmann-Wilsdorf, Provisional. Patent. No. 60/329,550, Filed Oct. 17, 2001

(d) Increase of v_{R}

Since in the described arrangement, the slip rings are positioned beyond the magnets, they may be narrowed to a radius well below R_{R}, depending only on considerations of mech-anical construction that will be discussed below. Thus by halving the slip ring radius, both the brush sliding speed, v_{R}, and the dimensionless brush wear rate may be halved at same motor rotation speed. This is a valuable option when high rotation speeds are acceptable, but less so for large ship drive motors which require low rotation speeds.

(e) Increase of “turns” to n=2 per Rotor

If in the current path described under (i) above, brush 1r were to be connected to a brush 2e that is situated on the (b) side, the current passage from 2e to 2r would cause a potential difference of opposite sign than if 2e were situated on the same side as brush 1e, i.e. on the (a) side. Namely, in the geometry of FIG. B, current passages from return end (r-end) to entry end (e-end) or vice versa cause equal and opposite potential differences on the (a) and (b) side, since the current path is reversed relative to the cross product of v_{R} and B. Correspondingly, instead of connecting brushes 1r and 2e on the (a) side, or similarly both brushes on the (b) side, one may let the current flow from the e-end to the r-end on the (a) side and cycle back from the r-end to the e-end on the (b) side thereby doubling the potential difference within one rotor, thus obtaining n=2 in equation 4. Machines with this design, in which n=2, are dubbed “bipolar”.

Not only is the bipolar design very favorable in terms of the voltage difference, but it halves the number of required brushes per unit potential difference since it does not require any brushes on the return end, i.e. the r-end. This is so because, as already indicated, the r-end is made to be free of eddy current cuts or other current channeling means so that (a) and (b) brushes would be short-circuited on the r-end, while (a) and (b) brushes are electrically insulated on the e-end. The only requisite connections between brushes are therefore, in general, from the (b) brush on rotor n to the (a) brush of rotor (n+1).

The modified bipolar design is also possible with circular instead of cylindrical rotors. In that case the requisite equal and opposite areas of magnetic flux may be generated by two pairs of horse-shoe-type magnets that face each other across the plane of the rotors.

(iv) Operation with DC, AC and/or 3-Phase AC

While positioning of more than one brush on one slip ring on rotors without eddy cuts or other current channeling means, is tantamount to short-circuiting them, brushes on slip rings that are intersected by eddy barriers are mutually electrically isolated at distances ex-ceeding the eddy cut spacing, respectively the spacing between the conductors in other forms of current channeling. Thus by omitting the return end that in the already discussed design is free of eddy cuts or other current channeling means, and instead extending the current channeling from end to end, any bipolar motor can be used with DC, AC or 3-phase current, depending on electrical connections among brushes. Specifically, positioning separate brushes on the (a) side and on the (b) side, both on the e-end and on the r-end, and designating them as (a,e), (a,r), (b,e) and (b,r), respectively, the already described DC operation is obtained by interconnecting the (a,r) and (b,r) brushes for any one rotor and electrically connecting, in general terms, the (b,r) brush(es) of rotor (n) to the (a,e) brush(es) of rotor (n+1).

Operation with alternating current, whether one phase or three-phase, requires treating the (a) and (b) sides as separate motors and operating them on the + and − phase by means of rectifiers, but in opposite directions. In that case, therefore, there are no connections between any (a) and (b) brushes, and the turns from rotor to rotor are accomplished by, in general terms, connecting brush (a,r) of rotor n to brush (a,e) of rotor (n+1) and similarly connecting brush (b,e) of rotor n to brush (a,r) of rotor (n+1). Methods for efficiently changing brush connections in individual machines so as to switch between DC and AC, will have to be worked out and may be cumbersome when large numbers of brushes are involved, although the use of brush plates may offer a solution. However, reversal of rotation direction is effected very simply by interchanging the + and − phase connections to the machine.

Alternatively, according to the present invention, operation that can be easily switched between DC and AC or 3-phase power, is accomplished by “in tandem” operation of two similar machines, i.e. by means of two similar machines operating on the same axle. When driven by direct current, the two motors may be electrically connected in series, in which case the power delivered to, or extracted from, the axle is twice that for the single machine at same current but at twice the applied voltage needed for, or delivered by, one machine. This, then, is a means of increasing the machine voltage. Alternatively, the “in tandem” machine pair may be electrically connected in parallel. In that case, again, the power delivered to or extracted from the axle is twice that for the single machine but at same voltage and doubled current. For AC operation of the same machines in tandem, rectifiers are placed in the electricity supply to the two machines, and are hooked up in one direction for one machine and in the opposite direction for the other machine, e.g. for a +phase input into the (a) side of one machine and a −phase input into the (b) side of the other machine.

While both motors and generators may be operated with AC as indicated, the output of bipolar generators will be rippled DC. There is as yet no proposal of how to generate alternating current by means of the bipolar design.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. A is a perspective view of the ideal morphology of electrical machines

FIG. B is a perspective view of the magnet, rotor and flux return morphology of bipolar machines with cylindrical rotors (same as FIGS. 15A and B).

FIG. 1 (PRIOR ART) is a perspective view of a type I homopolar generator according to Faraday (1831) that if connected to a current source instead of to a galvanometer will serve as a motor.

FIG. 2 (PRIOR ART) is a cross section through a type II homopolar motor/generator;

FIG. 3 (PRIOR ART) is a perspective view, partly in section of a recent type III homopolar motor/generator.

FIG. 4 (PRIOR ART) is a side elevation, partly in section, of a type m homopolar generator of 1959;

FIG. 5 (PRIOR ART) is a photograph of the homopolar generator of FIG. 4;

FIG. 6 is a sketch of the geometry of eddy current barriers, whether eddy cuts or insulating material between electrically conducting material in any form of current channeling means, according to the present invention; (A) for type I machines, (B) for type II machines and (C) for type m machines.

FIG. 7A is a perspective view of the magnet arrangement in a bipolar machine witch circular rotors

FIG. 7B is a perspective view lengthwise cross section through a bipolar machine of the type in FIG. 7A without showing the magnets.

FIG. 7C is a cross-sectional view and indicated current flow lines normal to the axis of the bipolar machine with circular rotors shown in FIGS. 7A and 7B.

FIG. 8A is a cross section of “scarfed” slip rings provided with insulating “separators” between neighboring slip rings suitable for any homopolar or bipolar machine.

FIG. 8B is like FIG. 8A but with the slip ring metal extending onto one side of each insulating “separator” between neighboring slip rings.

FIG. 8C is like FIGS. 8A and B but with separators eliminated by slip ring shaping

FIG. 8D shows slip rings with angled metallic extensions with scarfed brushes

FIG. 9A is semi-schematic view of brush holder strips from inside a brush plate

FIGS. 9B and C illustrate methods of fastening fiber brush material to brush holder strips (A) by means of dove tailing and (B) by means of conductive adhesive.

FIG. 10A is a perspective view of brush plate with flexible joints and bridge connectors between brush holder sections.

FIG. 10B illustrates the interfacing of brush plates with a stationary rigid bridge.

FIG. 11 is a lengthwise cross section of brush plates with brushes and rigid bridges to clarify the problem of brush and brush plate adjustment to non-uniform brush wear.

FIG. 12A is a perspective view with partial cut-out of two similar bipolar machines with circular rotors in tandem, arranged for operation with alternating current.

FIG. 12B is a perspective view of one of the machines in FIG. 12A but without cutout showing a possible brush plate arrangement.

FIG. 13A is a perspective view of part of a brush plate with fibers slanted in the plane parallel to the sliding direction

FIG. 13B is a plan view of FIG. 13A

FIG. 13C is a perspective view of part of a brush plate with fibers slanted in the plane normal to the sliding direction, i.e. in “scarfed” orientation.

FIG. 14 shows lengthwise cuts through a bipolar type machine with circular rotors and reduced slip ring diameters for minimizing brush sliding velocities, with less (top) and more detail (bottom).

FIG. 15A shows a schematic perspective view of the axle, magnet and flux return of a bipolar machine with cylindrical rotors (same as FIG. B (top).

FIG. 15B shows a cross sectional view of the machine of FIG. 15A, including the set of rotors with indicated magnetic filed lines (same as FIG. B bottom)

FIG. 15C is a schematic perspective view of the same machine as in FIGS. 15A and 15B, showing rotors, rotor rims and brushes with indicated current flow and connections between brushes by means of bridges.

FIG. 15D shows a cross sectional view of a machine as in FIGS. 15A to C but with an alternative arrangement of brushes on two slip rings of a bipolar machine

FIG. 16 is a schematic lengthwise cut of a bipolar machine with cup-shaped rotors, clarifying the mechanical construction.

FIG. 17 illustrates method 1 of making a bipolar machine with cylindrical rotors. (A) Perspective view of stack of layered sheets half-way wound for making a set of cylindrical rotors. (B) Perspective view of assembled machine. (C) Adjoining, aligned magnets in tray or shaped tubing that replace one long magnet.

FIG. 18 is a perspective view with cut-out that illustrates method 2 of making a set of cylindrical rotors of a bipolar machine.

FIG. 19 shows a method by which eddy cuts may be made in the course of method 1 or 2 of making bipolar machines with cylindrical rotors.

FIG. 20 illustrates how, in method 2, slip rings and separators can be made for a bipolar machine with cylindrical rotors. (A) Section through rotors, rims, slip rings and barriers between slip rings. (B) Enlargement of part of A. (C) Perspective view of a pre-formed slip ring and separator that may be used in method 2 of making bipolar motors with cylindrical rotors.

FIG. 21A is a cross section parallel to the axle of an assembled bipolar machine with cylindrical rotors and slip rings of reduced diameters, showing the arrangement of the various components.

FIG. 21B shows a detail of (A) to clarify how pre-formed slip rings with reduced radii can be fitted to the cylindrical part of the rotors.

FIG. 22 is a lengthwise cut through a rotor made of a current channeling material with attached slip rings and bottom strips. (A) Overview of one particular configuration. (B) Alternative configurations of slip rings and brushes. (C) Overview of another particular configuration. (D) Additional alternative slip ring/brush/brush plate configurations.

FIG. 23 is a schematic side view of a long bipolar machine composed of three sections that have been fitted together.

FIG. 24 clarifies three different ways for electrically interconnecting brushes in a bipolar machine with cylindrical rotors and eddy current barriers in the form of eddy cuts or any other form of current channeling means that extend the whole length of the machine. (A) Outline of the rotors. (B) connections and current flow in the basic bipolar design. (C) Connections and current flow when the two sides of the machine are operated with DC “in parallel”. (D) Connections and current flow lines for use with AC current.

FIG. 25 identifies symbols used in calculating the performance of a bipolar machine with cylindrical rotors.

FIG. 26 illustrates the basic geometry of rails and fibers in the manufacture of the fibrous parts of rail strips with fibers slanted in accordance with FIG. 13.

FIG. 27 perspective views of rails with profiling for making different fiber slants. (A) Rails with the morphology of concrete rebars. (B) Rails with protrusions. (C) Cross sectional view of (B).

FIG. 28 shows fiber tow wrappings on rails in making the fibrous parts of brush strips. (A) simple winding. (B) Winding on hooks on either side of pair. (C) Figure-eight winding.

FIG. 29 shows different ways of crimping a sheath about the rails and fibers wound on them in the manufacture of brush strips. (A) Crimping by means of segments of a slotted tubing. (B) Crimping by means of a shaped metal sheath in conjunction with a shaped rail.

FIG. 30 is a cross section of a rail including a cavity, with fibers wound on it, before and after crimping a sheath over it

FIG. 31 shows cross sections of rails with fibers after crimping. (A) Protrusions or hooks as in FIGS. 27B/C and 28B after crimping. (B) Fibers after figure-eight winding as in FIG. 28C after cutting the two rails apart in the manufacture of brush strips.

FIG. 32 is a schematic top view of a production line for brush strips, including cutting the fibers between rails after embedding them in a temporary matrix, curving the pieces to the shape of their intended brush plates, and cutting them into sections into lengths.

FIG. 33 (left) is a top view of a completed brush strip, and (right) is a cross section of a completed brush strip with inclined fibers as in FIG. 13A, 13B or 13C.

FIG. 34 is a perspective view of wound fibers on a rail pair, temporarily stitched on either side of the future cut of the fibers between the rails as in FIG. 32, with an easily removable stitching, to facilitate insertion of the future brush plate on a series of slip rings.

### DESCRIPTION OF THE PREFERRED EMBODIMENTS

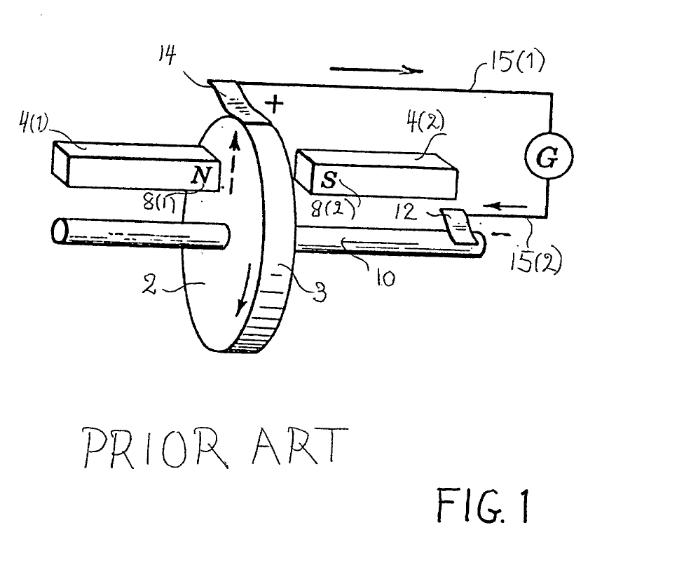

A. Regarding Current Channeling Means (FIGS. 1 to 6)

Referring now to the drawings, wherein like reference numerals designate identical or corresponding parts throughout the several views, the present invention will now be described.

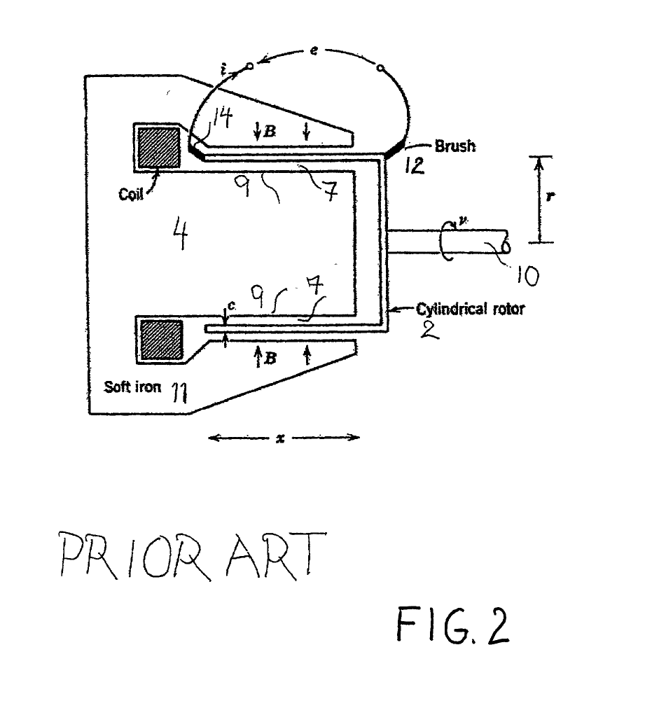

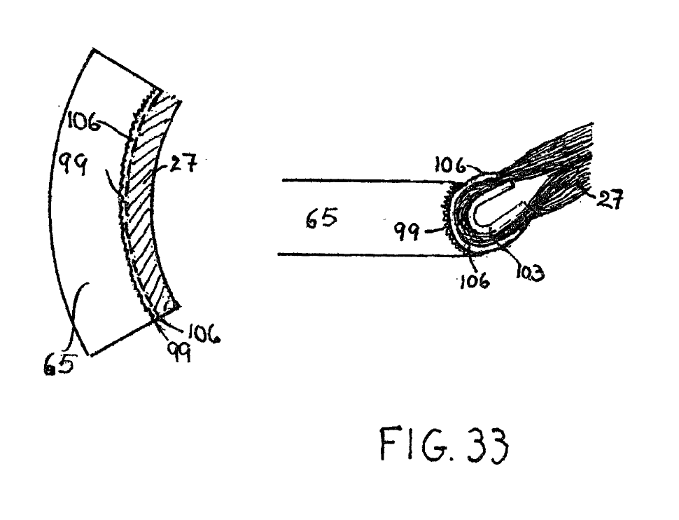

FIG. 1 (prior art) is a reproduction of FIGS. 2-38 of ref [1]. It is a perspective view that shows the basic structure of type I homopolar machines as invented 1831 by Michael Faraday. Herein FIG. 1 depicts the type I homopolar machine as a generator but it can be also used as a motor. It includes an electrically conductive rotor 2 between magnetic poles 8(1) and 8(2) of two bar magnets 4(1) and 4(2) and is mechanically rotated in anti-clockwise direction by means of electrically conductive axle 10 to which rotor 2 is electrically connected. As a result of the motion of rotor 2 an EMF is induced in the area of rotor 2 that is penetrated by the magnetic flux, B, of magnets 4(1) and 4(2). By magnitude and direction that EMF is proportional to [v×B] where v is the local velocity of rotor 2 relative to magnets 4(1) and 4(2). Consequently the EMF is radial as indicated by the vertical arrow. The EMF produces a current that is measured by galvanometer G in the circuit that will now be described.

The current travels through the circuit beginning in the upper portion of rotor 2, travels via the circumferential electrical brush 14 sliding on rim 3 of rotor 2 through the electrical cable 15(1) to the positive terminal of galvanometer G. The current exits at the negative terminal of galvanometer G though electrical cable 15(2) and from there travels via the axial brush 12 that slides on the axle 10 back into rotor 2.

Brushes 12 and 14 are shown in the form of flexible metal strips that were used by Faraday. In modern machines other types of brushes would be used, and one would place the rotor between similarly positioned poles of one toroidal magnet instead of the poles of two separate bar magnets as used by Faraday. However, toroidal permanent magnets, i.e. magnets that are shaped such that their two poles face each other, were not available to Faraday, and even less toroidal electromagnets, let alone toroidal superconducting magnets that now are the tools of choice for homopolar machines.

The type I homopolar generator depicted in FIG. 1 converts the mechanical energy input through the torque applied to axle 10 to rotate rotor 2 into electric energy, as do virtually all electrical generators based on electromagnetic induction, except for the following losses. (i) A typically minor loss through mechanical friction, including that due to the brushes. (ii) A major loss to be discussed below due to eddy currents. (iii) Another loss due to the current bypassing the rotor area that is penetrated by magnetic flux, so that it does not convert mechanical into electrical energy but generates Joule heat in the rotor, brushes and electrical cabling.

In the set-up of FIG. 1 the generated electrical energy is not utilized and is simply converted into Joule heat within galvanometer G, within the wiring 15(1) and 15(2), through the electrical impedance within rotor 2 including that through eddy currents and current bypassing, and on its passage through brushes 12 and 14. In actual practice, a “load”, e.g. a paying customer in the case of utilities, would abstract the electrical energy for other purposes at the position of G.

By reversing the operation, i.e. by supplying electrical energy through passing a current through the same circuit by means of an externally applied EMF, a torque is generated in the rotor and the type I homopolar generator of FIG. 1 is converted into a type I homopolar motor, without any structural changes whatever. With some minor exceptions, the same reversibility applies to all electric generators and, conversely, motors that depend on electrical induction. For this reason, in the present patent application the word homopolar machine is used whenever the device could be used either as a motor or a generator.

FIG. 2 (prior art) is a reproduction of FIG. P1.31 of ref. [2] that shows the basic structure of a type II homopolar machine. It is characterized by cup-shaped rotor 2 (in the drawing somewhat incorrectly called “cylindrical rotor”) whose cylinder wall of indicated thickness c, extends with some clearance into a matching cylindrical gap 7 between the pole-pieces of electromagnet 4. Electromagnet 4 consists of a specially shaped soft iron core 11 that is energized by the indicated electric coil such that the magnetic field (marked by arrows B) between the pole pieces on either side of the cylindrical gap penetrates the cylindrical part of rotor 2 uniformly everywhere from the outside to the inside. When rotor 2 is mechanically rotated by means of axle 10, in clockwise direction as indicated by arrow v, an EMF in axial direction is induced in the cylindrical part of rotor 2. An electrical circuit that is symbolized by curved arrows near the top of the drawing is established by means of the axial electrical brush 12 and circumferential brush 14 whose brush holders are, as in FIG. 1, not shown. The disk-shaped bottom part of cup-shaped rotor 2 is outside of the magnetic field area at its left and serves the mechanical function of joining the cylindrical part of rotor2 to axle 10 but does not contribute to the generator function of the machine. The general considerations regarding homopolar machines given in conjunction with type I homopolar machines above, apply also to type II machines. In fact, in principle type I and type II machines are alike except in the geometry of their magnets and rotors and, most importantly, of the absence of losses through current bypassing in type II since in it all of the active area of rotor 2 is uniformly penetrated by flux.

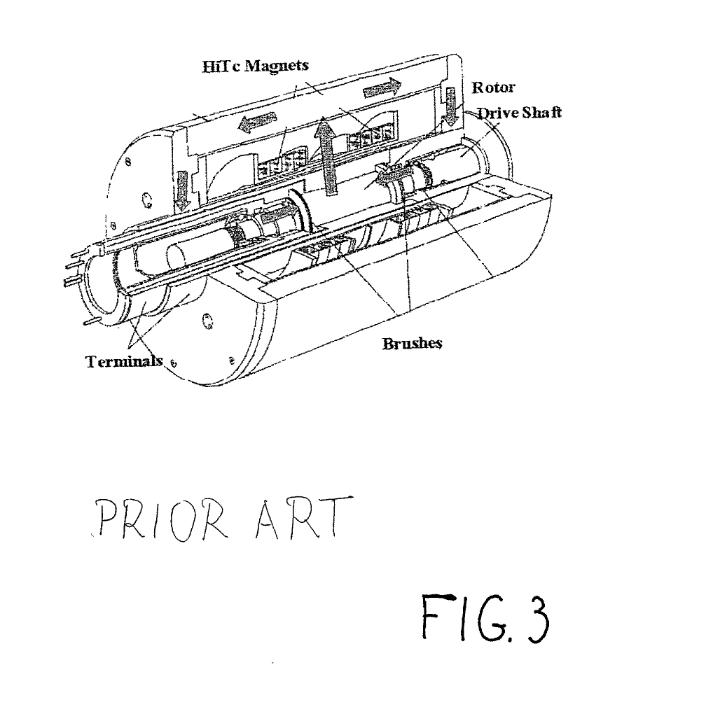

FIG. 3 (prior art) is a reproduction of FIG. 1 of ref. [4] that shows a modern type III homopolar machine. This differs from types I and II by utilizing two similar, axially aligned but opposing magnets. The resulting flux path is indicated by broad arrows and intersects the cylinder surface of the rotor at nearly right angles everywhere. In the specific case of FIG. 3, and typical for modern type III homopolar motors, these are superconducting magnets, i.e. solenoids of many turns of superconducting wire cooled to below their critical temperature.

In principle, the source of the magnetic flux penetrating the rotor or rotors, whether permanent magnets, electromagnets or superconducting magnets, does not affect the generator or motor action of homopolar machines of any type. Even so, type m machines are typically based on superconducting magnets because, (i) they can achieve much higher flux densities, B, and (ii) unlike electromagnets and permanent magnets, superconducting magnets do not require a core filled with a ferromagnetic material. Therefore they can be lighter in addition to being more powerful than ordinary electromagnets, which in turn tend to surpass permanent magnets. Moreover, hollow spaces inside the opposing superconducting magnets such as in FIG. 3, can accommodate the two ends of a single cylindrical rotor, or a set of nested cylindrical rotors, of a type III machine, as well as their slip rings and the brushes and their brush holders sliding thereon. However, the expense and volume requirements of a superconducting magnet and its cooling system are justifiable only for relatively large machines, e.g. are ruled out for cars, let alone handheld tools.

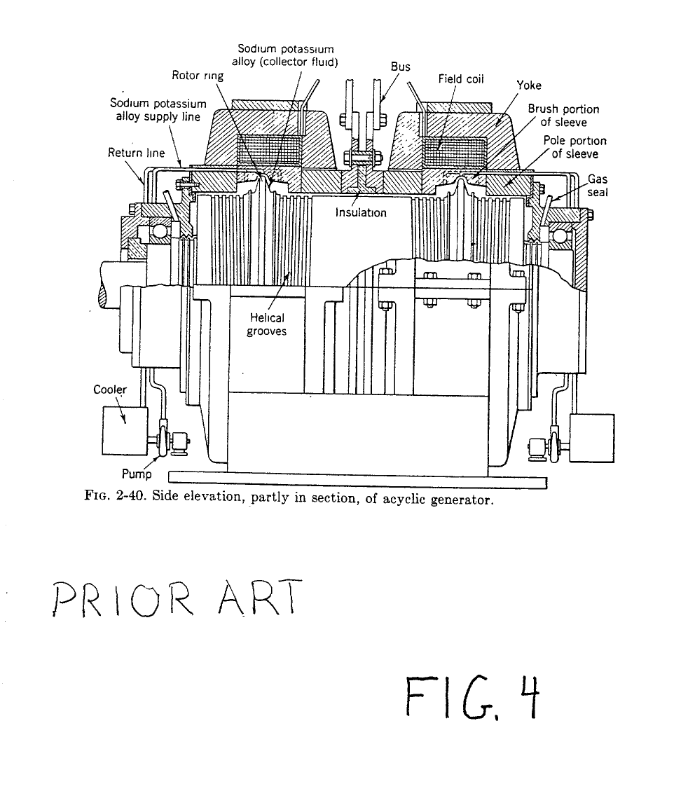

FIG. 4 (prior art) is a reproduction of FIGS. 2-40 of ref [1] showing the side elevation, partly in section, of a homopolar machine of type m which at the time of writing of ref [1] was in process of development by the Allis-Chalmers Manufacturing Company. It was rated at 80,000 amp at 75 volts, i.e. 8,000 hp, with an expected efficiency of 98% and was designed to use Na—K liquid metal brushes.

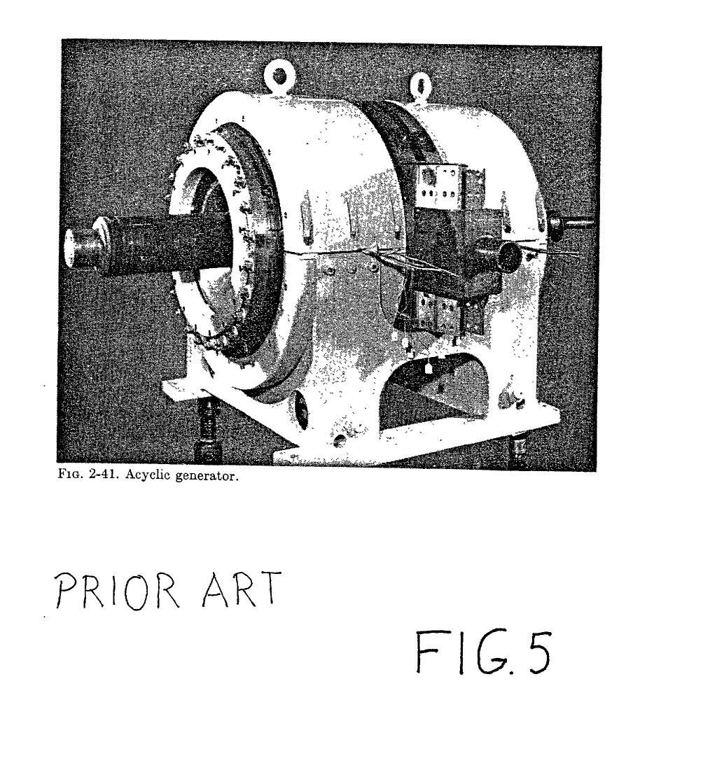

FIG. 5 (prior art) is a photograph of the machine of FIG. 4. It is doubtful that the machine was ever successfully completed on account of problems with the liquid metal Na—K brushes. At the least, there is no record that the machine was ever in use, whereas an intense effort to develop similar Na—K liquid metal brushes was abandoned after several years of development effort at the previous David Taylor Naval Research and Development Laboratory in Annapolis, Md., when liquid metal Na—K leaks through seals could not be prevented. Independently, it is extremely doubtful that the motor of FIGS. 4 and 5 could have achieved 98% efficiency since there is no indication that steps were taken to prevent Hall/eddy current losses to be further discussed below.

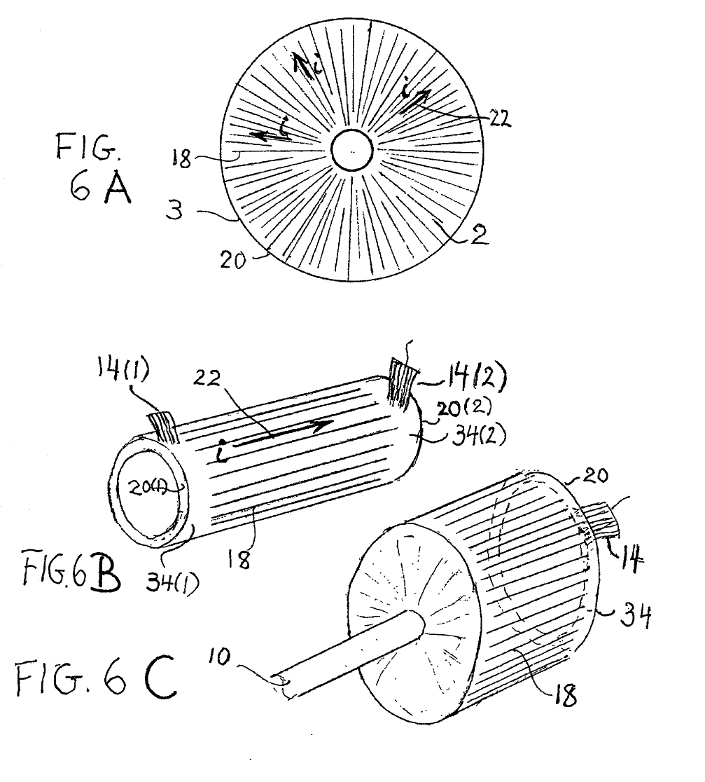

FIG. 6 clarifies the geometry of eddy current barriers, whether eddy cuts or insulators between lengthwise extended electrical conductors in other current channeling structures, for curtailing the Joule losses on account of the Hall effect and the eddy current effect according to the present invention. Eddy current barriers 18 interrupt the transverse current component, i.e. the component at right angles to the intended direction of currents, i, in a rotor or stack of rotors 2, that result from the Hall and also the eddy current effect. For the purpose of suppressing Joule losses through the Hall and eddy current effects, corresponding eddy current barriers 18 are preferably located in those areas of rotors 2 that are penetrated by strong magnetic flux and, further, eddy current barriers 18 are preferably arranged parallel to the intended current direction 22. They are therefore preferably radial in circular, i.e. disk-shaped rotors of type I homopolar machines as in FIG. 6A, axial in the cylindrical part of rotors of type II homopolar machines as in FIG. 6B, and axial in rotors of type III homopolar machines as in FIG. 6C. Also the circular part of the cup-shaped rotor 2, i.e. what would be the bottom of the cup, might be provided with radial eddy current barriers but those are not required because this part of the rotor is not inside a high magnetic flux area. Often, the eddy current barriers 18 will be the already introduced eddy cuts all the way through the rotor 2 or set of rotors (and thus force the current to travel in the solid portion of the rotor 2 between adjacent eddy current barriers in the intended direction of the current 22). In order not to unnecessarily increase the Joule loss due to the intended current flow in the rotor, eddy cuts, like other eddy current barriers such as insulating layers on, or insulating matrix material between, metal wires or foils, should be as narrow as possible, consistent with their function of providing very high local resistance to currents transverse to the intended current direction 22. Therefore eddy cuts are preferably filled with a suitable insulator, e.g. lacquer as may at the same time be advantageously used in joining rotors in an electrically insulating manner within a set, so as to forestall accidental contact between opposite sides of any one cut. As an important additional benefit, such filling of eddy cuts will mechanically strengthen rotors.

It depends on the severity of the Hall- and/or eddy current effect, as well as on the intended efficiency of a homopolar machine what fraction of rotor areas may need eddy current barriers. In general, let the power loss (in units of energy per unit time) due to the Hall/eddy effect, W_{H}, amount to x % of ideal machine power, W_{Max}, in the absence of eddy current barriers. Let this loss decrease to hx % if eddy current barriers were applied to all of the active rotor area, meaning essentially all of the rotor area that is responsible for the machine operation, but let only the fraction c of the active rotor area actually be supplied with eddy current barriers. Lastly, let the desired machine power be 100%-y %, and let all other machine losses (including windage, friction losses, brush losses, Joule heat losses on account of ordinary rotor and wiring resistivity) be z %<y % of W_{Max}. In that case, the actual machine efficiency would be

W_{Machine}=W_{Max}{1−z−(1−c)x−chx} (6a)

which would yield the desired machine efficiency of W_{Machine}=W_{Max}{1−y) for

c=(y−z)/[x(1−h)] (6b)

In other words, for the desired machine efficiency of (100%-y %), eddy current barriers would have to be supplied on at least the fraction c=(y−z)/[x(1−h)] of the rotor area that cumulatively generates 100% of the machine effect, i.e. torque in the case of motors and current in the case of generators

Since 0≦c≦100%, it follows that the machine efficiency, E_{Machine}=W_{Machine}/W_{Max} is at best

E_{Max}=100%−z−hx (7)

By way of numerical example, consider the machine in FIG. 3. Based on eq. (6a) and the discussed measurements of x≈30%=0.3, with c=0 since the machine includes no eddy current barriers and an estimated z=2%, the machine efficiency is expected to be

E_{Machine}=1−z−x=100%−2%−30%=68% (8a)

In fact, judging by the data of ref. 4, the machine does indeed have a similarly low if not lower efficiency. In this case, therefore, eddy current barriers should be installed over the whole active rotor area, for c=100%, with eddy current barriers spaced so densely that h≦5%=0.05. If so, in accordance with eq.(6a) the motor efficiency would rise to

E_{Machine}=100%−z−chx≧100%−2%−0.05×30%=96.5% (8b)

and if h=0 should be approached by spacing the eddy current barriers sufficiently closely, eq.7 yields the maximum possible efficiency of

E_{Max}=100%−z=98% (8c)

Through the persistent previous neglect of the Hall/eddy current effect, it is this inflated estimate of machine efficiency that has been used in the past,—presumably also for the machine in FIGS. 4 and 5.

In addition to the discussed effect of eddy current barriers, the eddy current barriers can play another role that is peculiar to machines in which only a part of the geometric rotor area is in fact “active,” i.e. is traversed by current and penetrated by magnetic flux which is the necessary condition for electromagnetic induction. This will be appreciated by reference to FIG. 1 as follows: If operated as a machine, a current, i in the rotor, driven by the induced EMF, [symbol] , will supply electrical energy at the rate of

Wᵢₙ=i [symbol] (9)

causing the axle to provide a torque M at rotational velocity (for the rate of work output of

Wₒᵤₜ=Mω (10)

Assuming 100% machine efficiency, i.e. that Wᵢₙ=Wₒᵤₜ, the EMF in the rotor across the length of the current lines between the pole pieces would be

[symbol]

=Mω/i (11)

For a modest Mω=11 watt work output, therefore, in a 110 Volt machine, drawing i=0.1A of current, it would be [symbol] =11 watt/0.1A=110V, even while the ohmic resistance of its copper rotor of say, t=0.1 cm thickness, and of R_{R}=1.25 cm diameter mounted on an R_{A}=0.2 cm axle and resistivity of ρcᵤ=1.6×10⁶ cm would be only

[symbol]

_{R}=(ρ/2πt_{R})ln(R_{R}/R_{A})≅5×10⁻⁶Ω (12a)

i.e. an associated ohmic voltage drop of

[symbol]

_{Ω}=i [symbol] _{R}=5×10⁻⁷[V] (12b)

Hence the voltage required to overcome the ohmic resistance against the current in the rotor would be small compared to the back EMF, [symbol] .

In light of the above disclosure, it is seen that the voltage required to drive the current against the ohmic resistance of the coils of conventional motors, and similarly through the rotors of homopolar motors, is insignificant compared to the electromagnetic back-voltages by which the electric energy is converted into mechanical energy. It follows that a type I homopolar motor patterned after FIG. 1 will have a small efficiency at any reasonable rate of rotation because, independent of the position of the circumferential brush relative to the magnets, the current will preferentially bypass the magnetic gap area.

According to the present invention, the problem of current bypassing can be avoided by channeling the current between eddy current barriers The effect thereof is to interpose regions of high ohmic resistance on undesired current paths.

In general, it would be preferable that eddy current barriers do not cross a slip ring because they will cause increased brush wear rates and can cause mechanical bouncing of brushes. However, unless the active rotor area of a type I machine completely encircles the slip ring of the axial brush, eddy current barriers though the rotor circumference will be essential because the circumference of a rotor will provide a low-resistance path unless it is intersected by eddy current barriers. Thus, some of the eddy current barriers 18 shown in the example of FIG. 6A intersect the outside circumference 20 of the rotor 2. By contrast, none of the eddy current barriers 18 cross the circumferences 20(1) and 20(2) of the cylindrical edge of the type II cup-shaped rotor of FIG. 6B, and similarly none intersect either of the two circumferences at the ends of the type III cylindrical rotor of FIG. 6C where the respective slip rings are liable to be located. This is so because rotors of type II and type III homopolar machines are uniformly penetrated by magnetic flux and therefore do not provide bypassing paths for the current and, further, their slip rings are outside of the area of strong magnetic field. Suitable filler materials for eddy cuts on slip rings will be discussed later-on.

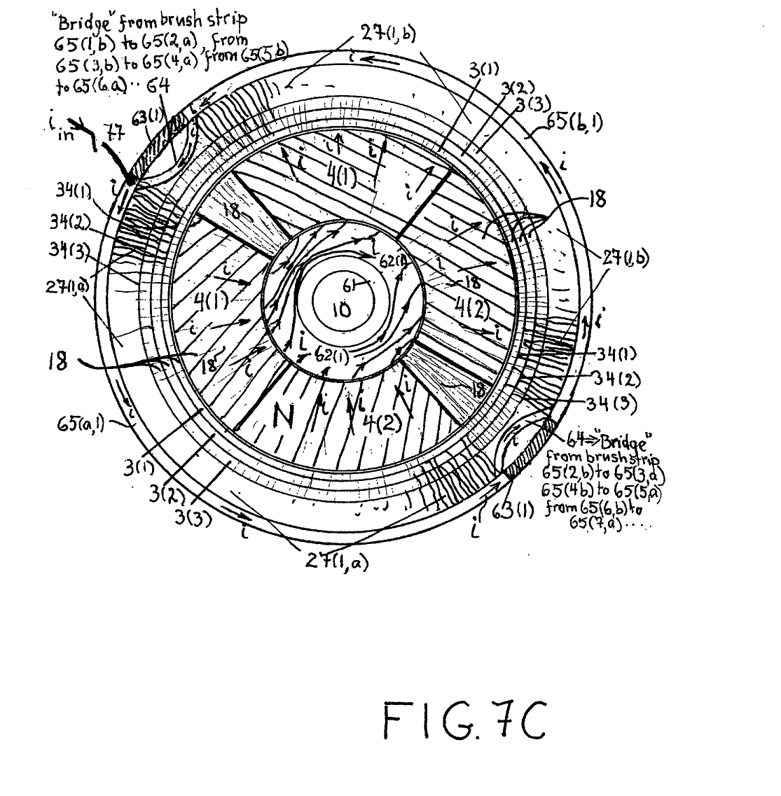

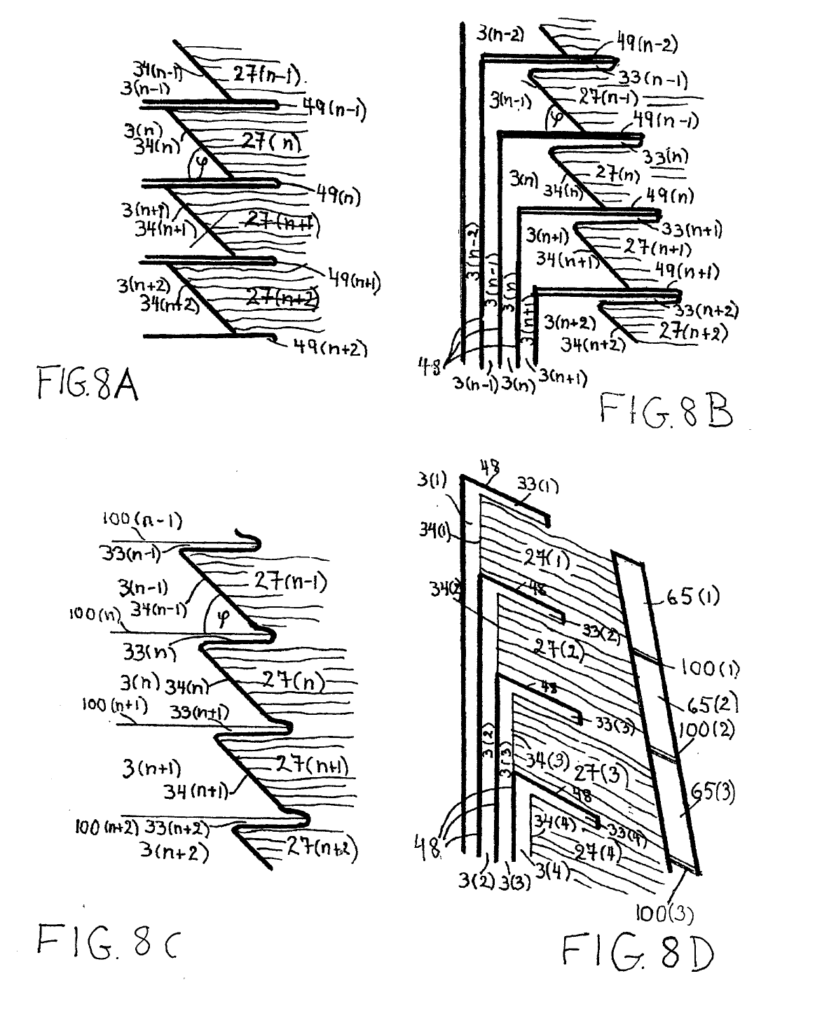

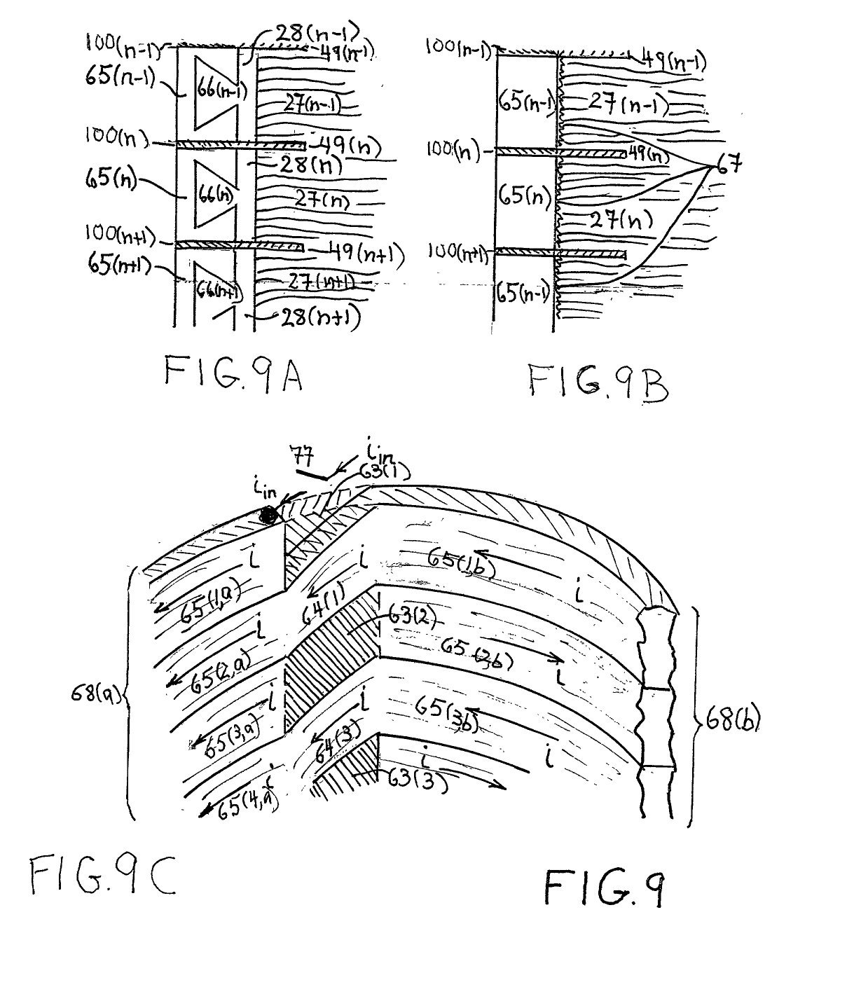

B. Bipolar Machines with Circular Rotors and Brush Plates (FIGS. 8 to 14)

(a) Basics of the Bipolar Design

In section 3e, bipolar machines have been introduced as having n=2, i.e. two current “turns” per rotor, thereby at the same time doubling the voltage at otherwise the same parameters and halving the number of required brushes. Two basic versions are proposed according to the present invention, namely machines with circular rotors and machines with cylindrical rotors of which a variant are machines with cup-shaped rotors. The critical feature throughout the present invention of bipolar machines is the establishment, in any one rotor, of two areas of similar extent but opposite magnetic flux direction through which the current flows consecutively before passing to the next rotor.

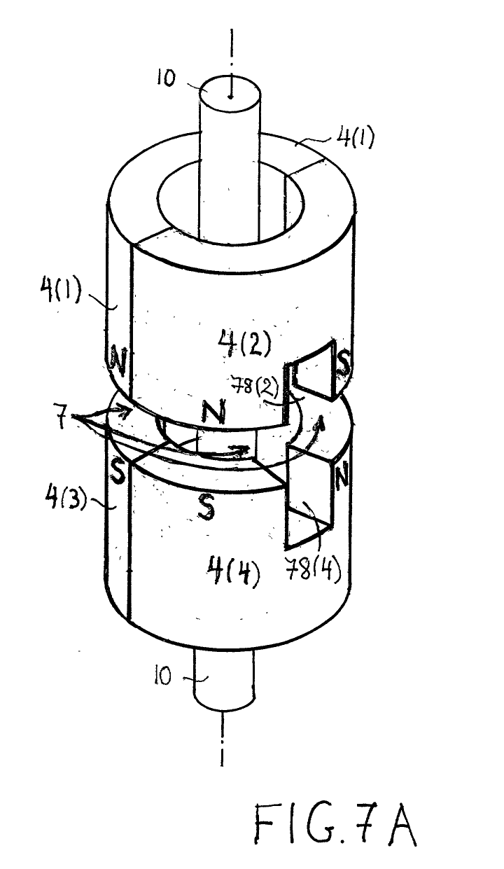

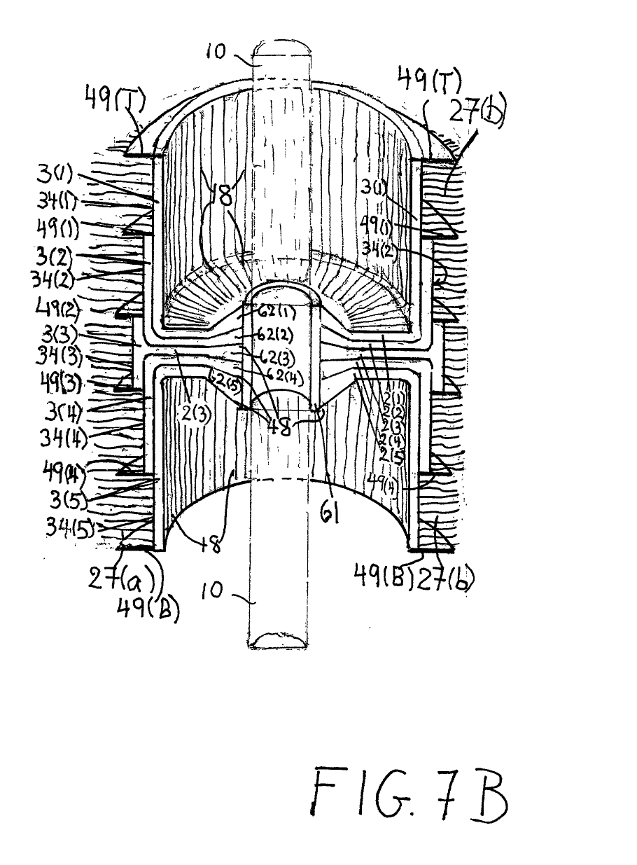

The principle is clarified in FIG. 7 for the case in which circular rotors are used. Herein, FIG. 7A shows a perspective view of a magnet shape and arrangement for a bipolar machine with circular rotors according to the present invention, in position relative to the axle 10. The arrangement comprises four geometrically similar horseshoe-type magnets, bent into cylinder arcs, that form two pairs. One pair comprises magnets 4(1) and 4(2) that face their mirror image of a pair of magnets of opposite polarity, 4(3) and 4(4). Together the four magnets define an annular magnetic gap 7 of N/S polarity over somewhat less than one half of the gap area, and its mirror image of S/N polarity, over the symmetrical nearly half of the gap, in which the circular rotors rotate.

Note that the specific shape of the magnets is subject to many possible variations, e.g. (i) the pole pieces need not be flat but can be curved in radial section for intensifying the flux intensity in the gap, (ii) the radial magnet thickness need not be uniform but may be variously shaped to optimize the flux in the gap and/or to optimize the length of the machine, (iii) the magnets need not be cylindrical but could be conical, e.g. so as to permit the rotor rims to lean inward towards the axle and thereby to reduce the brush sliding speed or conversely lean outwards to increase slip ring area, (iv) the ends of the magnets away from the gap may not form flat rings but be shaped three-dimensionally to save weight, optimize flux density, improve shock resistance of the magnets and/or reduce cost, . . . (v) the magnets may be shaped including any combination of the above for any combination of the above reasons, plus any other modifications, e.g. fluting if there should be good reason for doing so

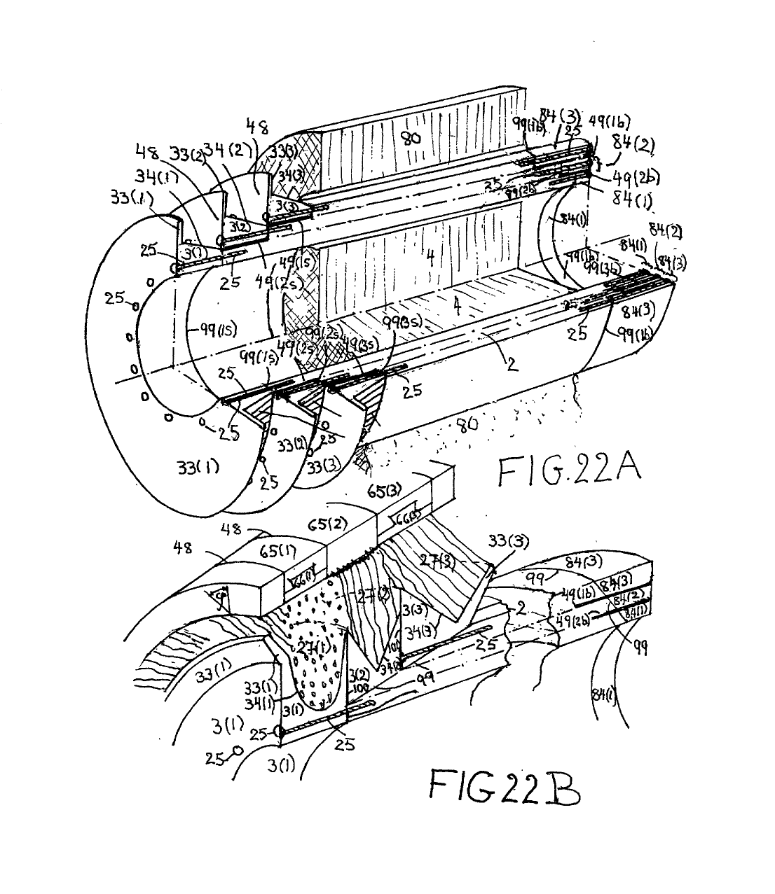

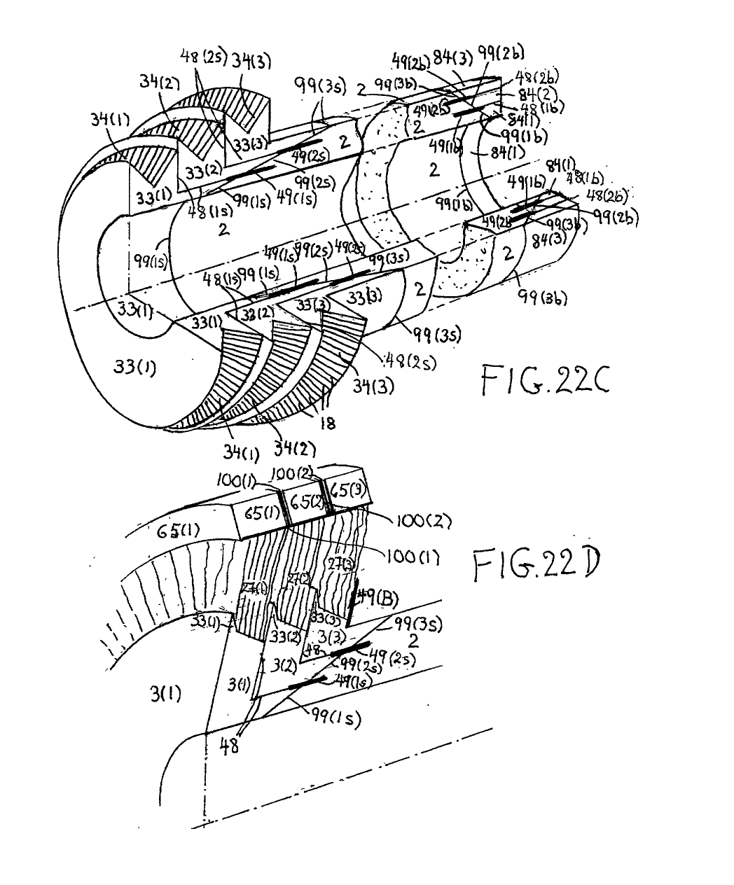

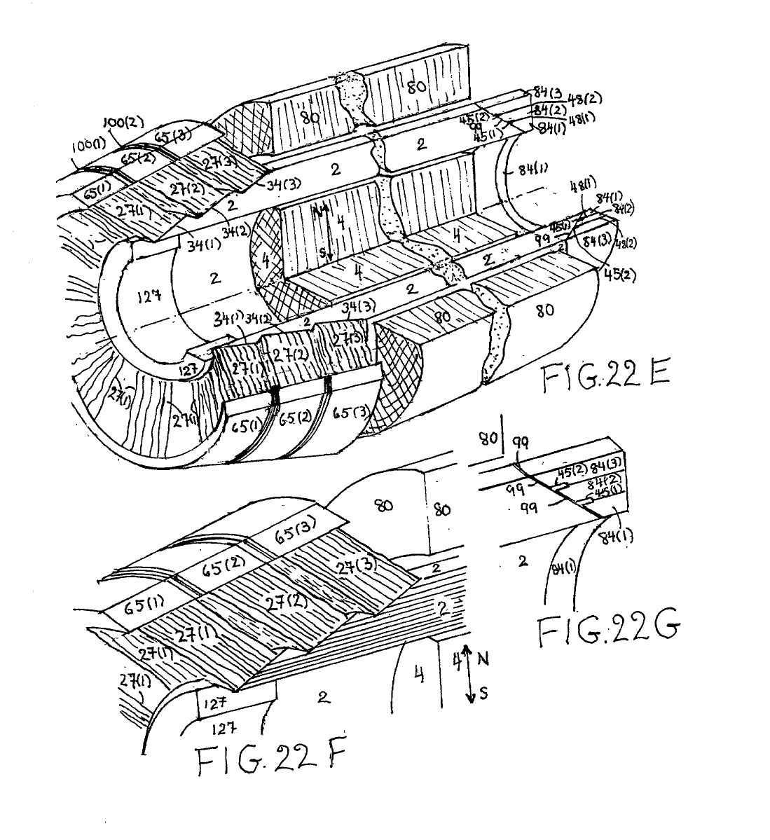

As shown in FIG. 7B, the machine further includes a stack of circular rotors (2) that are capable of rotating in the magnetic gap 7 and are mutually electrical insulated, preferably via “dielectric breakdown bonding” layers 100 that are not shown in FIG. 7B and serve as a protection against brush failure, to be more fully discussed in connection with FIG. 22 and in section Je. The rotors are provided with angled rims (3), meaning extensions that project beyond the magnetic gap and out of the plane of the circular rotors. Most typically but not necessarily the rims are oriented parallel to the rotation axis in the manner of FIG. 7B. The purpose of the extended, angled rims is to provide slip rings 34 for the brushes 27 that conduct the current from one rotor to the next as well as into and out of the machine and may be mounted in individual brush holders or in brush strips that may be assembled into brush plates. Through extending the dimension of the angled rims in axial direction, the total available slip ring area, that tends to be a limiting factor in homopolar motors designs especially of type I, can be almost arbitrarily increased.

The particular example of FIG. 7B shows a lengthwise section of the rotor set in the machine, parallel to the axle 10. The rotor set comprises five rotors 2(1) to 2(5). FIG. 7B further show an example of means 61 for mechanically fastening the rotor set to axle 10.

In greater detail, FIG. 7B shows a set of brushes 27(a) that run on slip rings 34(1) to 34(5) on rims 3(1) to 3(5) on the N/S-side (dubbed the (a)-side) of the magnetic gap 7, and the mirror-image set of brushes 27(b) that similarly slide on slip rings 34(1) to 34(5) on rims 3(1) to 3(5) (not all numbered in FIG. 7B) on the S/N-side (dubbed the b-side) of the mag-netic gap 7. For clarity, FIG. 7B does not show the brush holders. These could be indivi-dual brush holders or could be extending from “brush plates” in the form of brush strips rather than individual brushes as further discussed in section B(c).

Rotors 2(1) to 2(5) and their rims 3(1) to 3(5) including their slip rings 34(1) to 34(5) are mutually electrically insulated by insulating layers 48 (not shown in FIG. 7) and are supplied with radially oriented current channeling means 18, i.e. eddy current barriers whether eddy cuts and/or any other suitable form of current channeling means. Collectively, though not necessarily individually, the eddy current barriers extend from the inner edge of the annular magnetic gap area through the magnetic gap area 7, through the rims 3(1) to 3(5) and through the sip rings 34(1) to 34(5), so as to inhibit circumferential current flow between magnetic areas (a) and (b) and thereby electrically to insulate brushes 27(n,a) from brushes 27(n,b). However, the rotor area 62 about the axle 10 up to the magnetic gap, is free of eddy current barriers. Moreover, in order to lower internal machine resistance and thus Joule losses, in area 62 the thickness of the rotors is optionally increased as indicated in FIG. 7B by numerals 62(1) to 62(5), and in the general case by numerals 62(n) for any arbitrary number of rotors.

The inside edges of rotor parts 62(1) to 62(5), and in general 62(n), are fastened to axle 10 via part 61 that is electrically insulated from rotor parts 62(n). For example, part 61 could have cylinder shape as in FIG. 7B, could be made of metal or an insulator, and by means of some suitable adhesive could be glued to both axle 10 and rotor parts 62(n). Anyway, as already stressed and is the rule for all rotor sets in all homopolar machines, the different rotors in the set, including their rims and their parts in the area 62 about the axle, must be electrically insulated from each other by layers 48. This could be very easily accomplished by spraying with a stop-off lacquer before assembling the set of rotors while the lacquer is still wet or at the least “tacky”. Thereby eddy cuts will be glued shut if these should be the current channeling means employed, which would be highly desirable for mechanical strength.

The objective of the outlined construction is to force current i to flow consecutively from rotor 2(1) to 2(N), and in each of the rotors across both the (a) and (b) parts of the magnetic gap as indicated in FIG. 7C which is a plan view of the described bipolar machine according to the present invention. In a motor, current i will thereby be subjected to the corresponding increments of magnetic force on each pass through the annular magnetic flux area, and in a generator it will generate additive increments of induced voltage, always in the same direction, thereby causing n of eq.4 to equal n=2.

To clarify the current flow in greater detail, consider the machine in FIG. 7 to be a motor, wherein the voltage is applied between brush holder strip 65(1,a) at the top of the stack on the (a)-side), and brush holder strip 65(N,b) at the bottom of the stack on the b-side. In this arrangement, current i enters brush holder strip 65(1,a) via switch 77. From there, driven by the applied voltage increment between rotor brush holder strip 65(1,a) and 65(1,b) and constrained by the eddy current barriers 18, the current flows in axial direction through rim 3(1) towards the (a), i.e. N/S polarity, part of the gap between magnet pair 4(1)/4(2) above and pair 4(3)/4(4) at the bottom of the stack. Still constrained by the eddy current barriers the current next flows radially inwards through the axial N/S magnetic field and in the process is acted upon by the corresponding anti-clockwise toque. Leaving the gap area into area 62(1), and there unconstrained by eddy current barriers but still driven by the voltage between brush holder strips 65(1,a) and 65((1,b), current i circuits about axle 10 into the (b), i.e. S/N polarity, part of the gap. Now again constrained by the eddy current barriers, the current flows outward in radial direction and is again subject to an anti-clockwise Lorentz force torque in the (b) part of the gap. From there, still constrained by eddy current barriers and driven by the applied voltage, the current flows in axial direction through rim 3(1,b) and leaves rotor 2(1) through brush strip 27(1,b) into brush holder strip 65(1,b). With this the rotor has been traversed and has yielded twice the induced voltage due to a single passage of the current through the magnetic flux. The next current turn begins as the current continues to follow the applied potential gradient through “bridge” 64(1) into brush holder strip 65(2,a) on through fiber brush strip 27(2,a) to repeat the same course through rotor 2(2) etc. until it finally exits at brush holder strip 65(N,b) after N current turns.

(b) Slip Rings

In all cases, neighboring slip rings as well as brushes and brush holding devices must be electrically insulated. This may most simply be done by means of the already mentioned insulating joints 48, e.g. composed of “stop-off lacquer”. In order in particular to prevent electrical contact between brushes on neighboring slip rings, stiff, thin insulating layers 49, also called “separators”, may be provided between parallel brush tracks as shown in FIGS. 7B and 8A and similarly insulating end layers 49(T) and 49(B) at top and bottom of the series of parallel slip rings may be used to prevent brushes from sliding off the slip rings, as shown in FIG. 7B.

Rims 3(1) to 3(5), and in the general case 3(n), need not be of uniform thickness but may optionally be less than or exceed the thickness of the rotors in the magnetic gap area, e.g. so as to reduce ohmic electrical resistance. Moreover the thickness of the rims need not be the same for all rims nor be uniform over the whole extent of any one rim. One application here is “scarfing”, i.e. inclining the brush-rotor interface against the brush fiber direction in a plane normal to the sliding direction, which facilitates reversal of sliding direction attendant on reversal of sense of machine rotation. Scarfing is used for that purpose in the previously mentioned homopolar motor currently under construction at General Atomics Inc.

Simple scarfing is illustrated in FIG. 8A, wherein slip rings are conical with opening angle φ in either direction relative to the rotation axis. As a result, radially oriented metal fiber brushes or brush strips 27(n) as in FIG. 7B slide on slip rings 34(n) with their axes inclined by angle φ against the slip ring normal in a plane parallel to the rotation axis. In general, compared to cylindrical slip rings, the angle of inclination of arbitrarily oriented brushes against the same slip ring surface will be decreased by the angle φ if the brush axis, i.e. the brush fiber direction, is slanted in the same sense and increased by the angle φ in case of opposite slant.

The ease and safety with which the brush sliding direction, and hence the machine rotation direction, can be reversed increases with the angle φ of inclination of the brush fibers against the slip ring normal φ. However, increasing the angle φ at the same time causes the brushes to be driven increasingly forcefullly towards the slip ring side with the smaller radius. The possible resulting contact with and friction between the brush fibers and separators 49 may cause wear damage to the separators 49 and eventually wear them out. In order to prevent this, it will be advantageous to clad at least one side of separators 49(n) with slip ring extensions (33). This variation in accordance with the present invention is indicated in FIG. 8B by means of a set of rims 3(n) mutually electrically insulated by means of insulating joints 48, comparable to those at the right of FIG. 7B, with slip ring extensions 33(n) mechanically joined to slip ring separators 49(n). Slip ring extensions will inhibit separator wear and incidentally will also mildly increase the available slip ring area when brushes are contacting the separators.

Further, advantageously the separators 49(n) may be eliminated by means of slip ting extensions from both sides as indicated in FIG. 8C. From the view point of manufacturing that means that suitably shaped rims (3) with, typically differently shaped slip ring extensions (33) on both sides, may be simply joined together by means of insulating joints 48 that provides electrical insulation between rotors and bonds them mechanically. It is anticipated that this will at the same time enhance long-term reliability in preventing electrical contact between brushes on adjoining slip rings, and on account of eliminating separators (49) will reduce manufacturing cost.

Another form of scarfing, namely obtained by angling the brushes instead of the slip rings, is obtained by providing rims with angled slip ring extensions 33 as in FIG. 8D. Shown in this figure is a set of mutually electrically insulated rims, 3(1) to 3(4), comparable to those at the right of FIG. 7B, provided with angled extensions 33(1) to 33(4) each of which is covered with insulating material 48 on one side. Fiber brush strips 27(1) to 27(4) extending from brush plate strips 65(1) to 65(4) slide on slip rings 34(1) to 34(4) that are formed by the exposed parts of rims 3(1) to 3(4) between neighboring slip ring extensions 33(1) to 33(4), e.g. slip ring 34(3) on the surface of rim 3(3) between extensions 33(3) and 33(4) on which slides fibrous part 27(3) extending from brush strip 65(3). It may be noted that electrical contact between brush 27(n) with the bare side of the adjacent angled extension 33(n) will be harmless or even beneficial, while the applied brush force drives brush 27(n) away from the insulation 48 on extension 33(n+1) thereby reducing of eliminating wear on the side of 33(n+1). However, wearing through layer 48 would give rise to highly detrimental short-circuiting between slip neighboring slip rings and must be strictly avoided. Correspondingly, according to the present invention, any combination between the two-sided cladding of the joints between neighboring slip rings as in FIG. 8C and the angling of slip ring extensions, brushes, brush strips and/or brush plates as in FIG. 8D, may be advantageous depending on detailed conditions.

(c) Brush Plates and Brush Strips—Basic Construction

According to a feature of the present invention and depicted in FIG. 8D, fiber brushes or brush strips (27) are favorably positioned on brush holder strips (65) already introduced, and the brush holder strips are favorably integrated in the form of rigid “brush plates” (68). Thus brush plates are composed of parallel brush holder strips (65) that can carry brushes (27) in the form of multi-contact metal strips that are electrically insulated from each other via insulating layers (48) or (100) including dielectric breakdown bonding that will be further discussed in section Je.

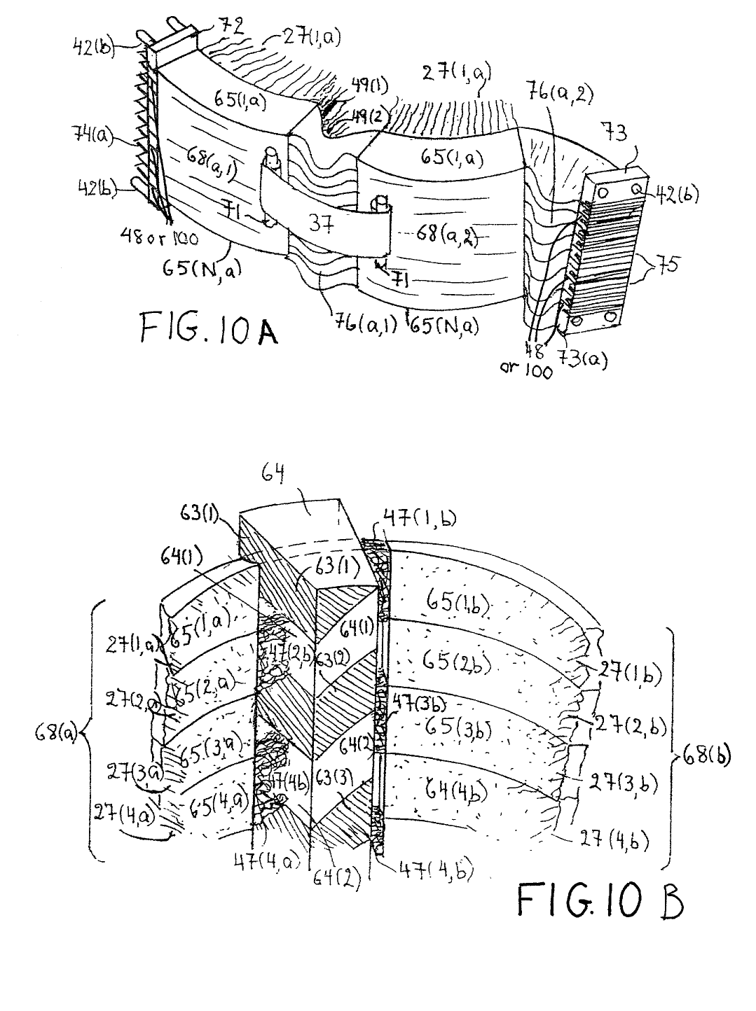

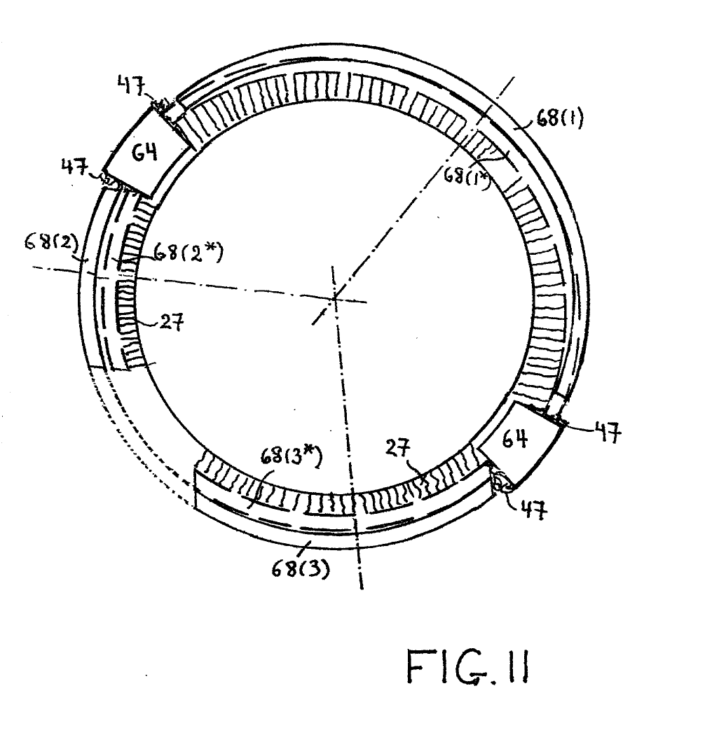

Brush plates (68) can substitute for large numbers of individual brush holders, and can achieve smaller slip ring widths than would be possible with individual brushes and brush holders. Brush plates according to the present invention are further discussed in connection with FIGS. 9 to 13.

According to FIG. 7D, for example, brush strips 27(1,a) and 27(1,b) and their respective brush holder strips 65(1,a) and 65(1,b) collectively each extend over not quite half the circumference of rotor rim 3(1) on the a- and b-side, respectively, and similarly brush strips 27(n,a) and 27(n,b) projecting from brush holder strips 65(n,a) and 65(n,b) extend over most of rotor rim 3(n) on it's a- and b-side, respectively. As explained, the electrical potentials of 27(n,a) and 27(n,b) differ on account of the current passing twice through the magnetic flux between the (a) and the (b) side of rotor 3(n). Therefore brush holder strips 65(n,a) and 65(n,b) which in axial direction are rigidly connected to their neighbors 65(n−1, a) and 65(n+1,a) via insulating layers 48 as in FIG. 8D or, as seen plan view (from the inside without the fiber parts) in FIG. 9A, must be electrically separated from each other. This is the function of the two oppositely located insulating sections 63(1) for rotor rim 3(1) and in general 63(n) for rotor rim 3(n) that are aligned with the dividing line between the (a) and (b) side of the machine, where the B-field has no normal component with respect to the plane of the rotors. Thus insulators 63 are located at the positions of the gaps between the opposing poles of the individual magnets, i.e. gaps 78(1)/78(3) (not seen in FIG. 7A) between the N and S poles of magnets 4(1) and 4(3) and gaps 74(2)/78(4) between the S and N poles of magnets 4(2) and 4(4) on the opposite side of the machine.

The rigid brush holder strips 65 perform the normal dual function of any brush holders, namely of conducing the current to and from the fiber brush strips 27 while they press these against the slip rings 34 with more or less constant brush pressure. Fiber brush strips 27 may be affixed to their respective holder strips 65 by a variety of means, e.g. mechanically by means of dove tailing 66 as indicated in FIG. 9B, or fastened by means of gluing with a con-ductive adhesive 67, e.g. epoxy filled with metal powder, as shown in FIG. 9C, or they may be fastened through soldering, or any other method that yields a firm electrically conductive bond. Dielectric bonding (100) may be used to protect machines against brush failure (see Je).

However, and as already indicated, if operated in a protective atmosphere or in the open air, gaps should be left between segments of brush strips in sliding direction to permit adequate supply of moisture. Altogether, as a rule of thumb, in a gaseous humid atmosphere not much more than the previously introduced fraction f_{Bmax}=50% of the slip ring area should be covered by brush foot print, and the individual length of continuous foot print should best not exceed L_{BSmax}=5 cm Note that these quoted values are very rough estimates since they greatly depend on conditions, with more gap widths and shorter continuous foot print lengths needed for high than for low speeds, for high than for low humidity, and for high than for low fiber packing fraction.

While two insulating gaps 63(n) are needed per rotor, to electrically isolate brush holder strips 65(n,a) and 65(n,b), as explained, there must be no more than a single current connection (dubbed a “bridge”) 64(n) to conduct the current from brush holder strip 65(n) to 65(n+1) since otherwise the current would simply take the shortest route between 65(n,a) and 65(n+1,b) without traversing the magnetic gap 7. Moreover, advantageously, not only the insulating gaps (63(n) but also the bridges 64(n), e.g. as shown in FIG. 9A, should be located at the positions of the gaps between the poles of the four magnets. As a result, much like in an irrigation channel the water flow is at maximum at its inflow point and is success-ively depleted by the water flowing into successive furrows, so the circumferential current density in any one brush holder strip is depleted by the current flowing out into the rotors through the fiber brush strips, until the current vanishes at the insulating gaps 63. The resulting non-uniform evolution of Joule heat in the brush holder strips may, in accordance with the present invention, be smoothed out by alternating the positions of the bridges 64 between the two discussed opposite circumferential positions, as indicated in FIGS. 7C and 9A.

Short-circuiting between adjoining current turns via unintended contact between brushes on neighboring slip rings is inhibited by means of insulating separators/barriers 49(1) to 49(4) between adjoining brush tracks in FIG. 7B, and in general labeled 49(n), or extensions from slip rings 33(n) as already discussed in conjunction with FIGS. 8(B) to 8(D). Optionally similar separators of both types, at both ends or the slip ring zone, in FIG. 7B indicated as 49(T) and 49(B) (for T=top and B=bottom) may be employed to constrain outermost fibers, if any, from splaying out too much. Moreover, in view of the planned close spacing among brushes on adjoining slip rings, according to the present invention cross conduction among brushes may be curbed by coating the fiber with a very thin insulating film A requirement for the choice of such coating material, besides raising the cross resistance among fibers, is that in the course of brush wear it does not leave a residue on the slip rings that significantly raises the electrical resistance between brushes and slip rings.

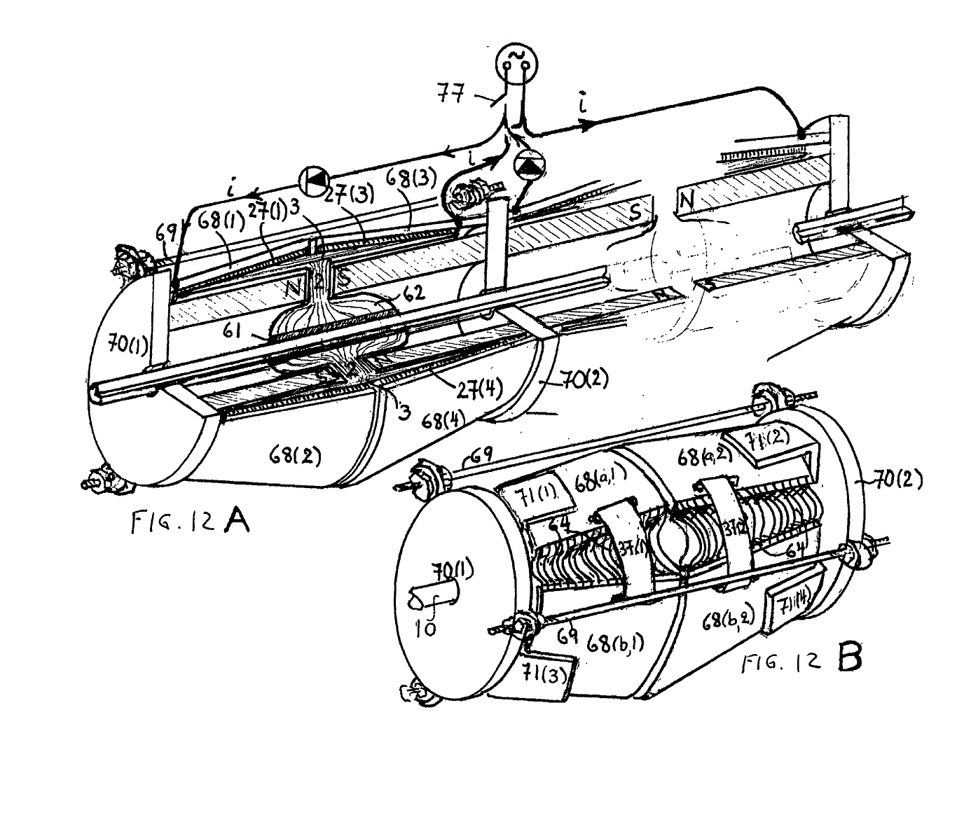

Even though the bridges 64 in FIGS. 7C and 9A are drawn as flat strips that is just one example of their possible morphology. Much more likely, in practice they will take the form of “joints” 76 interposed between the rigid holder strips that may be made of flexible cabling or of foils as indicated in FIG. 10A The tangential component of the brush force among neighboring sections is maintained by means of springs, e.g. constant force spring 37 in FIG. 10A. In fact, due to the radial inward movement of the stiff brush holder strips on account of brush wear, the construction of the flexible joints and bridges between sections of the brush plates is a challenge that is identified and overcome in the present invention as clarified by means of FIGS. 10 to 12. Hence the depiction of the insulating gaps 63 and the bridges 64 in FIGS. 7C and 9A are only schematic to show the current flow directions and general geometry involved, but do not reflect the actual (and rather more complicated) morphology.

(d) Construction, Operation and Manufacture of Brush Plates

Conceptionally, according to the present invention, it will be advantageous to think of brush plates including the rigid brush strips 65 and the fibrous brush strips 27 extending therefrom, as consumable units much like, say, printer cartridges, car tires or indeed graphitic brushes in motors and generators. Instead of repairing a worn out or defective brush plate, it would simply be removed and replaced by a fresh plate. However, in order to function satisfactorily, the problems of how to maintain a more or less uniform brush pressure in the course of brush wear, how to manufacture brush plates and how to service them must be solved. The crucial considerations herein are how to maintain a steady brush force and more or less uniform rate of brush wear. Specifically, as the rigid brush holder strips 65(n) move toward the axle 10 in the course of brush wear, both the bridges 64(n) as well as the insulating sections 63(n) of FIGS. 7C and 9A must either deform without offering much mechanical resistance if they are somehow fused to the brush holder strips, or if insulators 63(n) and/or bridges 64(n) are stiff and fixed in position as in FIG. 9A, the brush holder strips must be able to slide relative to them.

This poses no difficulty in regard to the insulating sections 63(n) since these could be made of polymer foam or even be empty spaces. In the latter case, the cross sectional areas of brush holder strips facing each other across the empty gap should, to prevent possible short-circuiting through wear debris or other, be covered with an insulating lacquer or paint.

The challenge is not so easily solved in regard to bridges, as seen by considering the movements of brush plates 68 of different circumferential extent relative to stiff, stationary bridges 64 and/or insulators 63 that accompany the same brush wear lengths, as sketched in FIG. 11. Specifically, FIG. 11 considers brush plate displacement on account of the same brush wear length at the center of the plate, i.e. displacement of the center of brush plate 68 towards the axis by the same distance, as a function of the angular extent of the plate. As seen, brush plate 68(1), spanning an arc of θ≅180°, moves into position 68(1*), while brush plates 68(2) and 68(3) with θ≅90° and θ≅60°, respectively, move into positions 68(2*) and 68(3*). As the outer edges of the brush plates displace at angles θ/2 relative to the adjoining stationary bridges 64, the relative wear lengths of brushes in the middle and at the edges of the same brush plate, i.e. δL_{B,center}/δL_{B,edge}, is 1/cosθ/2. Thus the edges of plate 68(1) move almost directly towards bridges 64 with strong brush wear at the center of the plate and virtually none at its edges. Evidently, with this morphology, the brush force is similarly skewed to be very low near the edges and to be at maximum about the center of the plate. It follows that a total of two ≅180° brush plates about the circumference of a machine would be unsatisfactory from the standpoint of uneven brush pressure and brush wear alone, no matter how the needed accommodation of the gap shape available for bridges 64 would be achieved.

The parallel displacement of the plate edges, compared to the normal displacement component of the plate edges relative to the bridges 64, is ≅cos(θ/2)/sin(θ/2). Numerically, the displacement ratio parallel and normal to a stationary bridge or insulator would be ≅cos 90°/sin 90°=0:1 by the use of two ≅180° brush plates about the machine circumference, would be ≅1:1 for a total of four ≅90° brush plates like 68(2), would be ≅cos 30°/sin 30°=1:0.58 for six ≅60° brush plates like 68(3), and would reduce to ≅cos 22.5°/sin 22.5°=1:0.414. by the use of eight similar ≅360°/8=45° brush plates about the machine circumference. Meanwhile the relative brush wear rates between the middle and edges of the brush plates would be ≅1/cos 90° [symbol] ∞ by the use of just two 180° brush plates, one each on the (a) and (b) side, whereas with 4, 6 and 8 brush plates per circumference the relative brush wear rates, and by implication correlated brush pressures, would be ≅1/cos 45°=1.41, ≅1/cos 30°=1.15, and ≅1/cos 22.5°=1.08.

It follows that, based on non-uniformity of brush wear alone, one ≅180° plate per side will be unacceptable, two plates per side, i.e. ≅90° brush plates, will barely do, three ≅60° brush plates per side will fulfill all foreseeable practical requirements, and still narrower brush plates would be overly ample. Correspondingly, for a circular rotor one or two flexible brush plate “joints” will have to be included per side in addition to the required current bridges.

Having settled this question, the practical challenge of how to accommodate the needed parallel and normal displacements is much more severe for stationary bridges as in FIG. 10B than for flexible bridges that move with the plates, as in FIG. 10A. The best solution for stationary, stiff bridges is probably via resilient multi-contact metal material 47 indicated in FIGS. 10B and 11. However, at, say, 2 cm total average brush wear the resilient multi-contact material would have to accommodate a change of gap width of more than 1 cm even with 60° brush plates. This would be quite difficult to achieve and possibly lead to arcing as the contacts between plate edge and rigid, stationary bridge loosens with brush wear.

Although in line with the above considerations stationary rigid joints and bridges are possible, it is more likely that one will utilize flexible bridges and flexible joints in accordance with FIG. 10A. The principal function of flexible joints and bridges that are moving with the plates is that of accommodating the reduction of circumference from some value 2πR before brush wear to 2π(R−δL_{B}) after δL_{B} brush length wear, i.e. a reduction of 2πδL_{B} of circumferential length through a δL_{B} average brush shortening. This 2πδL_{B} length reduction will be distributed over 4 or 6 gaps depending whether 90° or 60° brush plates are used, i.e. for δL_{B}=2 cm will require an average shortening of 3.1 cm or 2.1 cm per joint or flexible bridge in the cases of 90° and 60° plates, respectively. According to the present invention this required gap shortening will be accomplished by means of joints and bridges constructed from stacks of parallel foils, a solution that is adapted from ref.[13] as follows: The mechanical stiffness of a foil (and similarly a fiber) may be modeled by a cantilever. For a foil diameter d_{F} the cantilever deflection under force F_{F} is proportional to 1/d_{F}⁴, whereas its electrical resistance is proportional to 1/d_{F}². Specifically, the spring force, F_{F}, of a uniform cantilever of width w, length L and thickness d_{F}, hence cross sectional area A_{F}, made of a material with Young's modulus E, at the elastic deflection Δl of its free end is

F_{F}=(Ed_{F}³w/4L³)Δl=(EA_{F}d_{F}²/4L³)Δl (13)

Hence, disregarding friction among the foils, for N_{F} parallel foils of total material cross-sectional area A_{S}=N_{F} A_{F}, the spring force is, disregarding friction among the foils in the stack,

F_{S}=N_{F}F_{F}≅(EA_{S}d_{F}²/4L³)Δl (14)

i.e. F_{S} drops sharply with decreasing foil thickness, while the electrical resistance of the foil stack from end to end is

R_{S}=ρL/A_{S} (15)

independent of foil thickness. Thus, replacing a certain segment of brush holder strip by double its length of separate thin foils that together occupy only one half the strip thickness in order to essentially eliminate friction among the foils, is electrically equivalent to tripling the length of the replaced segment. This will be relatively insignificant provided that the average bridge or joint length amounts to, say, no more than ten percent of the machine circumference. Moreover the insertion of such flexible joints between rigid brush plates, as indicated by numeral 76 in FIG. 10A, would presumably not too seriously interfere with brush placement since it provides for some of the needed gaps among brush strip segments for moisture access in gaseous atmospheres.

As to the mechanical forces due to the bridges consider a, say, L=3 cm=3×10⁻² m long copper bridge in a square 1 cm by 1 cm holder strip for A_{S}=5×10⁻⁵m² that deflects by Δ1=1 cm=10⁻² m in order to accommodate 1.5 cm of brush wear. With E=1.2×10¹¹ N/m² for copper, the associated force would be, according to eq. 14,

F_{S}≅1.2×10¹¹×5×10⁻⁵×d_{F}²×10⁻²/[4×(3×10⁻²)³][N]=5.56×10⁸d_{F}² (16)

i.e. for d_{F}=10 μm an entirely negligible force of F_{S}=0.056N. More economically, foils of say, d_{F}=25 μm thickness could be used and yield a still very low F_{S}=0.35N. This is just one numerical example to illustrate the wide possibilities offered, in regard to mechanical behavior, by flexible joints and bridges inter-linking brush plates

The remaining question in this section, then, is how to insert the insulators, how to make bridges and how to attach them. According to the present invention this is accomplished by means of male (72a) and female (73a) connector plates illustrated in FIG. 10A. Herein the groups of foils that make up the conductive part of brush holder strips 65(1,a) to 65(N,a) could be directly fed through the male connector plate 72(a) to extend out of it from the other side in the form of being fused into one rigid metal strip 74(a) per foil group. Alternatively, according to the present invention, the foils in any one group may be electrically connected, within the male brush plate, to their one correlated strip. Either way the strips must be mutually electrically insulated, as may be accomplished by making the bulk of the connector plate of an electrically insulating material, or by incorporating into it intervening insulating layers 48.

The construction of the female connector plate 73 is similar except that the groups of foils are electrically connected to conductive slots 75 that are shaped to receive the protruding metal strips 74(b) of the male connector plate 72(b) of brush plates 68(b,1) and 68(b,2) to which they are to be connected. For creating a bridge, male and female connector plates from opposite sides, e.g. from the (a) and (b) side, are snapped or pushed together so that brush holder strip 65(n,b) is connected to strip 65(n+1,a).

The indicated plugs 42(b) and receptacles 42(b) are designed to insure the proper alignment between strips and slots. These perform the same function as the screw connectors integrated into the receptacles of printer cables that secure the proper alignment of the male and female parts. In fact, plugs and holes 42(b) of FIG. 10A might favorably be replaced by just such screw fasteners.

In FIG. 10A, the labels 42(b) of the centering device, while the plates, strips and brushes are labeled 68(a) 65(a) and 27(a), respectively, indicate that the part shown in FIG. 10A is meant to belong to the (a)side that in a machine will be connected to its corresponding part of the (beside. Therefore plates 72(a) and 73(a), together with their counterparts 72(b) and 73(b) that are not shown, must have the previously discussed feature of linking strip 1 to strip 2, strip 3 to strip 4, strip 5 to strip 6, etc. on the left side of the drawing, say, and strip 2 to strip 3, strip 4 to strip 5, strip 6 to strip 7, etc. on the right side, in accordance with FIG. 7C. For use in actual machines, the plates must therefore be labeled accordingly to permit the replacement of brush plates by untrained personnel, in the manner of replacing printer cartridges and other consumable parts of technological equipment, as already discussed.

Lastly, brush plates in motors must be connected to the terminals of power supplies, and similarly brush plates in generators must be connected to the terminals of the current user. For large machines this means that brush plates must be electrically connected to the corre-sponding rigid cables or buses, while at the same time they must be able to move easily in the course of brush wear. According to the present invention, this potential difficulty is solved by making said electrical connections between brush plates and terminals via substantially parallel contact plates that are rigidly fastened to the terminals and the brush plates, respectively, of which one is lined with a resilient multi-contact metal material under light pressure.

(e) Basic Overall Construction of Bipolar Machines with Circular Rotors

Having available brush plates in lieu of individual brushes in individual holders, and having means of suitably connecting them together electrically and mechanically by means of joints and bridges according to the present invention as discussed above, still leaves open the question of how to keep them in position within machines and how to apply the brush force. Several possibilities for positioning and advancing the plates towards the axle in the course of brush wear exist, e.g. guiding the plates between rails, or in slots, or by a kind of dove tailing. These means may be variously used, depending on conditions and cost. For precision and high performance the favored choice, however, is linear bearings. to which the plates are rigidly fastened by means of adequately long and sturdy brackets to withstand possible shocks.

FIG. 12, which presents a perspective view with partial cut-out of two similar bipolar motors in tandem (FIG. 12A), and a perspective view of just one of them (FIG. 12B), indicates this feature by means of the linear bearing brackets 71(1) to 71(4) that are visible and their implied mirror image on the opposite side of the machine that are out of view. The linear bearings are to be fastened to the motor end plates 70(1) and 70(2) such that the brush plates can slide towards the center of the axle in the plane of the end plates 70(1) and 70(2). The geometry depicted in FIG. 12 comprises four 90° brush plates about the circumference of rotors 2(1) to 2(N/2)) of the first machine, of which 68(a,1) and 68(b,1) are visible, and a symmetrical group of four 90° brush plates about the circumference of rotors 2(N/2+1) to 2(N) of which 68(a2) and 68(b,2) are visible, whereas an actual machine might well comprise six or even eight brush plates on each side. The mild inclination of the brush plates relative to the rotation axis takes account of (i) the overlapping rotor rims as indicated in FIGS. 7B and 8D, with cumulative rim thickness largest at the center (the plane of rotor 2(N/2) and feathering out to zero at the edges of rims 3(1) and 3(N) of rotors 2(1) and 2(N) at the extreme ends near the motor end plates 70(1) and 70(2). (ii) Potentially different initial brush lengths in order to take account of the higher sliding speed and thus higher brush wear rates at the center. (iii) Possibly different brush wear rates on the (a)- and (b)-sides.

Thus, unlike the previous example of FIGS. 7C, 9A and 10, but in line with FIG. 8D, the brush plates are not cylindrical but conical. The reasons for potentially different brush wear rates on the (a)- and (b)-side is that they exhibit positive (brushes 27(n,a)) and negative (brushes 27(n,b)) electric potentials relative to the rotors. As a result, (a) and (b) brushes can, and typically do, exhibit moderately different brush resistances and wear rates at otherwise the same conditions. Even though the majority of bipolar or other homopolar motors will be required to occasionally reverse direction and thereby invert brush polarity, e.g. as in ship or car drives, most of their operation takes place in the same direction and correspondingly, if they are made of identical construction, brush plates 68(a,n) may tend to wear out faster, and in that case would have to be replaced more often than 68(b,n) brush plates, unless they accommodate initially longer brushes.

The outlined geometry would not require the significant pair-wise separation of brush plates along the machine mid-plane as drawn in FIG. 12B since brush wear would be strictly in radial direction and would be accommodated by the joints and bridges described in connection with FIG. 10A. However, some pair-wise separation of brush plates will be needed in order to avoid possible strong axial stresses through temperature changes or shock loads when plates are firmly anchored between motor end plates 70(1) and 70(2) via their respective mounting brackets 71(n) and linear bearings. Note, however, that the gap between plates 68(a,1) and 68(a,2) and similarly 68(b,1) and 68(b,2) is exaggerated in FIG. 12 since it basically serves the function of expansion joints in bridges and large buildings and its width would best only be, say, a percent or less of the overall motor length.

As in FIG. 10A so also in FIG. 12, the brushes on the brush plates are loaded against the slip rings on the rotor rims by means of constant force springs 37(1) and 37(2) across joints 76 and/or bridges 64. Generally, such springs should be applied across every flexible junction between adjoining brush plates in order to achieve as uniform brush pressure about the circumference as possible. Also in long machines more than one constant force spring may be advisable along the axial length of any one flexible part. Other types of brush loading are evidently possible, e.g. substitution of the constant force springs by spiral springs or spring clips, and these are not ruled out in the present invention disclosure. However, constant force springs are the almost universal means of choice for brush loading in existing technology and are liable to be preferred also here unless and until some better solution should be found.

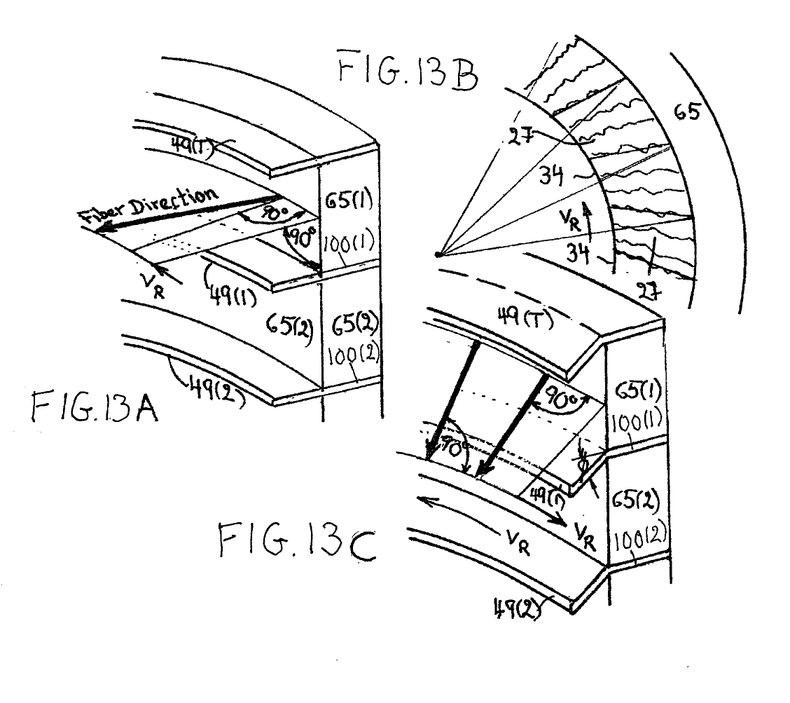

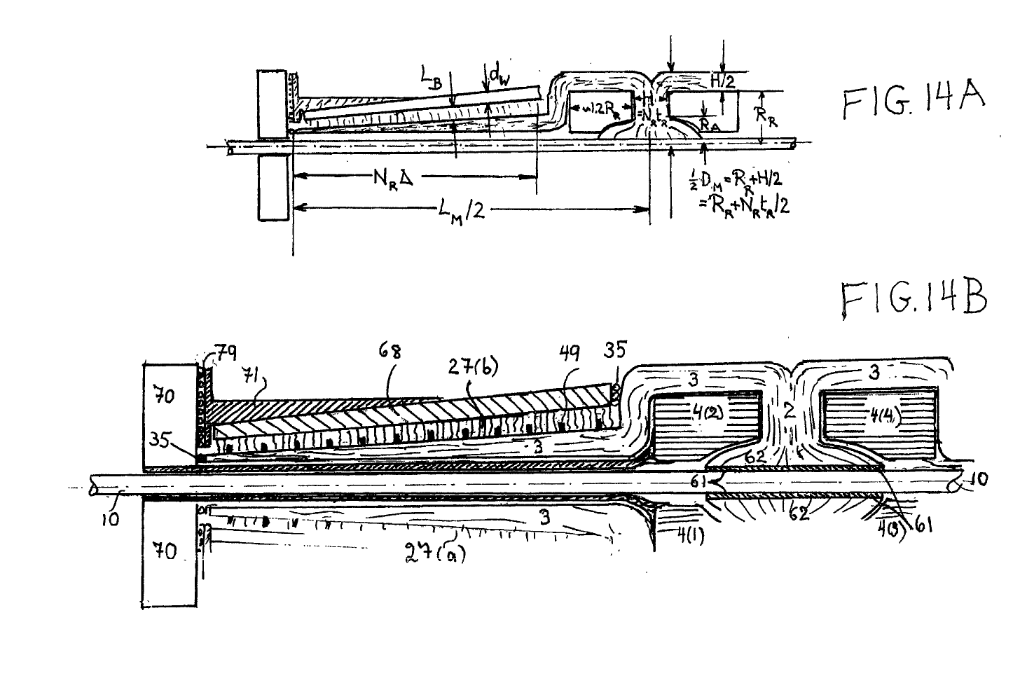

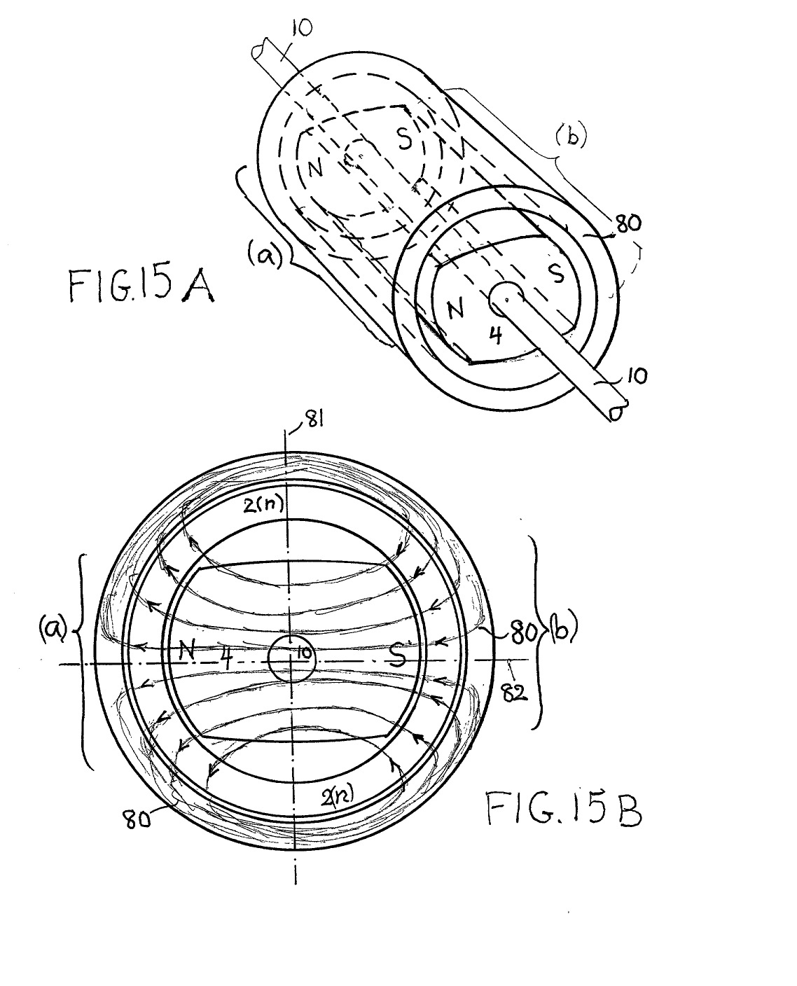

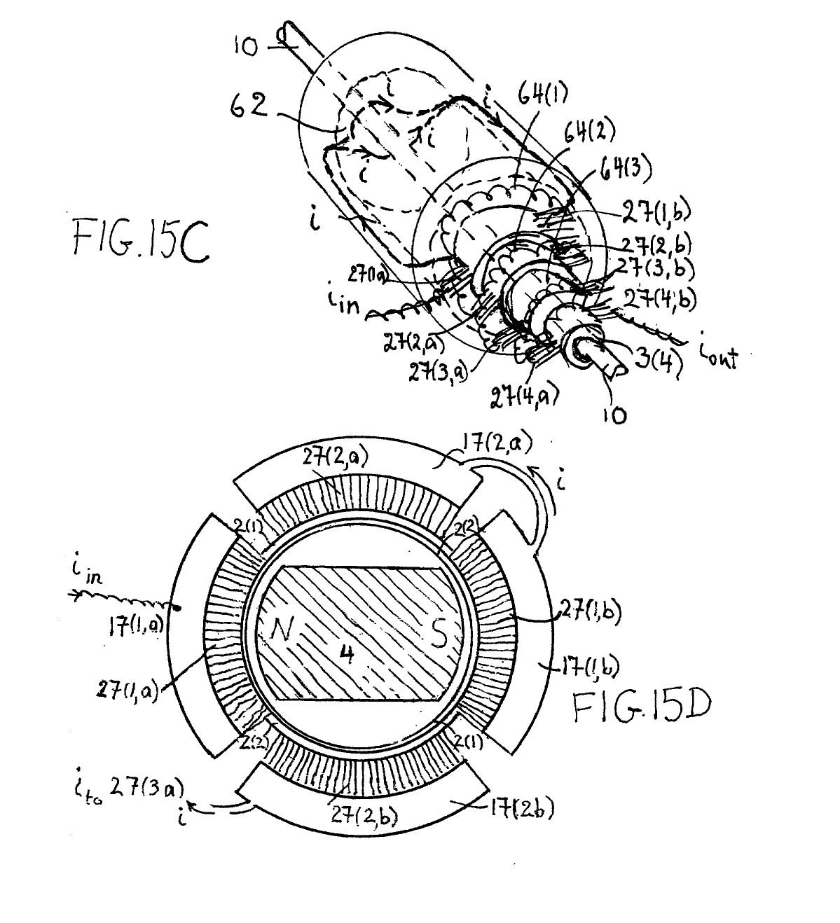

The desire to reduce brush wear and/or the need to permit reversal of machine rotation direction already discussed in conjunction with FIG. 8, will presumably not only be facilitated by scarfing of slip rings but also by slanting of brush fibers, as for example already indicated in FIG. 8D. The possible morphologies are (i) rotation of the average fiber direction about the axis in the plane of the interface, normal to sliding direction, as indicated in FIGS. 13A and 13B which give a perspective and plan view, respectively. When run on a slip ring parallel to the brush plate this causes sliding in leading or trailing direction. (ii) Rotating the fiber direction about the sliding direction as shown in FIG. 13C which results in scarfing orientation against a slip ring parallel to the brush plate. (iii) A combination of the two. Practical experience will be needed to determine the best approach from case to case.

(d) Manufacture, Replacement and Reliability of Brush Plates

The proposed flexible joints composed of thin foils between rigid brush plates and associated bridges (e.g. FIG. 10) according to the present invention lend themselves to mass production by using the same foil thickness throughout, as follows.

1) A sequence of rigid brush holder strips (65) with their brush strips (27) and intervening flexible joints (76) is made by stacking the requisite number of metal foils (e.g. copper or aluminum) in the intended shape and “potting”, in an electrically conductive hardenable adhesive, the intended lengths and positions of the future brush strips (65), while at the intended positions of flexible joints (76) the foils are left free.

2) The strips of brush material (27) (whose manufacture will be discussed further in section K) are affixed to the fused segments of the brush holder strips (65), e.g. by means of soldering or some (perhaps the same) electrically conductive adhesive that was used for “potting” or any other suitable method.

3) The resulting rigid strips (65) bearing fiber brush material (27) and the interlnked flexible joints (76) without fiber brush material are stacked with intervening insulating layers (48) and assembled into brush plate sections (68) by gluing the rigid segments together by means of insulating adhesive, optionally with intervening electrically insulating separators between adjoining brush strips (49).

In order to achieve the desired low friction among the separate foils in the joints (76), either some fraction of them must be cut out from the joints, or the volume fraction of the “potting” material in the rigid parts must be made large enough so that without it the joints have an adequately low friction. Also, a lubricant may be applied to the foils in the joints, provided that it will not spread to, and contaminate, the brushes and slip rings.

According to the present invention, in brush plates, aluminum foils could be advantageously substituted for copper foils. This so because at E_{A1}=6.5×10¹⁰ N/m² the elastic modulus of aluminum is just above one half that of copper, while on account of its electrical resistivity of ρ_{A1}=2.65×10⁻⁸ Ωm versus ρ_{Cu}=1.6×10⁻⁸ Ωm, for same electrical resistance the cross section A_{S} of Eqs. 14 and 15 would need to be increased by only 60%. The use of aluminum foils for the construction of brush plates, joints and/or bridges would also be attractive on account of low cost, excellent deformability in manufacture and easy availability of aluminum foils

Although the outlined method of manufacturing brush plates is part of the present invention, in being a unique not previously known combination of steps, it is not conjectural since all steps therein are already known to be feasible. In view of the successes of mass producing technological items involving small parts, it is therefore not doubted that, given an adequate volume of demand, brush plates can eventually be mass produced at low cost to become rather inexpensive.

It is not immediately apparent how best to place/replace brush plates on matching slip ring assemblies so that the individual brush strips make proper contact with their designated slip rings and are mutually electrically insulated by means of separators (49) as in FIG. 7B or slip ring extensions (33) as in FIG. 8D. This is no serious problem when slip rings and separators or slip ring extensions are relatively wide but will become a challenge as one drives towards more and more compact, power-efficient machines with thinner and thinner separators or slip ring extensions. In terms of say, the left side of FIG. 7B, the question is how in installing brush plates one places the assembled brush strips so that brush 27(n,a) contacts slip ring 3(n) and none of its fibers straddle insulators 49(n−1) and 49(n) to cause a short-circuit between slip rings 3(n−1), 3(n) and 3(n+1). Similarly in terms of FIG. 8D, how does one install a brush plate so that fiber strips 27(1) . . . 27(N) smoothly fit into the spaces between slip ring extensions 33(1) . . . 33(N+1), without damaging the fiber strips.

Again, this is not difficult if one leaves sizeable gaps between neighboring brush strips 27(a) and similarly 27(b), but increasingly power-efficient machines will require increasingly slender separators. According to the present invention two primary methods are used as follows: (1) shaping brushes such that initially their running surfaces are compressed so as to leave gaps between neighboring brushes and (2) using temporary separators between brush strips, say, 27(n−1,a), 27(n,a) and 27(n+1,a) etc. that are withdrawn as the brushes slip between the respective separators 49(n−1), 49(n) and 49(n+1) or slip ring extensions 33(n−1), 33(n) and 33(n+1). Fortunately, too, it is now possible to produce rather shape-retentive fiber brushes that do not splay and are not too easily damaged. Additional methods will be further discussed in Section K(d)

Further, by the design of FIG. 12B, removal of brush plates would involve no more than detaching constant force springs 37, releasing connector plates 72/73 (not shown in FIG. 12), and detaching brush plates 68 from their linear bearing brackets 71. Installation of new plates would be done by reversing these steps.

Regarding reliability, again experience with modern technology of mass production is very reassuring. Also, years of laboratory experience indicate that erratic strong increases of brush resistance and brush wear rates such as are a problem with traditional graphitic brushes are virtually non-existent for fiber brushes. Although their resistance and wear rate can fluctuate, the changes exhibited by fiber brushes are gradual, occurring over hours or more. Therefore one may be confident of generally predictable behavior of brush plates. Even so, at least for large machines it will be advisable to install on or at each brush plate, firstly, a contact resistance monitor between plate and rotors and, secondly, a proximity gauge to monitor wear distances. In relation to the cost of large machines the cost of such monitoring and alarms in case of malfunction will be small.

A major contributor to problems with brush plates, if any, is expected to be wear debris that is similarly problematic for brushes in closely spaced individual brush holders. Inevitably, the rate of wear debris production is proportional to the area of active slip ring/brush interface, A_{S}, and thus can be sizeable in accordance with equation 3. Fortunately, the debris of multi-contact metal material is much more innocuous than the carbon dust that is shed by graphitic brushes because, firstly, metal fiber wear debris is chemically inert and secondly, it is essentially non-conducting. These favorable features result because the fiber brush wear debris particles are chemically inert and do not significantly adhere to each other. Consequently, current through accumulations of multi-contact metal brush wear debris is transported across large numbers of contact spots in series that are very small on account of the small forces among them, even while the intervening film resistivity tends to be large. By contrast, carbon wear debris is chemically reactive and the particles in it adhere to each other to produce a remarkably low electrical resistivity of carbon brush wear debris.

The concern that multi-contact metal fiber wear debris could lodge in narrow brush tracks and interrupt conduction is remote according to available experience. It has not been observed in any previous tests except when the fiber material was strongly contaminated with organic substances, mainly left over from commercial wire drawing. Even so, it can be combated if observed by (i) flushing out wear particles either periodically or continuously as part of machine cooling, best with water. (ii) Provide wells where wear debris is likely to settle at low areas in a machine, to capture and permanently remove wear debris from circulation in the machine.

(f) Mechanical Structure and Assembly of Machines

The weights of magnets (specifically 4(1) to 4(4) in the machine of FIGS. 8 and 12) rotors and brush assemblies must be mechanically supported, as well as the force of the force of attraction among the magnets. In FIG. 12 this is done by the use of strong, non-rotating endplates, 70(1) and 70(2), through which axle 10 passes; or a common endplate in the case of tandem machines (i.e. plate 70(2) in FIG. 12A). The magnets could be attached to the endplates at their outer ends by means of bolts, or by means of screw threads about the magnet circumference and matching treaded openings in the base plates, or by soldering, brazing or any other means, e.g. gluing with a suitable adhesive. Alternatively, the magnets could be mounted into suitable framing, e.g. with struts fitting into gaps 78(1) to 78(4), and the framing could be fixed to the machine endplates either directly or indirectly via tie rods 69 or other supports by means of which the motor endplates are attached to each other.

Advantageously, according to the present invention, instead of parallel flat, solid endplates as in FIG. 12, other shapes or structures may be used. Thus endplates could be arbitrarily curved (e.g. for less drag in a fluid environment), could be variously perforated or be made of grids or meshwork (e.g. in order to decrease the machine weight or to facilitate cooling), and in any of these cases could be made of metal, ceramics, plastics, composites and any combination of these. Alternatively, endplates could be eliminated in favor of tubing, again solid or perforated and be made of any suitable material, in which case the structural support for the machine must extend either from the tubing or from its end perimeters, or both. Thus supports could span the circular openings at either or both ends and encircle the axle by means of low-friction bearings. Again, any of these possibilities could be executed in a variety of ma-terials, including iron and steel, copper and copper alloys, aluminum alloys, ceramics, such as fiber glass, polymers or composites of any type, e.g. metal, fiber glass or carbon fiber composites, and any combinations of these, to name a number of potential choices. Actual solutions will be dictated by various parameters including strength, volume, weight, corrosion resistance, acoustic properties, shock resistance and cost. The specific design of FIG. 12 is depicted mainly because of its simplicity but it is not meant to be exclusive in any way.

Much the same general considerations regarding shape and choice of material apply also to the other structural details of the machine, including to the means of fastening the motor to the axle. The solution depicted in FIG. 7B, namely a cylindrical attachment between rotors and axle is by way of plausible example but not meant to be exclusive, as already emphasized previously.

Assembling bipolar machines with rotors of simple shapes, as in the present example, poses no problems, provided that means exist to pass the axle though a completed machine. Specifically, the rotors are simply nested petri-dish- or cup-shaped metal sheet. Experience with the ubiquitous beer and soft-drink cans and with very common commercial tubing down to quite thin wall diameters, indicates that these can be produced inexpensively in large numbers even if their peripheral rims should be fairly extended.

Assembling the rotors into sets, once all of the requisite sizes have been made, requires nothing but mechanical stacking while the rotors are still wet from dipping them into some suitable lacquer or other hardenable polymer or cement that on drying will glue them together at small layer thickness of insulating material. Next the magnets may be put into place and fastened to their respective motor end-plate, or may be placed into the annular spaces on opposite ends of the rotors by any conventional means after they have already been attached to the endplates, and similarly the linear bearings with their brackets. The endplates would be joined by tie-bars 69 and the brush plates 68 would probably be installed last in the already described manner. The order in which the enumerated steps are performed in constructing a bipolar machine is optional, but the indicated sequence appears to be practical

(g) Optimizing the Ratio of Machine Diameter to Power

In a number of applications, specifically for podded ship drives, there is a premium on small diameter to machine power ratio while the machine length is of little concern, provided it does not much exceed a length to diameter ratio of six or seven. Alternatively, there may be a premium on reduced slip ring diameter so as to reduce brush speed and thereby to extend brush life. The design on FIG. 14 accomplishes these goals by extending rotor rims 3 beyond the length of magnets 4, and there bringing them in closer to axle 10.

Its drawback is a reduced motor efficiency and increased complexity of design. Most likely it will have to be constructed in two halves, e.g. the (a) and (b) half separately. The slip rings will then have to be accurately assembled and will have to have a very low run-out, e.g. no more than 0.001″=25 μm.

(h) Numerical Values for Bipolar Machines with Circular Rotors

The power of a homopolar machine is limited by the maximum permissible fractional loss,

[symbol]

= [symbol] _{Ω}/V_{M} (17)

It is dominated by the voltage drop on account of the internal resistance of the machine, i.e.

[symbol]

_{Ω}≅i [symbol] ᵢₙₜ≅V_{M} [symbol] (18)

Therefore for a machine operating with current i and voltage V_{M}, of nominal machine power W_{M}, it is

W_{M}=iV_{M}=V_{M}² [symbol] / [symbol] ᵢₙₜ (19)

while

V_{M}=N_{R 1}V_{R}≅N_{R}v_{R}R_{R}B (20)

according to eqs. (4) and (5)

W_{M}≅(N_{R}v_{R}R_{R}B)² [symbol] / [symbol] int (21)

However, [symbol] is mostly proportional to N_{R}/R_{R} since the current path lengths are proportional to N_{R} R_{R} and the conductor cross sections to 1/R_{R}² while [symbol] int is proportional to N_{R}. Hence, to a first approximation, the maximum machine power is

W_{M}∝v_{R}²R_{R}³B² [symbol] (22)

i.e. rises

linearly with the permissible loss, [symbol] ,—which is problematic because the waste heat must be removed by forced cooling;

in proportion with v_{R}², i.e. the rotation speed,—whence the great advantage of increasing v_{R} beyond the maximum brush velocity of about 20 m/sec, as by the design in FIG. 14, but whence also the difficulty of designing homopolar ship drives with slow rotation speeds;

with the third power of the rotor radius, i.e. in essence linearly with the machine volume and mass;

in proportion with the square of the magnetic flux density, B², whence the advantage of superconducting magnets, with B in the range of 4, whereas B≅1 tesla for permanent and electro magnets.

Anyway, eq.22 is useful for making rapid back-of-the-envelopes estimates of the maximum power of homopolar motors with circular rotors. Specifically the internal resistance per rotor, [symbol] ᵢₙₜ/N_{R}, was estimated for the particular motor of FIG. 14 with R_{A}=R_{R}/2, i.e. α=½ (see eq.5), and with uniform thickness of rotor and rim of t_{R}=R_{R}/N_{R}, as follows:

1) The resistance of the two half-circle annular areas, i.e. in the gap and leading the rims back towards the axle after passing the magnets and current traverse in part (a) and part (b) is, for a single rotor, (4ρ/πt_{R})ln(R_{R}/R_{A})=ρ0.88/t_{R}.

2) The resistance of the two half-cylinders formed by the rim along the magnet height of 1.2R_{R} is 2×ρ1.2/πt_{R}=ρ0.76/t_{R}.

3) The resistance of the two half-cylindrical rims of average length N_{R}Δ is 2×ρ N_{R}Δ/πt_{R}R_{R}=0.64×ρΔ/t_{R}².

4) The resistance of the brush holders and bridges correlated with the (a) and (b) side of the rotor and of width d_{w} is 2πρR_{R}/d_{w}t_{R}

The total internal resistance per rotor is thus

₁ [symbol] ᵢₙₜ=ρ{(4/πt_{R})ln(R_{R}/R_{A})+2.4/πt_{R}+2N_{R}Δ/πt_{R}R_{R}+2πR_{R}/d_{W}t_{R}}≈ρ{0.88/t_{R}+0.76/t_{R}+0.64Δ/t_{R}²+2πR_{R}/d_{W}t_{R}} (23)

Introducing numerical values shows that the internal resistance is dominated by the fourth term, i.e. the brush holder so that in first approximation one may write, with 0.75R_{R}≅N_{R}t_{R}

₁ [symbol] ᵢₙₜ≈ρ2πN_{R}/d_{W} (24)

Hence with eq. 19

W_{M}=(N_{R}V_{R}²/ [symbol] ᵢₙₜ) [symbol] ≈[V_{R}²d_{W}/ρ2π] [symbol] (25)

and with eq.5 and n=2, α=½ and d_{W}/R_{R}=δ_{W}

W_{M}≅[V_{R}²d_{W}/ρ2π] [symbol] ≅(0.12v_{R}²B²R_{R}³δ_{W}/ρ) (26)

By use of the typical values of v_{R}=20 m/sec, B=1 Tesla and ρ=1.6×10⁻⁸ Ωm for copper, the simple relationship

W_{M}≅3×10⁹δ_{W}R_{R}³ (27)

follows. Based hereon, remarkably high possible values for the power of bipolar machines of this type follow. This topic would be further pursued, were it not that bipolar machines with cylindrical rotors are yet much superior as will be discussed next.

C. Bipolar Machines with Cup-Shaped or Cylindrical Rotors (FIGS. 15 to 22)

(a) Bipolar Machines with Cup-Shaped Rotors

FIGS. 7B and 14 suggest that preferably the magnetic field should penetrate the elongated cylindrical rims 3 rather than the geometrically smaller circular rotors 2 of the machine, which so-to-speak form the bottoms of nested cups, rather than the other way around, while maintaining the feature of bipolarity, i.e. n=2. According to one form of the present invent-ion, this is accomplished by enclosing an axially extended bar-type magnet 4, whose direction of magnetization is normal to its long axis, in a set of rotors 2(n) in the form of axially extended cups. The cups are provided with eddy current barriers on the cylindrical parts but are free of such at their bottoms 62, in the pattern of FIG. 6C but in this case with the eddy current barriers, i.e. eddy cuts or other current channeling means, intersecting the outer circumference 20. Further, the described set of cup-shaped rotors is surrounded with a cylindrical flux return 80, as indicated in FIG. 15A (the same as the top of FIG. B).

In the described geometry, the magnetic field penetrates the cylindrical parts of the set of rotors with maximum intensity within two zones that are axially extended and are situated in diametrically opposite locations adjacent to the N-pole and the S-pole of magnet 4, respectively. The magnetic field is at maximum in symmetry plane 82 in 15B (the same as the bottom part of FIG. B). Within the zones of strong magnetization, that together comprise roughly one third to one half of the cylindrical part of the rotors, the magnetic field is substantially radial and, being anti-mirror-symmetric with respect to plane 81 at right angles to the direction of magnetization, vanishes where that plane intersects the cups. Furthermore, within the rotors the magnetic field direction is substantially parallel to the magnet's direction of magnetization and has the same orientation in both zones of strong flux penetration. This is shown in FIG. 15B which indicates the approximate geometry of the magnetic field by means of arrowed lines.

Dubbing the zone of strong flux penetration nearer to the N-pole the (a)-zone and the zone of strong flux penetration nearer to the S-pole the (b)zone, it follows that a positive current flowing from the outside circumference in the (a)-zone to the bottom of the cup will give rise to a clockwise torque, and on a return journey from the bottom to the outside circumference in the (b)-zone that current will similarly give rise to a torque of same strength and also in clockwise direction.

FIG. 15C, which is a simplified perspective sketch of a bipolar motor with cup-shaped rotors of staggered lengths, clarifies the current path. In general terms, taking the example of a bipolar motor with cup-shaped rotors, the current is driven by an applied voltage between brushes 27(1,a) and 27(N,b) (where N=4 in FIG. 15C). Consequently, on account of the “bridges” 64(n) between brushes sliding on slip rings of neighboring rotors, a voltage drives the current from brush 27(n,a) to 27(n,b) which brushes slide on a slip ring at the outside circumference (20) of rotor (2n), wherein brush 27(n,a) is located in the (a)-zone and brush 27(n,b) is located in the (b)-zone. However, due to the eddy cuts or other current channeling means that intersect the outside circumference 20 of the rotor, these two brushes are electrically connected only via the bottom of the cup (62) that is free of eddy current barriers (18). Therefore, constrained by the eddy current barriers the current flows from brush 27(n,a) in zone (n,a) axially along rotor n until it reaches bottom of the cup 62(n), as shown in FIG. 15C by means of the arrow line labeled i. Here the current is unconstrained and flows about axle 10 that penetrates through it toward zone (n,b) From there, now again constrained by eddy current barriers, the current travels axially along zone (n,b) to brush 27(n,b).

The outlined progression of the current path from rotor to rotor, successively from rotor I to rotor N, beginning with brush 27(1,a) in the (a)-zone of rotor 2(1) and ending at brush 27(N,b) in the (b)-zone of rotor N, is accomplished by electrically connecting brushes 27(n,b) and 27((n+1,a) via bridges 64(n). These are shown as spiraled lines in FIG. 15C but in actual fact could be flexible cables or, more likely in large machines, be parts of bridges 72/73 of brush plates as in FIG. 10A. Especially if the number of brushes is fairly large, brush plates will be the favored solution and the considerations given in their regard, in connection with FIGS. 7C to 14, are applicable except that in bipolar motors with cup-shaped or cylindrical rotors, bridges can be used from both sides of the two zones, e.g. there could, and favorably should, be counterparts to bridges 64(1) to 64(3) above the slip rings in the view of FIG. 15C also underneath, and similarly in FIG. 17B. This doubling of bridges provides a considerable advantage since as shown in the calculation of the internal resistance for the bipolar machine with circular rotors, the brush strips and bridges are liable to be the dominant contributors to the internal machine resistance. By making bridges from both directions, that is not possible with circular rotors, the corresponding resistance is halved.

The set of rotors (label 2(n) in FIG. 15B and for clarity not shown in FIG. 15A) rotates in the space between magnet 4 and flux return 80. The strip-shaped bar-type magnet 4 that provides the magnetic flux could in principle be a permanent magnet, an electromagnet or a superconducting magnet, as may be deemed most suitable. However, lack of space will typically make permanent magnets the favored option. Also, axle 10 must pass through the magnet, and similarly the axle will pass through what amounts to the bottom of the cup, labeled 62 in FIG. 15C.

Typically, slip rings are located beyond the geometrical extent of the magnet and thus in positions of low or negligible magnetic field strength. The brushes on them are positioned to connect with the conductors (that are separated by the eddy current barriers) within zones (a) and (b) of strong magnetic flux density. Correspondingly, in both FIGS. 15C and 17B, the brushes are shown as geometrically in line with the magnetic N- and S-poles, i.e. about symmetry plane 82 shown in FIG. 15B. This is not necessary, though, because the eddy current barriers could be spiraling. in the slip ring part of the rotors In fact, by applying such spiraling in different strengths and/or directions in individual rotors, it will be possible to distribute brushes more or less evenly about the circumference, and in the process shorten the lengths of “bridges.” This is shown in FIG. 15D. Such an arrangement may be desirable by the use of individual brush holders but probably not with brush plates. .

The cups in the machines are stacked in much the same geometry as utilized for the machine with circular rotors of FIG. 14. Also in the present case it is possible to reduce the slip ring diameters below those of their rotors. Whether or not one will opt for reducing the slip ring diameters relative to the diameter of the cylindrical part of the cup, depends on whether it is more desirable to reduce the brush sliding velocity by means of reduced slip ring diameters as in FIG. 14, or is more important to reduce brush current density by means of larger slip ring circumferences. In practice, the diameters of the slip rings are liable to represent a compromise between low brush sliding speed and low brush current density (compare the numerical examples below).

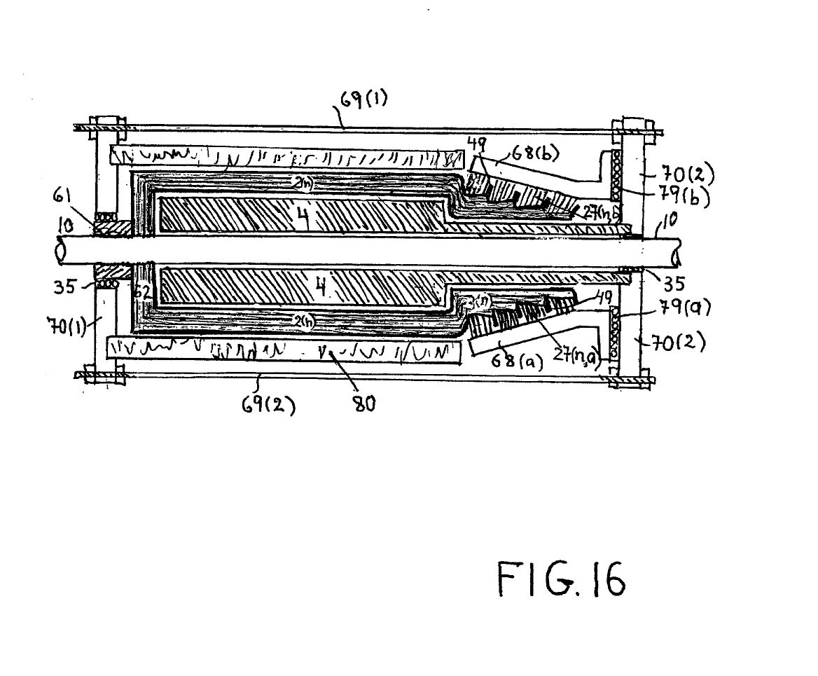

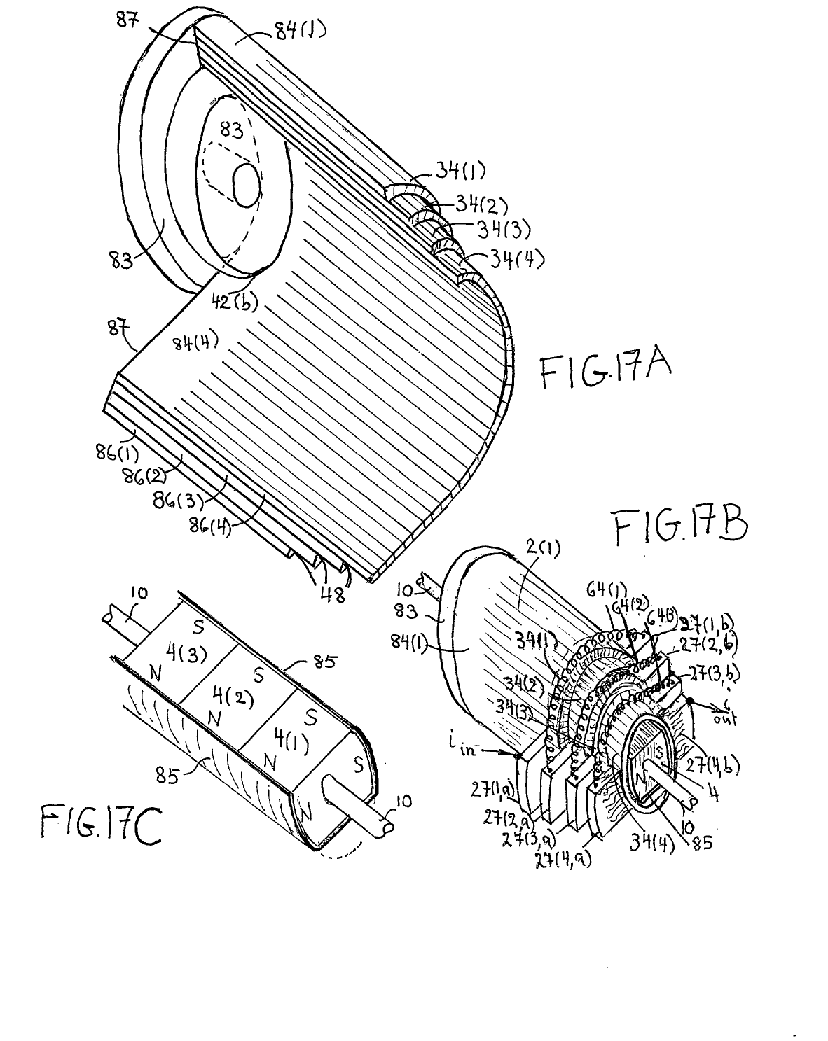

The mechanical construction of the machine is shown in FIG. 16 by means of a lengthwise section. It is just one example of doubtlessly many different methods for insuring mechanical stability of the machine. It is important, though, that the set of rotors rigidly rotates with the axle and is rigidly fastened to it, as indicated by label 61 in FIG. 16. The magnet 4, the flux return 80, the brushes 27 and their individual holders or their brush plates 68, as the case may be, will be mechanically attached to the motor endplates 70(1) and/or 72(2), in whatever method or arrangement may be convenient. In the example of FIG. 16, the flux return 80 is fastened to motor endplate 70(1) and the remainder, i.e. the magnet, and the brush holders are attached to motor endplate 70(2). The shapes and means of mutual attachment of the magnet etc to the endplates is subject to wide variations and, again, the design of FIG. 16 is just an example. Further, the endplates may be hexagonal or quadratic or circular etc. They may be joined by tubing or by angle iron or other profiles instead of or in addition to, tie rods 69. Nor need the endplates be solid, but as already discussed in connection with bipolar machines with circular rotors, they may be perforated or may be in the form of grids, especially if direct water cooling is employed. Further there may be no end-plates at all but they may be replaced by struts etc.

(b) Bipolar Machines with Cylindrical Rotors and Their Manufacture

Three Simple Methods of Making Bipolar Machines. Even though on first sight the above discussed embodiment of the present invention of an axially extended bipolar machine with cup-shaped rotors, as in FIG. 16, appears to be the optimal design, it is distinctly inferior to the second embodiment of the invention, namely based on nested open-ended cylindrical rotors. The reason for that superiority is mainly cost and ease of manufacture. Namely, making multiple nested, elongated cup-shaped rotors of small wall thickness, whether or not comprising rims of decreased diameter relative to the rotors, and which cups rotate with the machine axle and whose interior contains a stationary elongated magnet, poses severe (perhaps insurmountable) precision manufacturing problems if it should be attempted to deep-draw the rotors individually.

By contrast, according to the present invention, in bipolar machines with cylindrical rotors the three-dimensional complication of cup bottom 62 is avoided by providing a bottom strip 84 that is free of eddy current barriers and extends beyond the end of the magnet on the side opposite to the slip rings. In this strip the electrical cross connection is made between brushes 27(n,a) and 27(n,b). Thereby the opportunity is generated to avoid deep drawing or other complex methods in favor of winding sheet metal stock onto rollers. As a further bonus and discussed below, a machine with cylindrical rotors is more easily adapted to alternative use with DC and AC.

Three alternative methods are herewith proposed by which to manufacture bipolar machines with open-ended cylindrical rotors. The descriptions of the first two methods focus on the particular case that eddy cuts are used, since these pose particular challenges that are not encountered by the use of other current channeling structures, e.g. rotors made of a current channeling material such as a composite of metal fibers in a polymer matrix. However, the first two methods are directly adaptable, and are intended to be used, also for machines with other current channeling means, and in particular also with rotors comprising current channeling material. Method 3, by contrast, is specifically tailored to the use of current channeling material for rotors, i.e. rotors that are inherentlyl structured for current channeling such as made of polymer matrix/metal fiber composites.

Method 1 is indicated in FIG. 17. Herein 86(1) to 86(4) (and in general an arbitrary number 86(N)) is a set of mutually electrically insulated but mechanically joined metal sheets (e.g. by means of lacquer that is still soft when adjoining pieces are fitted together) of the de-sired material and thickness t_{R}. Sheets 86(n) comprise current channeling structures in the indicated configuration, which may be, but not necessarily are, eddy cuts that are filled with an insulating adhesive material (e.g. stop-off lacquer or an insulating epoxy). The border at the left edge 84(4) is already mentioned bottom strip that is free of current channeling means and hence electrically connects all points along the right hand edge of sheet 86(4) that in the rolled-up configuration forms the innermost rotor, and similarly for all of the other sheets.

The widths of the layered sheets are graded as shown so as to form the series of slip rings 34(1) to 34(4) of the machine once the sheets have been rolled up into rotors as indicat-ed in FIG. 17B. The sheets are shown in the partly rolled-up condition in FIG. 17A Their lengths are graded so that in the fully rolled condition the two long edges are fiat and “butt-end,” to be joined with an insulating adhesive for forming the machine as in FIG. 17(B).

Part 83 at the border 84 is made of a mechanically strong material that serves as the means of mechanically fastening the set of cylindrical rotors 2(1) to 2(4) (and in the general case 2(n) from 2(1) to 2(N)) releasably to axle 10 such that there is no electrical contact among any of the rotors 2(n) (i.e. the rolled-up sheets from 86(1) to 86(N)), and thereby 83 serves the same function as 61 in the previous figures. The shape of 83 in FIG. 17A is just one possible example of a great variety of shapes that could be used for that purpose For example, part 83 could be a simple cylindrical disk that only contacts sheet 84(4), or its vertical rim could extend over only part instead of all of the collective rotor end surface 87 radially and/or circumferentially. Part 83 could be made of metal or an insulator, and could be glued by means of some suitable adhesive to both axle 10 and rotor parts 62(n). or it could be fastened via shrink-fit to the axle, or via a collar and set-screw, or via a low-melting solder to either or both sides. However, importantly, the different rotors must be electrically insulated from each other. As throughout, this could be accomplished by means of insulating adhesive layers 48 such as a lacquer or an epoxy.

In manufacture, however, the sketched disk-shape of 83 as the only support for rolling up the stack of sheets 86(n) may be unsatisfactory because the rotors must be fabricated with good precision on account of the required low run-out of the slip rings (since brushes wear out too fast unless the run-out is kept below about 0.001″). Therefore the sheets should be rolled onto, and be made to close upon themselves on, a precisely made cylinder, and either 83 must be elongated into such a cylinder, or the sheets have to be wound and glued together on a suitable cylinder, then be removed therefrom and then part 83 be inserted. Or, finally, in continuous manufacture it might be a tool of the kind used in manufacturing of tubing.

The butt-end joining of the two long edges of the stack of sheets 86(n) may have to be done with insulating adhesive or lacquer if it should prove to be too difficult to conductively join the respective free edges of sheet 86(n) without inadvertently creating short circuits among neighboring layers, as seems likely. Such an insulating axial glue joint would create a current barrier in axial direction across all of the bottom strips 84(1) to 84(N) so as on average double the ohmic resistance of the current in strips 84(n) on the path between brushes 27(n,a) and 27(n,b). However, as will be shown later, the corresponding contribution to the internal machine resistance will be insignificant compared to the other terms provided that the width of bottom strips 84(n) is a not too small fraction of the rotor radius R_{R}.

Making a motor of the type in FIGS. 15 and 16 after obtaining the set of rotors in the form of a rolled-up cylinder according to FIG. 17A will require some care. In particular it will be necessary to avoid a significant elastic twist of rotors and magnets that would cause misalignment between eddy cuts and thus misalign the current path and the zone of magnetic penetration. If a continuous method as in the manufacture of tubing already mentioned is used, staggering of lengths as in FIG. 17A is impossible and pre-formed slip ring assemblies will have to be attached as further described in connection with method 2 below.

In view of the typically poor mechanical properties of permanent magnets and the cost of continuous, long magnets, it is proposed to use several or many smaller magnets in a shaped tubing, or in a tray 85 as in FIG. 17C, in lieu of a single magnet. This will certainly cut cost of magnet material and will not affect machine operation. However, all of the force due to the machine torque will in this case have to be supported by the tray or shaped tubing and it must be correspondingly strong.

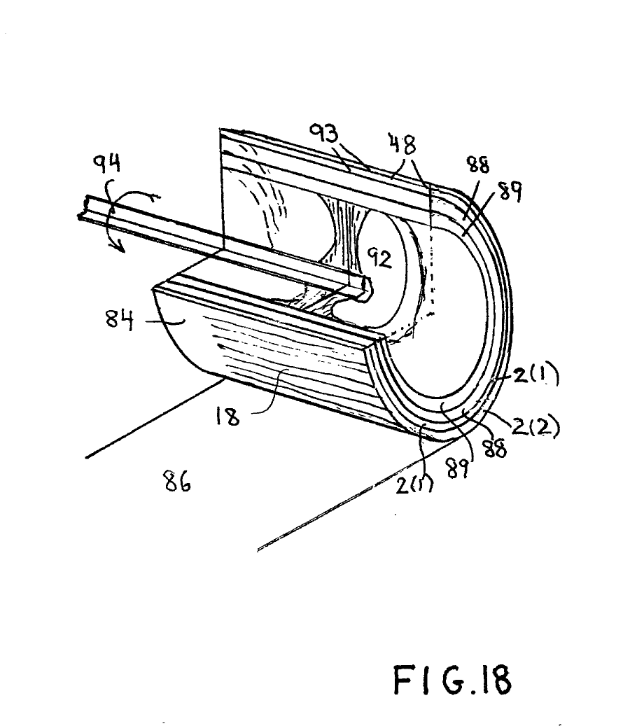

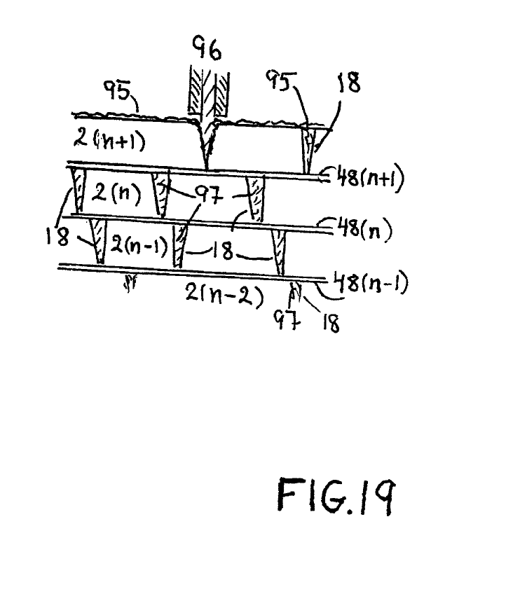

Method 2: Method 1 yields slip rings of same diameter as the corresponding rotors, and it will be difficult reduce or increase slip ring diameters while maintaining low run-out. Also, a nonconductive barrier across the bottom strips 84(n) is undesirable. Therefore ac-cording to a second embodiment of the present invention, illustrated in FIGS. 18 to 21, there is provided a method which permits independent choices of rotor and slip ring diameters. It has the additional benefit of perhaps being more accurate and economical than the first.

In this method 2, the principle of which is illustrated in FIG. 18, continuous metal sheet stock 86 of thickness ≦t_{R}, i.e. smaller than or equal to the desired thickness of the rotors in the stack, is wound onto a roller 89 in successive intervals of the desired rotor thickness t_{R}, and eddy cuts are made, either continuously or at the completion of an interval. After the completion of any one t_{R} thick layer, i.e. rotor, the sheet stock 86 is cut off and an insulating layer 48 is supplied before starting a new t_{R} thick layering.

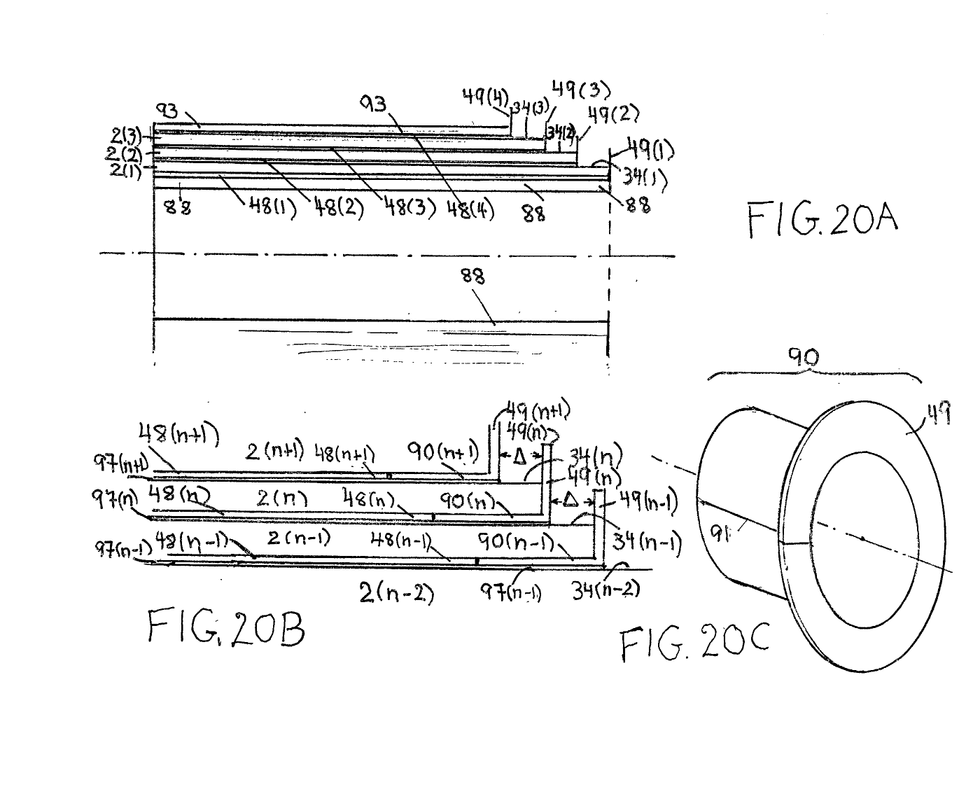

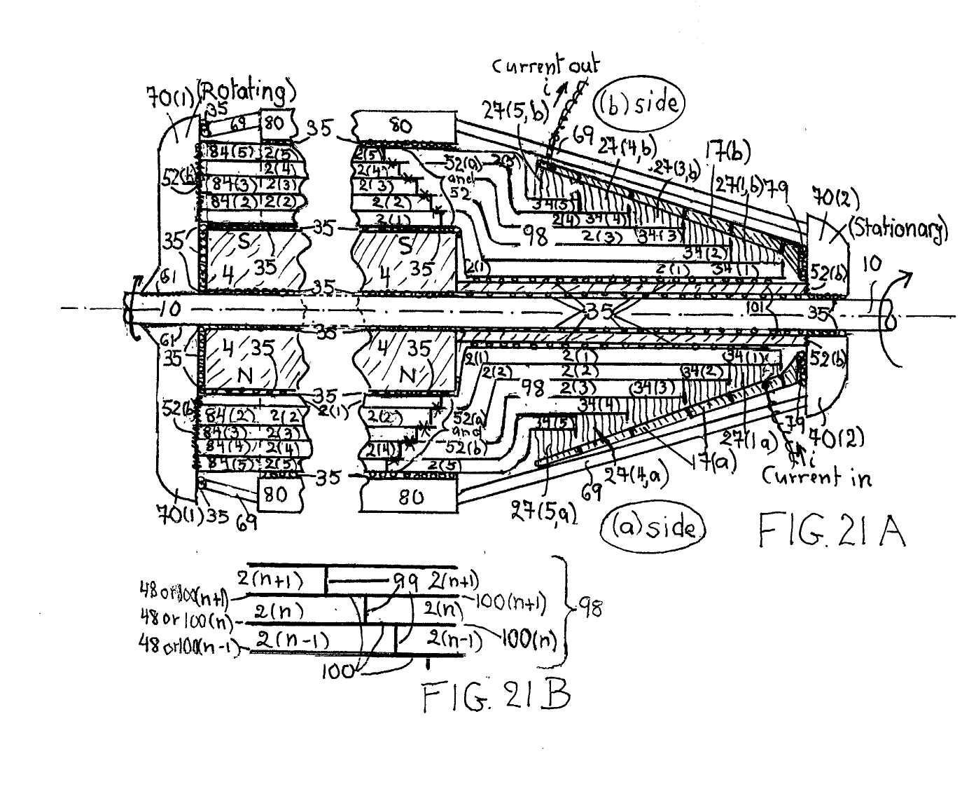

FIGS. 19 and 20 provide further details, including the production of slip rings. To begin with, the very first layer of the first t_{R} thick interval is deposited on roller 89 or on an insulating layer 48(1) that has been coated with an adhesive (preferably but not necessarily insulating). Similarly, the first layer of each t_{R} thick interval, in general the n^{th} layer, is glued to an insulating layer 48(n) that in turn is glued to the topmost layer of sheet stock of the previous interval, preferably but not necessarily by means of insulating adhesive.

On account of the force of tension, a stack of rotors may be wound in the outlined manner without the use of adhesive except as may be required to prevent unraveling from the outermost layer. This will be the quickest and least costly. However, in order to form solid rotors of maximum strength from the described layering of wound metal sheet stock, adhesive is continuously applied to the surface of the sheet stock, i.e. while sheet stock is laid down within any one t_{R} interval. Thereby each turn or layer is bonded to the turn or layer of sheet stock underneath, until a strong, solid cylindrical rotor of wall thickness t_{R} is completed.

For maximum electrical conductivity, the adhesive applied among the turns forming a single rotor, should be conductive. However, if so, the eddy cuts cannot easily be made on individual layers or on small groups of layers because the cutting blade is liable to smear conductive adhesive into the cuts, thereby causing shorts between the two sides and making the cuts ineffective. Conversely, by the use of insulating adhesive and a suitable cutting technique, as illustrated in FIG. 19, still liquid or viscous insulating adhesive 95 may be dragged into the cut and at the same time prevent accidental short circuits between the sides of a cut and provide mechanical strength on hardening.

One may therefore choose to apply insulating adhesive and make the eddy cuts continuously on single turns as they are being wound, at the penalty of somewhat increased electrical rotor resistance. Alternatively one may choose to bond the windings into rotors by means of conductive adhesive and defer making the cuts until a predetermined fraction of the intended wall thickness has been generated or a whole layer of thickness t_{R} has been formed, then make the cuts by the use of insulating liquid or lightly viscous adhesive 95 as indicated in FIG. 19.

In the simplest modification of the present method 2 of generating rotor sets by means of winding onto rollers, sheet stock widths are staggered, comparable to FIG. 17A so as to provide parallel slip rings of same diameter as the rotor to which they belong In that case one begins with the widest sheet for the innermost rotor (comparable to sheet 86(4) in FIG. 17A, but in the following outline labeled sheet 86(1)). Further, roller 89 is dimensioned to yield the desired inner diameter, R_{A}, of the set of rotors.

Preferably, according to the present invention, winding should either start with one or a multiplicity of layers of an insulating, low-friction material such as teflon to facilitate removal of the completed set of rotors from the permanent roller 89. Alternatively, and typically better, wind the sheet stock onto a thin-walled tubing 88 that will be permanently incorporated into the machine, reminiscent of the cardboard tubing in rolls of toilet paper.

Elaborating on what has already been outlined above, the steps of method 2 are as follows: If using metal sheet stock 86 of thickness t_{R} and of width L(1), apply (in any desired manner, e.g. by brushing, spreading, spraying, dipping . . . ) an electrically insulating adhesive or cement to the surface of the inner tubing 88 or insulating layer 48(1). Wind on one turn of sheet 86 and, in any desired order, cut off from the remaining sheet stock, apply insulating ad-hesive to all of the outside of sheet 86 except for a width A that will form slip ring 34(1), make eddy cuts over the whole sheet 86 except for bottom strip 84(1). Next place or wind onto the adhesive-covered sheet 86, complete with eddy cuts (that now has become rotor 2(1)), an insulating barrier material 48(2) covering sheet 86 completely except for slip ring 34(1). Continue with rotor 2(2) by using the same method but with sheet stock of width L(2)=L(1)−Δ that is aligned with rotor 2(1) at the current return strip edge 87.

Optionally, and more favorably, especially for t_{R}>≅1 mm, use thinner sheet stock, e.g. of thickness just below (to make allowance for the adhesive) t_{R}/2, t_{R}/3, t_{R}/4 and in general t_{R}/n. In that case the same procedure is followed except that as much sheet stock is wound onto the roller as needed to generate wall thickness t_{R}. Further, by the use of sheet stock of thickness ≦t_{R}, one may inhibit the opening of eddy cuts on account of winding tension and greatly increase the strength of the resulting set of rotors, by continuously applying adhesive until rotor thickness t_{R} is reached. As already explained above, the choice between conductive and non-conductive adhesive between the layers that form any one individual rotor, is the choice between maximum electrical conductivity and ease of making the eddy cuts.

In either case, either continuously or when a suitable fraction if not a complete t_{R} layer thickness of conductive rotor wall has been laid down, apply eddy cuts in axial direction over the whole width of every layer except for the bottom strip 84 that in the completed machine serves as current path between brushes. In this operation, care must be taken not to mechanically open up the cuts through the winding tension in the sheet stock, or to fill cuts with conductive adhesive. It is therefore advisable to make the eddy cuts either at intervals or after a single rotor winding has been completed, and certainly not while there is still moist conductive adhesive present that could infiltrate into the cuts and permit current conduction across. The alternative would be to use non-conductive adhesive throughout. This is a good solution if the resulting marginal increase of rotor resistance is of no concern.

According to the present invention, one preferred method for generating eddy current cuts of high electrical resistance as well as radial tensile strength, is indicated in FIG. 19. Herein the cuts are visualized as being made by mechanical cutting which presumably is the fastest and most economical, but other method will be equally acceptable, e.g. etching, or ion beam cutting, or laser cutting. Further the cuts should be made at least a quarter turn from the point of beginning winding were the sheet already well adheres to the layer below so as to inhibit mechanical spreading of the cuts through winding tension. The actual cutting should best be done after the sheet has been coated with non-conductive adhesive and while the adhesive is still fluid or lightly viscous so that the cuts are immediately, as part and parcel of the cutting operation, filled with the non-conducting adhesive.

According to the present invention, with the use of sheets of staggered widths, the rotors are formed and insulating layers 48(n) and separators 49(n) between adjoining slip rings are introduced as illustrated in outline in FIG. 20A and in greater detail in FIG. 20B. The procedure includes the following steps.

(i) Onto the completed layered rotor 2(n−1), made of L₍ₙ₋₁₎ wide metal sheet stock, apply (by any desired method) a thin layer of adhesive 95 except for the width of A that shall form slip ring 34(n−1). Note: Filling of eddy cuts in slip rings will be discussed later-on

(ii) Unless this has been done already, make eddy cuts by means of the still fluid or “tacky” insulating adhesive 95 as in FIG. 19 or by any other suitable method,

(iii) Onto the still tacky adhesive 95 on rotor 2(n−1), place insulating layer 48(n) of width, say, L₍ₙ₋₁₎−2.5Δ, and thereby form an adhesive bond between the surface of rotor 2(n−1) and insulating layer 48(n). Note that insulating layer 48(n) may be in the form of a single layer or consist of a plurality of windings joined by means of insulating adhesive.

(iv) Onto the still tacky adhesive on the 1.5Δ wide strip between slip ring 34(n−1) and insulating layer 48(n), similarly place, and thereby glue on, part 90(n) that is shown separately in FIG. 20C. It is a ring of somewhat flexible insulating material that comprises barrier 49(n) as a kind of flange and is placed to butt-end with the edge of its cylindrical part against the free edge of insulating layer 48(n). For convenience part 90 may be cut through by an axial cut 91 as indicated in FIG. 20C so that it may be placed into position by forcing it over the roller and then be allowed to snap back into its original shape. Alternatively, part 90(n) may be made without such a cut and be slipped over and past slip ring 34(n−1) from the free edge of the roller with its windings.

(iv) Cover insulating layer 48(n) and insulating part 90(n) with a thin layer of adhesive.

(v) Begin winding rotor 2(n) by gluing metal stock of a width L₍ₙ₎=L₍ₙ₋₁₎−Δ onto insulating layer 48(n) and the cylindrical part of 90(n).

(vi) Complete winding rotor 2(n) by continually gluing with a thin layer of (preferably but not necessarily conductive) adhesive.

(vii) Optionally make eddy cuts continually as the material is wound but make sure that the cuts are not mechanically opened by tension nor short-circuited by inadvertently being partly or completely filled with conductive adhesive, as already explained

(viii) Cut off from the remaining sheet stock.

(ix) Apply a thin layer of electrically insulating adhesive.

(x) Unless this has already been done, make eddy cuts as indicated in FIG. 19.

(xi) Begin new cycle by spreading adhesive onto all but width A for slip ring 34(n)

(xii) Glue on insulating layer 48(n+1) and part 90(n+1) in the already described manner and continue until the last rotor is completed.

As indicated by the labels 97(n−1), 97(n) and 97(n+1) at the left of FIG. 20(B) that signify a cured adhesive between adjoining layers, it is anticipated that the adhesive hardens speedily already in the course of the winding operation. However, this is not necessary and the adhesive may be allowed to harden to its fill mechanical strength by storing at ambient temperature or it may be cured by heating in and oven or by any other method of heating.

Refined Methods 1 and 2 and Slip Rings with Reduced Diameter

According to the present invention, a modification of methods 1 and 2 permits making machines with arbitrary, typically reduced slip ring diameters as follows.

Make all rotors of same or similar length with eddy cuts as before but wind onto a roller 89 that is modestly longer than the width of the sheet stock. Then at the completion of winding rotor 2(n), slip over the free edge of the assembly a pre-formed part 98(n) that at its wide end snugly fits over the previous layer 98(n−1) and at its narrow end comprises the slip ring 34(n) and separator 49(n) of reduced diameter that in turn fit snugly over the previous slip ring part of part 98(n−1), as illustrated in FIG. 21. Glue part 98(n) to the underlying part 98(n−1), and conductively glue or otherwise join together the butt-ends of rotor 2(n) and of part 98(n). Next apply insulating layer 48(n+1) and proceed with winding 2(n+1).

Returning to machines not made with current-channeling material, a lengthwise cross section of a completed machine with cylindrical rotors and reduced slip ring diameters by means of part 98 is shown in FIG. 21A, while FIG. 21B clarifies the described joining method between rotor(s) and slip rings. Shown in FIG. 21B is an enlarged view of a the joints between rotors 2(n−1), 2(n) and 2(n+1) on the left and their correlated parts of the slip ring assembly on the right for the case of nested separate rotors. The slip rings had been pre-formed as parts 98(n−1), 98(n) and 98(n−1) but are now simply a continuation of the respect-ive rotors. Herein, label 99 designates electrically conductive bonding, and 100 electrically insulating bonding, optionally including a dielectric breakdown interlayer, (see section Je).

It is necessary that these joints be mechanically strong since they must sustain a part, albeit only a minor part, of the torque between axle 10 and rotors 2(1) to 2(N). It is for this reason that collectively the joints between rotors and preformed slip rings are stepped, i.e. so as to provide a greater bonding area. Again any number of adhesives or cements could be used, some conductive and some insulating, depending on position. For high demands for insulating joints between conductors, e.g. for filing eddy cuts in slip rings, especially the cements used by dentists are an attractive choice.

Method 3—Rotors Made of Curent Channeling Material: The present invention includes a third method for making rotors, namely making them wholly or partly of current channeling material. This method permits simplification in manufacturing rotors, slip rings and bottom strips free of current channeling structures. In this preferred method, the rotor is made of a current channeling material, i.e. a material with structurally inherent current channeling in the desired direction, such as a composite of continuous metal fibers in a non-metallic matrix. With a rotor made of such a material it is not necessary to physically delineate concentric rotors. Rather, instead of fastening individual rims 3(n) with slip rings 34(n), and individual bottom strips 84(n) to individual physically delineated rotors, one may fasten these pair-wise to one and the same concentric cylindrical zone in a monolithic rotor made of a current channeling material. This requires that the current channeling elements are accurately axially aligned and that a majority of them extend through the whole length of the future rotor. Under these conditions, the any one cylindrical zone between correlated slip rings 34(n) and bottom strips 84(n), that electrically connect to opposite ends of the same metal fibers. represents one cylindrical rotor, and the entire cylindrical rotor made of current channeling material represents a set of rotors. In fact, it is not necessary, either, that the fibers be axially aligned but only that they extend between a correlated pair of slip ring and bottom strip. Thus fibers could well spiral as already discussed in connection with FIG. 15D.

The indicated use of materials with structurally inherent current channeling for making rotors is clarified in FIG. 22. It has two principal advantages. 1) It eliminates the need for making eddy cuts or providing any other current channeling structures within the rotor, e.g. by means of eddy current barrier cuts as discussed in conjunction with FIG. 19. 2) The length of rotor may be almost arbitrarily extended. These advantages are somewhat offset by 3) moderately increased internal electrical resistance because of the volume fraction of insulating material in the rotors.

In FIG. 22, rotor 2 is “monolithic”, i.e. has no internal subdivisions. It is made of current channeling material, e.g. metal-fibers or other extended metal shapes such as tubing or strips or small cross sectional dimensions, that are embedded in non-conducting matrix material so as to be mutually insulated. Advantageously, the embedded metal conductors could be made of oxidized aluminum This would have the simultaneous advantages of low weight and the possibility of using very high packing densities since electrical contact, and thus potential short-circuiting between parallel current “turns” would be prevented as much and more by the high resistance aluminum oxide layers as by non-metallic embedment material. Anyway, the great majority of the embedded and mutually electrically insulated current conductors in any shape must be (i) continuous with any one conductor extending from end to end of the rotor, (ii) start and end at the same radial distance from the rotor axis (In FIG. 22 indicated by the central dash-point-dash line).

In the example shown in FIG. 22A, rims 3(1), 3(2) and 3(3) with slip rings 34(1), 34(2) and 34(3) are supplied with slip ring extensions 33(1), 33(2) and 33(3) that are conductively, firmly fastened to the monolithic rotor 2 so as to each make low-resistance electrical contact with the metal fiber ends in one of three concentric cylindrical zones that at the other end of the rotor are conductively connected to bottom strips 84(1), 84(2) and 84(3). Those three concentric zones play the role of three concentric rotors, as indicated in FIGS. 22A and 22B by means of dash-point-dash lines. These are marker lines only, without physical structure, and the machine could have any arbitrary number of slip rings 34 and bot-tom strips.84. Ordinarily, dielectric breakdown bonding should be put used on brush plates as in FIG. 22D, E and G, and between slip rings as in 22B only for very special reasons.

As already indicated, on the opposite end of the concentric cylindrical zones that in essence define concentric rotors, matching cylindrical bottom strips free of current channeling structures, 84(1), 84(2) and 84(3), are mechanically firmly fasted fastened so as to make low-resistance electrical contact with closely the same fibers to which slip rings 34(1), 34(2) and 34(3), respectively, are electrically connected.

The low-resistance firm mechanical connection between the rotor material and the slip rings and bottom strips, respectively, may be accomplished by various means. Indicated in FIG. 22 for this purpose are metal screws 25 that supplement electrically conductive joints 99(1s), 99(2s) and 99(3s) at the butt-ends of the slip rings and 99(1b), 99(2b) and 99(3b) on the slanted joints at the bottom strip side Joints 99(n) may be glued with a thin layer of conductive glue and/or may be soldered. Soldering will be facilitated through a suitable choice of materials in that solder will not wet most non-metal matrix materials. Anyway, one will want to facilitate current flow in axis direction as much as possible but will endeavor to minimize current conduction along the conductive joint and thus between the different “turns”.

Certainly, and as in all preceding designs, neighboring slip rings must be electrically well insulated from each other. In the example of FIG. 22A, separators 49(1s) and 49(2s) on the slip ring side and 49(1b) and 49(2b) on the side of the bottom strips, provide the requisite insulation in this example. These are shown to extend into the rotor 2. The idea here is that thin, say, cylindrical strips of a suitable plastic, may be fitted and glued into, say, the slip ring assembly on one side and into narrow matching grooves cut into the rotor material on the other side, and similarly at the bottom strips. Such strips have the additional advantage that they will increase the shear strength against axial torque

A minor amount of highly unwanted short circuiting between neighboring slip rings along conductive joints is eliminated by using diameters of the fibers or other conductors that are smaller than the thickness of the separators, so as to virtually eliminate the incidence of fibers which straddle the boundaries between neighboring slip rings. However, one will want to use as slender separators as possible since they interrupt current flow between into and out of the rotor. Further, in order to reduce accidental short-circuiting, slip ring extensions are covered with insulating layers 48 on the side facing the next slip ring,

In the same manner as for all bipolar machines, slip rings 34(1), 34(2) and 34(3) must be provided with eddy current barriers in order to electrically insulate the brushes on the a- and b-side from each other, as shown in FIG. 22C. Brushes will typically be in the form of brush strips extending from brush plates, and any of the modifications of geometry introduced in FIG. 8 may be employed, or also simple cylindrical slip rings. Examples in addition to those already given in FIG. 8 are shown in FIGS. 22B 22C and 22D. which also depict different possible methods of joining the slip rings and bottom strips to the rotor. The objective in the different configurations of the slip rings is to provide geometries that simplify the placement of brushes into series of potentially large numbers of narrowly spaced slip rings, and reduction of the danger of accidental electrical contact between brushes on neighboring slip rings.

A considerable simplification relative to the examples shown in FIGS. 22A to D is possible by sliding the brushes on suitably machined strips on the rotor itself, as illustrated in FIGS. 22E to G. The advantages in doing so, i.e. of slip rings in the form of machined bands on the rotor itself, are (1) simplified construction compared to the designs in FIGS. 22A to D that will doubtlessly lower manufacturing costs, (2) elimination of the need for providing eddy current barriers on the slip rings, (3) elimination of potentially weak joints between slip rings and rotor and (4) almost 100% utilization of current conduction cross section on the slip ring side.

The overall construction is shown in FIG. 22E. As seen, and shown in greater detail in FIG. 22G, according to the present invention the slip ring end of the rotor is machined into a profile of cone-shaped sections that serve as slip rings which are separated by narrow zones of opposite slope. The slip ring zones, i.e. 34(1), 34(2) and 34(3) in FIG. 22E, slope away from the working section where the rotor is intersected by the magnetic field between magnet 4 within the rotor and the flux return 80 that surrounds the rotor. The narrow zones separating the slip rings are sloped in the opposite direction. As seen in FIGS. 22E and F, these narrow zones impede mechanical, and thus electrical contact between neighboring brush strips 27(1), 27(20 and 27(3) in FIGS. 22E and 22F. For extra safety, the brushes themselves may be coated with some insulating spray or other surfacing.

The narrow zones between slip rings 34(1), 34(2) and 34(3) form mechanical barriers against touching of brushes on neighboring salip rings, e.g. of 27(2) and 27(3) without entailing any loss of conductive paths as is entailed in separators 49 in accordance with FIGS. 22A to 22D, except as due to inaccuracies in the alignment of the fibers or other conducting members, provided that they are slender, as required in any event. This is demonstrated by the lines in axial direction, that indicate the axially aligned conductive elements in the current channeling material in FIG. 22G. As seen, in the proposed geometry, the current line that just barely misses the “downhill” edge of, say, brush 27(3), arrives at the top edge of brush 27(2), and similarly, the element that just misses the lower edge of brush 27(2), arrives at the upper edge of brush 27(1). The specific profile in FIGS. 22E and 22F are just examples and a wide range of profiles with this same feature is possible by varying the relative widths and lopes of the slip ring as compared to the barrier zones.

Since the slip rings as part of the rotor are already provided with current channeling structures everywhere, they need no further eddy current barriers. It may be further noted that a construction as in FIGS. 22E and 22F, perhaps with increased opposing slope in the narrow barrier zones, will permit quite closely spaced narrow slip rings and thus many turns, limited mainly by the conductor diameter and accuracy of conductor alignment. The slip rings may be operated in the open atmosphere if the conductors as well as the brushes are of a noble metal, otherwise they may be operated in a protective atmosphere. If aluminum is used as conductor material, it must be plated with a noble metal in both cases.

The construction on the bottom strip end is perhaps even simpler than at the slip ring end but here entails some lowering of conductive cross section. The solution shown in FIGS. 22E and 22G in accordance with the present invention, envisaged making very narrow, shallow cuts at the positions of the insulating layers 48 between adjoining bottom strips 84 that preferably but not necessarily will be filled with some insulating material. Conductive joint 99 should be made very thin in order to inhibit current conduction between adjacent bottom strips. Again, the geometry of joining the bottom strips in FIGS. 22E and 22G to the rotor is by way of example. Many variations are possible, including interposing cylindrical between sloping sections in joint 99 or even fluting or saw-toothing for improving bonding strength.

Methods for manufacturing the monolithic rotors will depend on the form of the fiber-composite starting material, i.e. whether sheet, cylinders, rod or bars. For example, if the current channeling material is obtained in the form of sheets or foils, the rotors may be by Methods 1 or 2, but if it is supplied in the form of rods, cylinders or plates, rotors may be formed through conventional machining, e.g. boring or turning in a lathe.

Finally, and in summary, current channeling materials may be used to obtain monolithic rotors that comprise no cylindrical insulating layers (48) to delineate nested rotors of a set. Such delineation is not needed provided the rotor material inhibits all cross currents. Further, if desired the current channeling structures in such a material need not have strictly axial orientation but, if desired, may be spiraled or waved in cylindrical surfaces, i.e. with constant radial distance from the rotation axis. In such a case fastening by means of screws, that in any event are not very desirable, may not be possible. The two most basic requirements for low-loss functioning of a machine with a rotor made of current channeling material are (1) small size and precise alignment of the current channeling structures in the rotor and 2) precise alignment of the bottom strips with the slip rings

Extra-Long Machines

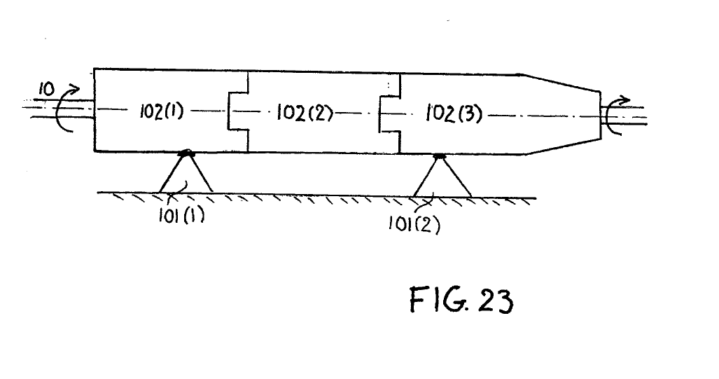

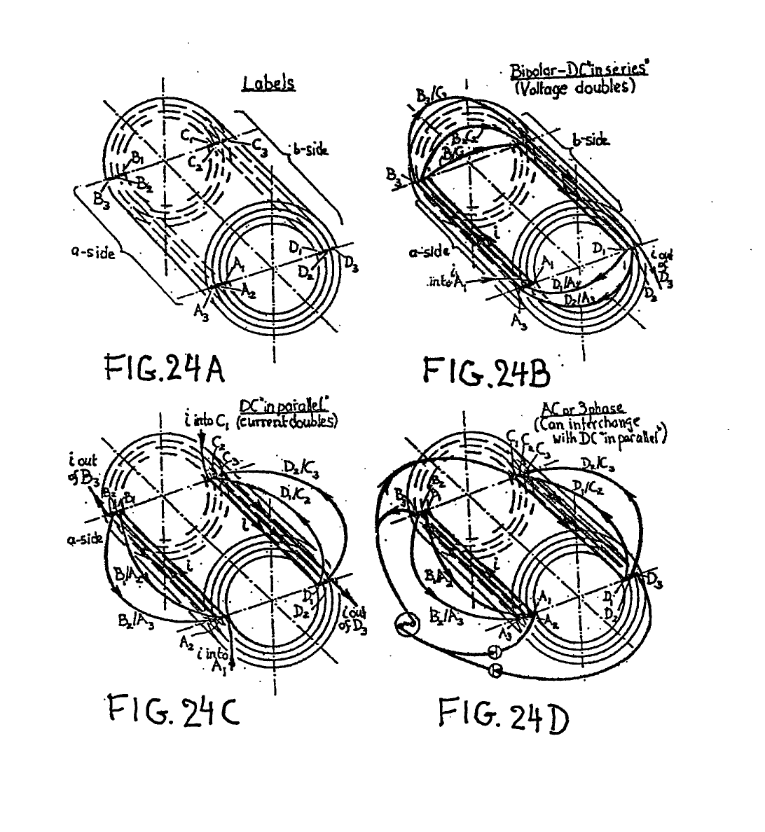

An additional advantage of monolithic rotors made of current channeling material is the potential for producing extra long rotors for machines with correspondingly large voltages (eq.4). Indeed, the perhaps greatest drawback of method 2 is the restricted length of obtainable rotors. In this regard method 1 is superior, because it is amenable to continuous curling and butt-joining of stacks of sheet in much the same method that is used for making commercial tubing, as already pointed out above. Anyway, presumably by the use of method 2, and probably also by the use of method 3 rotor lengths for large machines cannot be achieved directly. These may need to be fitted together in segments of manageable lengths, e.g. of current-channeling material or of wound sheet stock, as indicated in FIG. 23. With rotor wall thicknesses of t_{R}>1 mm this fitting together will presumably not pose any serious problems but care must be taken to avoid inadvertent electrical shorts among different rotors. The described winding and alignment before joining sections must thus be done accurately, and if need be the thickness of the insulating layers 48 must be increased, although this will lead to the corresponding increase of internal resistance and thus decrease of machine efficiency. Anyway, joining of sections as in FIG. 23 will be required only for medium sized to large machines in which, as will be discussed presently, internal ohmic resistances are relatively small and no great loss of efficiency results from raising them moderately.

The preceding discussion regarding joining methods in connection with method 3 apply also here. Actual joining for minimum electrical resistance at the interfaces between conductors may be done by means of conductive adhesives or by soldering. In the former case, it may be possible to pre-fabricate peel-off sheets with the correct pattern of still “tacky” conductive adhesive applied. As to soldering, it is a great aid that solder tends not to wet insulators. Therefore a thin layer of solder may be applied over the whole interface and yet only the metal layer will bond and no conductive paths will be established in-between. Still other means of joining may be feasible, and be developed as the need may arise.

Machine Structure

Most of the various methods and morphologies described for slip rings and bottom strips of machines with rotors made of current channeling material, apply also to layered rotors, i.e. made by methods 1 and 2. This includes machining slip rings directly onto a rotor as in FIGS. 22E and 22F. However, fitting slip rings onto rotors as in FIGS. 20 and 21 is required for obtaining slip rings of reduced diameter. In fact, a particular challenge as well as opportunity is presented by slip rings of reduced diameter that will permit achieving higher machine rotation speeds than would otherwise be limited by permissible brush sliding velocities. Proposed methods according to the present invention have already been discussed in conjunction with FIG. 21.

Several features in FIG. 21A are the same as in FIG. 16 or are closely parallel to these, although elimination of the cup bottom parts of the rotors will greatly simplify machine assembly. In fact a wide variety of specific structures for bipolar machines according to the present invention is possible even beyond those already discussed. The drawings herein are meant to illustrate the invention and to document that it can be translated into practice by comparatively simple methods. They are not meant to be exhaustive.

The major difference in the machine structures in FIGS. 16 and 21 is the treatment of back plate 70(1), away from the slip rings. While 70(1) is stationary and rigidly fastened to back plate 70(2) in FIG. 16, it rotates with the rotors in FIG. 21. Both constructions have their advantages and disadvantages and future decisions for actual machines will be based on their various advantages and disadvantages, e.g. one will generally want to keep the rotating mass as small as possible in order to keep kinetic energy and vibrations low. Therefore in future machine constructions the designers will carefully examine all aspects including the question to what degree back plates may be variously modified or dispensed with in favor of other constructions as already discussed above. However, the machine of FIG. 21 is visualized as being bigger and longer than that in FIG. 16, and to deliver a larger torque. Therefore the rotors in FIG. 21 would need a strong mechanical support and be fastened very stably to the axle. In view of the other requirements on the rotors and the possible need for occasional repairs, i.e. that the machine can be disassembled without destroying it, a rotating back plate seemed to be more suitable.

Also for mechanical stability, on account of large length to diameter aspect ratios and large torques, at the least medium-sized to large bipolar machines will require low-friction bearings at the interfaces between (i) axle and magnet(s), (ii) magnet(s) and innermost rotor, (iii) outermost rotor and flux return. Additionally, since the rotors rotate relative to one or the other motor endplate, the corresponding bearings at the endplates will be useful if not essential. Such bearings are indicated in FIG. 21 with labels 35 whereas on FIG. 16 they would probably also be used, somewhat depending on size, but are shown only between axle 10 and back plate 70(2), respectively part 61 that connects rotors 2(n) to axle 10 and back plate 70(1). Mostly but not necessarily, those bearings will be ball bearings or roller bearings.

Bearings named under numerals (i), (ii) and (iii) above, will operate under sizeable forces normal to their sliding direction on account of the strong magnetic field and hence strong force of attraction between the magnet and the flux return. Even so, since the effective coefficient of friction of, say, ball or roller bearings is in the order of 1%, the resulting friction loss is liable to remain below 1% of machine power.

Other noteworthy features in FIG. 21 are the linear bearings 79 of the brush plates. These will enable smooth motion of the plates under the comparatively small brush forces as brushes wear. Not shown are the cables or bus bars by which the brush plates are electrically connected to the terminals of the current supply or consumer. According to the present invention those linkages are made via resilient multi-contact metal material as already indicated in section Dc.

Further note struts 69. These support the flux return that in large machines can weigh tens of tons and may in practice take the form of much more complex shapes of scaffolding that stabilizes the whole structure. Note, however, that the magnet only firs part of the cavity within the innermost rotor, instead of all of it; i.e. the cut shown in FIG. 21 is in the plane of the magnet, i.e. symmetry plane 82 of FIG. 15B.

Finally, medium sized to large machines will require outside support, e.g. by supports 101(1) and 101(2) in FIG. 23, wherein the machine is visualized as having been assembled from three sect-ions, 102(1), 102(2) and 102(3) as outlined above, but with keyed profile for extra mechanical strength.

D. Machine Operation with DC, AC and/or 3-Phase Current (FIGS. 12 and 23)

(a) Two Machines in Tandem

Motor control is not treated in the present invention but is the subject of a planned independent patent application. It is expected to be relatively simple since homopolar machinery requires no electric circuitry besides the interconnections among brushes in order to obtain multiple current turns. In addition there may be circuitry for recommended monitoring systems, including of brush plates, if any. Therefore, in general terms, (i) the power of homopolar machines, including bipolar machines, may be controlled by controlling the magnitude of the current; (ii) the rotation direction may be reversed by reversing the current direction, and (iii) the machines may be idled by interrupting the current through the rotors, e.g. opening switch 77 in FIG. 12A. Also, in accordance with the present invention and as in the case of basic homopolar motors, (iv) any desired number of bipolar machines may be operated on the same axle. Next, in the case of multiple homopolar machines operating on the same axle, (v) the power delivered to or extracted from the rotating axle may be controlled by the number of powered as compared to idling machines and/or by the power delivered to or extracted from at least one machine.

According to the present invention, the arrangement of two similar homopolar machines operating on the same axle is called “sin tandem”. The following advantages accrue from teaming two homopolar machines in tandem, as in FIG. 12, whether they are used as motors or generators Firstly, if connected in series their voltages add, in essence because the current flows through the rotors of both machines for a doubling of N_{R}. Secondly in the motor mode, as shown in FIG. 12A, by the use of rectifiers in opposite directions in the circuits of the two machines, one will be driven by the positive phase and the other will be driven by the negative phase. Thus two homopolar motors operating in tandem, i.e. on the same axle, can be used at will with either AC or DC or three-phase current, indeed of any frequency, by employing rectifiers with the positive phase feeding one motor and the negative phase the other, as in FIG. 12A. The two modes of operation can be changed by the flick of a switch simply by alternatively turning the AC and DC power sources on and off.

When the option of both direct and alternating current is desired, e.g. in a submarine that might be powered with alternating current when surfaced and battery powered while submerged, the switching from one to the other could be readily automated, e.g. by appropriately connected rectifiers, plus bypassing cables, that can be switched by means of relays. These relays would be connected to coils that surround the power cable to be activated by the induced currents when, and as long as, it carries alternating current.

(b) Individual Bipolar Machines Replacing Two Machines in Tandem

According to the present invention, bipolar motors with cylindrical rotors comprising eddy current barriers that extend from end to end and that are fitted with brushes on both ends, can be operated in the same manner as in tandem machines and thus can be similarly used with DC, AC or 3-phase current. This is clarified in FIG. 24 by the example of a machine with three rotors, each of which has been provided with eddy current barriers along the whole length. For clarity not shown in FIG. 24 is the magnet 4 that is enclosed in the rotors in the manner of bipolar machines, e.g. as illustrated FIGS. 15, 17 and 25. Specifically, in FIG. 24A the entry brush(es) on rotor 1 on the a-side (i.e. in the (a)-zone, facing the North pole of the magnet(s)) is labeled A₁ and is indicated by a dot. Similarly the brushes on rotors 2 and 3 are indicated by dots labeled A₂ and A₃. The terminology brush(es) is used where applicable because in medium sized to large machines, the (a) and (b)zones may be quite extended and each may require several if not many brushes.

Via their respective rotors, brushes A₁, A₂ and A₃ are electrically connected to the brushes on the opposite end, here called B₁, B₂ and B₃ and similarly indicated by black dots. The corresponding brushes on the b-side (i.e. the (b)-zone, facing the South pole of the magnet(s)) are labeled D₁, D₂ and D₃ and C₁, C₂ and C₃. All of these brushes slide on slip rings of their respective rotors (i.e. an Al brush would slide on slip ring 34(1) on rim 3(1) of rotor 2(1) and be labeled 27(1,a), in the same manner already disclosed above for all brushes in the present invention. Similarly, say, brush C₂ would slip on a slip ring at the return end of rotor 2 and be labeled, say, 27(2,b,r).

On account of the eddy current barriers between them, in the arrangement of FIG. 24 and similarly for machines with an arbitrary number of rotors, the brushes on the (a)side are electrically isolated from the brushes on the b-side. Therefore, the two sides can function like two independent conventional homopolar motors in tandem, either connected in parallel or in series when powered by DC, or they may be operated with AC. Most simply, such a machine with eddy current barriers along the whole length of the rotors functions like a bipolar machine if brushes interconnected by cables replace the bottom strip free of eddy current barriers, label 84, as illustrated in FIG. 24B.

Electrically and mechanically the arrangement of FIG. 24B is the equivalent a bipolar machine without rim 84 or also of two homopolar machines in tandem and connected in series. Specifically, in the example of FIG. 24B, the current may enter at brush(es) A₁, from there flow to brush(es) B₁ along rotor 1 guided by the eddy current barriers, and flow on to brush(es) C₁ via a cable that in FIG. 24B is indicated by a curved line labeled B₁/C₁, whence the current flows to brush(as) D₁, axially along rotor 1, again guided by the eddy current barriers. From there cable D₁/A₂ leads the current to brush(es) A₂ to begin a new cycle, i.e. the current flows from brush(es) A₂ parallel to the eddy current barriers along rotor 2 to brush(es) B₂, and via cable B₂/C₂ axially along rotor 2 to brush(es) D₂ and on, in general for an arbitrary number of cycles.

Electrically and mechanically, machines with eddy current barriers extending over the length of the rotors are symmetrical with respect to their mid-plane at right angles to the rotation axis. Therefore, the current need not to enter an A₁ brush, but could enter a B₁ brush, and similarly it could enter the b-side from D₁ instead of from C₁ as in the present example of FIG. 24. In fact, physically the naming of the two rotor ends is arbitrary.

As already indicated, in the present choice of labeling, cables B₁/C₁, and in general Bₙ/Cₙ, replace the bottom strips of the rotors that are free of eddy current barriers 84, whereas cables DₙAₙ₊₁ take the role of bridges 64, and indeed may have the same physical shape. Namely, the curved lines that in FIG. 24 indicate electrical connections between brushes will in fact be carefully configured. Specifically connections Dₙ/Aₙ₊₁ together with the brushes to which they are connected will favorably be made into brush plates 68, and similarly Bₙ/Aₙ. Connections Bₙ/Aₙ₊₁ and Dₙ/Cₙ₋₁ in FIGS. 24C and D (to be discussed presently) are more problematic yet since physically they have to span the length of the rotors and therefore, unlike connections Dₙ/Aₙ₊₁ and Bₙ/Aₙ, cannot be accommodated in linear extensions of the rotors.

Since the complication of the Bₙ and Cₙ brushes in FIG. 24B can be avoided by simply substituting a bottom strip free of eddy current barriers 84, the configuration in FIG. 24B will hardly ever be made in practice. However, configurations 24C and 24D are physically the same and represent the “in series” tandem configuration of FIG. 12, as follows (from here on using abbreviated wording in lieu of the entirely equivalent more elaborate wording that was used for FIG. 24B).

In terms of a motor, driven by an applied voltage, say, between A₁ and B₃, or in general between A₁ and B_{N}, the current enters at A₁ on the a-side and flows through rotor 2(1) to B₁. From there via electrical connection B₁/A₂ the current will flow to A₂ to repeat the cycle through rotor 2(2) and so on until it exits at B₃ in the example of FIG. 24C, or at B_{N} in the general case. Similarly, driven by a voltage applied between C₁ and D₃, and in the general case between C₁ and D_{N}, the current will flow from C₁ successively through rotors 2(1) to 2(3) until it exits at D₃, or will flow successively through rotors 2(1) to 2(N) to D_{N}, in general. Similarly, for the case of a generator, the input of mechanical work through rotation of rotors 2(1) to 2(N) in clockwise direction, an voltage is induced between brushes A₁ and B(N) and will drive the current in the same manner. FIG. 24C indicates that current path by means of bold lines with arrows in the expected current direction.

As discussed, FIG. 24C illustrates the application of DC power to a motor with eddy current barriers extending through the whole length of the indicated cylindrical rotors, respectively shows the resulting currents if used as a generator. FIG. 24D illustrates the same machine as in FIG. 24C but with application of AC power, whether conventional, 3-phase, or any number of phases, and of any arbitrary frequencies, regular or irregular, that may be suitable for a motor (i.e. not radio frequencies). Exactly the same current flow directions will result as in FIG. 24C when one side, in the case of 24D the a-side, is powered by the positive current, gained by means of a rectifier as indicated, and the other side is powered by the negative current component, similarly gained by means of a rectifier. Thus the two arrangements in FIGS. 24C and 24D are exactly the same except for the source of power and therefore may be switched at will between the two types of power, in the same manner as already explained for in tandem motors as in FIG. 12. The disadvantage of the arrangement of FIGS. 24C and D is the need for the connections Bₙ/Aₙ₊₁ and Dₙ/Cₙ₊₁. According to the present invention these can be consolidated into appropriately shaped and mounted bridges 64 between brush plates on the two ends, which bridges extend alongside the flux return 80.

(c) Machine Power Control via Bipolar Machines

According to the present invention, the idea of machines in tandem is extended to any two or more machines, not necessarily alike and not necessarily powered by the same source. Thus the use of rectifiers to power homopolar machines in tandem with DC or alternating or three-phase current outlined above, can be extended to more than two machines by appropriate connections to the individual machines. Further, a single bipolar machine with cylindrical rotors that are supplied with eddy current barriers over the whole length of the rotors can be used in the same independent manner if driven by DC power. This gives additional flexibility that may be very useful in machine operation and control. For example, say, the a-part could provide the machine power used in the ordinary running condition, e.g. cruising for a ship, and the b-part could be used to rapidly increase machine power if needed.

Similarly, in the case of bipolar generators, the a-side may be used in standard power generation, e.g. from wind or tides, while the a-side may kick in for extra demand or supply (e.g. high winds). One advantage herein would be extended brush life, especially useful if the role of the two sides should be periodically switched.

E. Cooling of Homopolar/Bipolar Machines

In many cases, e.g. in electric or hybrid cars, bipolar as other homopolar motors could be cooled in the same manner as the gasoline engines that they replace, i.e. typically by fan-assisted air flow. Such air cooling could be even more effective and might not need to be assisted by fans in especially favorable positions, e.g. if mounted on car axles, for example. For other applications, bipolar and other homopolar motors could be cooled by means of a suitable circulating protective gas (traditionally moist CO₂) as is planned for the 5,000 hp superconducting homopolar motor being built by the General Atomics company. Even more effective would be cooling by direct immersion in water. A preliminary casual test by W. M. Elger and N. Sondergaard at the David Taylor Annapolis Naval Ship Laboratory (circa 1999) suggests that such direct immersion in water is easily possible with homopolar/bipolar machines as these would continue operating smoothly even when entirely flooded with water. The reason for this option is the fact that homopolar machines employ large currents flowing in current paths of as low electrical resistance as possible under relatively low potential differences among neighboring elements. Thus that leak currents through ambient water with very much higher electrical resistivity than in the deliberate current path will be negligible.

Where open water is easily available, such flooding would provide most efficient cooling at low expense if not perhaps even at cost savings such as for podded ship drive motors or for energy extraction from tides or waves by means of homopolar/bipolar generators, especially if the pods and/or other structural supports were provided with perforations for water circulation. Specifically for water cooling by immersion in water, e.g. in a pod attached to a ship, the motor endplates 70(1) and 70(2) of single machines or endplates 70(1) to 70(3) for tandem machines, should be perforated or be made in the form of gratings to permit the freest possible water flow. For similar flooding of machines with circulating cooling water on dry land or in vehicles of any type, including ships, the machines must be provided with enclosures that do not significantly leak. However, a modest amount of leakage though seals could be easily tolerated if either they are minor, or the leaked water is naturally dissipated, and/or if measures are taken to collect the leaked water and to replenish the water volume in the machine as needed.

In general it is expected that homopolar/bipolar machines submerged in a liquid will operate essentially undiminished provided that the liquid will not interfere with the proper functioning of the electric brushes and has an electrical conductivity that is, say, at least four orders of magnitude lower than that of the rotors. Correspondingly, for cooling by direct immersion into water it is not necessary that the water is purified. In fact, even ocean water would presumably be acceptable, and in fact the leak currents would have the benefit of killing marine organisms, presumably on account of the small amount of chlorine that would be generated, so as to inhibit fouling through microscopic organisms and barnacles.

A particular advantage of flooding with water is the anticipated decrease of brush wear rates. Doubtlessly, further tests are needed to confirm the preliminary observation that specifically copper brushes running on copper while submerged in water resist tarnishing and have lowered wear rates. Theory would support this expectation since in successful fiber brush operation actual sliding, on the microscopic level, also in gases, occurs between two monolayers of waters adsorbed on the two sides and not directly between metals or metals and adsorbed water [12]. Wear debris formation occurs where statistically the opposite sides sterically interlock and a wear particle is formed through shearing off. In water, theory forecasts the opportunity of increasing the water layer thickness between the two sides to three or perhaps four, which is expected to result not only in reduced wear as already mentioned but also in greatly lowered friction, albeit at increased film resistivity. On account of reduced friction coefficient, the total losses due to brushes immersed in water and similarly other suitable liquids, may therefore be reduced to or below the total brush loss in air or a protective atmosphere, by significantly increasing the brush pressure, even while wear is also reduced. Patent protection for this possibility is sought in D. Kuhlmann-Wilsdorf, “Management of Contact Spots Between an Electrical Brush and Substrate”. U.S. and International (PCT) Patent Application, filed Oct. 22, 1999, U.S. Serial No. 60/105,319 in connection with hard smooth platings of slip rings in gaseous atmospheres. It is herewith sought for brush systems in homopolar/bipolar machines submerged in suitable liquids.

F. Favored Applications for Bipolar Machines According to the Present Invention

(a) Generators in Conventional Applications

The described bipolar machines will work equally efficiently as motors or DC generators. A great advantage when employed as a conventional generator is their adaptibility to a wide range of power levels, depending on rotation speed. Electrically and acoustically quiet operation and typically high efficiency are further great advantages of bipolar generators. Bipolar generators according to the present invention would be particularly useful for large sizes, including power generation in private, commercial or public power stations including those at Hoover Dam, for example.

(b) Bipolar Generators for Renewable Energy, e.g. Tidal and Wind Power

Still more valuable is the potential of bipolar generators for generating high voltages even at low rotation speeds. Thus bipolar generators can extract power even from quite low-density power sources, as similarly bipolar motors can run on a wide range of mechanical power. Consequently bipolar generators are ideally suited for current generation from wind, tidal and/or other intermittent power sources with wide variations of power density.

(c) Bipolar Motors

Valuable advantages of bipolar motors according to the present invention, especially those with cylindrical rotors, include

generally high efficiency

mechanical as well as electrical silence

high power to weight density

simple construction

expected low cost in mass production

great adaptability to a wide range of rotation speeds, voltages and currents

potential for use with DC as well as AC in a wide range of frequencies including 3-phase or other multi-phase currents

slender shape as an aid in cooling

potential for immersion in water and other suitable fluids for cooling.

Importantly, relative to conventional electro motors with graphitic brushes, on account of the multi-contact metal brushes in bipolar machines, the following advantages may be added to the above list

greater reliability

longer service life

less maintenance

freedom from obnoxious wear debris.

Correspondingly, bipolar motors with cylindrical rotors according to the present invention have the potential of gradually displacing conventional internal combustion engines and electro motors in a wide range of applications, from the very large to the small. To name just a few examples: On the low end of the size scale, conventional battery-driven electro motors, e.g. in hand-held tools, have an efficiency of only about 65% or less, mainly due to the inefficiency of the graphitic brushes in them. Bipolar motors with cylindrical rotors of comparable volume and weight can potentially increase the efficiency to 90% and better. In the range of modestly higher power levels, motors of electric wheel chairs are very disconcerting to many users on account of erratic unpredictable failures caused by malfunctioning or too rapid wear of gra-phitic brushes. Next, in many transport applications, the slender shape of bipolar machines with cylindrical rotors can aid in cooling and offers opportunities for novel placement, e.g. the already mentioned placement of them on car axles. Similarly bipolar motors and/or generators may be distributed to various locations in larger vehicles, e.g. military tanks. At still higher power, bipolar machines would be very suitable for rail transportation, e.g. trams and electric trains.

Perhaps the most suitable application of bipolar motors with cylindrical rotors according to the present invention are ship drives, for a wide range of power levels from, say, 1 hp to 10⁵ hp whether for the fighting Navy, commercial or private shipping. Specifically these motors are eminently adaptable to ship drives when given a streamlined, elongated shape, whether inboard or podded, from life boats to cruise liners and aircraft carriers. In commercial shipping, such ship drives would be suitable from large tankers to small freighters, and for pleasure boating for all sizes from outboard motors to large yachts. Bipolar motors will be similarly useful for water pumps of all sizes and other marine uses.

G. General Equations and Symbols Used for Bipolar Motor with Cylindrical Rotors

(a) Symbols used

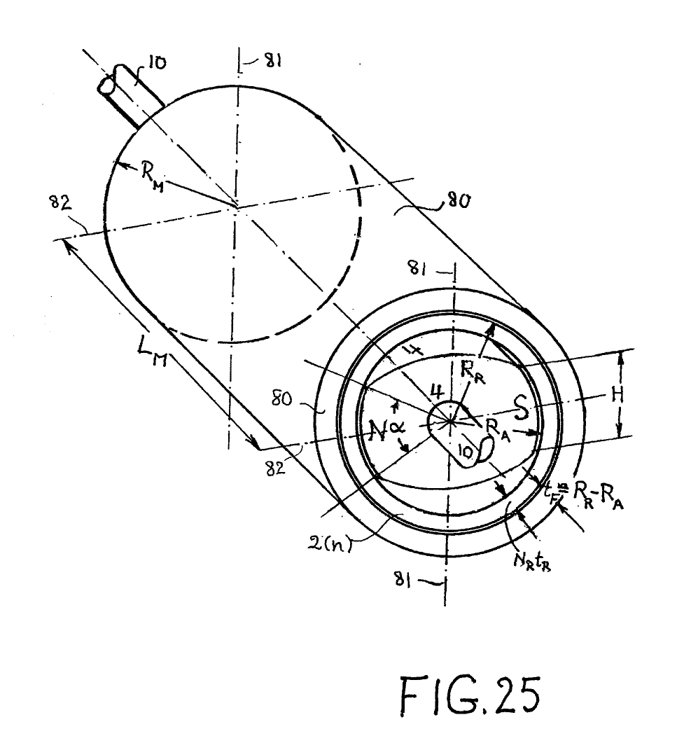

We shall use the same symbols as before and as shown in FIG. 25 plus a number of additional symbols as follows

A_{S}=N_{R} i/j_{S}=active slip ring area (eq.38)

B=magnetic flux density (normal to rotors)

d=mechanical density (assumed to be d=7.5×10³[kg/m³], as average between Cu with d=8×10³[kg/m³] and iron/steel with d=7.1×10³[kg/m³])

d_{W}=thickness of brush plate

D_{M}=outer machine diameter ≅2R_{F}=3R_{R}

f_{B}=slip ring surface covered by brush foot print (safe limit for moisture access f=50%)

F=approximate machine volume in units of R_{R}³ (eq. 45b)

H=Height of magnet ≅R_{R}

i=machine current

j_{B}=2×10⁶ Amp/m² (estimated upper safe limit of current density in brushes in humid gases)

j_{S}=f_{B}j_{B}=10⁶ Amp/m² (estimated upper safe current density on slip rings in humid gases)

L=V_{Ω}/V_{M}=loss through internal machine resistance

L_{b}=width of the bottom strip (code 84)

δL_{B}=permissible brush wear length

L_{BS}=length of brush foot print in sliding direction

L_{E}=thickness of endplate (code 70, assumed to be ⅔ R_{R})

Lⱼ=R_{R}=active circumferential slip ring length (eq. 37)

L_{M}=length of machine

L_{R}=length of cylindrical rotor equal to the length of the magnet

Lⱼ=R_{R}=active slip ring length in tangential direction (eq.38).

L_{S}=N_{R}Δ=active slip ring length in tangential direction (eq. 41)

m_{corr}=machine mass if the flux density in the flux return is 1.8 tesla (eq.45c)

m_{F}=mass of flux return

m_{M}=machine mass (if B=1 tesla is assumed throughout)

M_{M}=W_{M}/ω=machine torque

N_{R}=number of rotors

N_{R}t_{R}=cumulative thickness of the set of cylindrical rotors (assumed to be R_{R}/3, eq.30)

R_{A}=inner rotor radius

R_{F}=outer radius of flux retun=R_{R}+H/2=1.5R_{R}

R_{P}=radius of axle

R_{R}=outer rotor radius

₁ [symbol] ᵢₙₜ=internal resistance per rotor

[symbol] ᵢₙₜ=N_{R 1} [symbol] ᵢₙₜ=internal ohmic machine resistance excluding brushes and brush holders

[symbol] _{Bridge}=ohmic resistance of “bridge” between brushes on adjoining rotors

t₆₁=length of the mechanical mechanism 61 fastening the rotors or endplate to the axle

t_{F}=wall thickness of flux return (assumed to be ≅H/2 in bipolar machines)

t_{R}=wall thickness of individual rotor (assumed to be R_{R}/3N_{R}, eq.30)

T_{B}=estimated average brush wear life or life expectance of brush plates

v_{R}=average rotor surface speed

V_{M}=N_{R 1}V_{R}=machine voltage

₁V_{R}=induced voltage per rotor

[symbol] _{B}=voltage loss per brush

[symbol] _{Ω}=potential difference on account of internal machine resistance

W_{M}=iV_{R}=iN_{R} V_{R}=machine power

α=angle subtended by magnet on the cylindrical rotors in bipolar machines (≅60° assumed)

β=R_{R}/L_{b}

δm_{M}=machine wieght reduction for B=1.8 tesla in flux return (eq.45d)

δ_{W}=d_{W}/R_{R}=relative thickness of brush plate

γₑₗ=elastic shear strain in machine on account of torque M

δL_{B}=permissible brush wear length (in numerical examples assumed to be 2 cm)

Δ=width of slip ring

Δₘᵢₙ≅0.25 cm=minimum slip ring width

λ=L_{R}/R_{R}

ρ=electrical resistivity of rotor material (1.65×10⁻⁸ Ωm for copper).

(b) Relations Among Parameters

In the following, numerical estimates are made regarding the major characteristics of bipolar machines of different sizes. These are based on simplifications, e.g. loss of efficiency on account of intermediate insulating layers or embedment material has been neglected as also the fact that in a set of rotors the rotor diameters are graded. Also, the characteristics of the magnets and flux return are not well known. Correspondingly, the values presented below are guideline figures without quantitative accuracy.

To begin with, the best present estimate of the optimum gap width between the magnetic poles and the flux return, within which the rotors of total thickness N_{R}t_{R} slide, is about H=R_{R}/3. Too wide gaps will have low values of B on account of depolarization, and too narrow gaps do not permit an adequate number and wall thickness of rotors. Further, at same flux density in the magnet and flux return, the wall thickness of the flux return must be t_{F}=H/2 and a suitable value for the angle a that the magnet subtends on cylindrical rotors is α≅60°, so that

H=2R_{R} sin(α/2)≅R_{R}=2t_{F} (28)

Consequently the motor diameter is, approximately and neglecting the narrow gaps between the rotor and the magnet on one side and the flux return on the other,

D_{M}=2R_{F}=2(R_{R}+t_{F})=2R_{R}+H=3R_{R} (29)

Next, the gap width of R_{R}/3 must accommodate the cumulative thickness of N_{R} rotor cylinder walls of thickness t_{R} each, i.e.

t_{R}≅R_{R}/(3N_{R}) (30)

With α=60°, the two brush plates, if any, do not require flexible joints, as discussed in connection with FIG. 11. This is a considerable advantage of bipolar machines because (i) only one linear bearing or other device would be needed on each side to keep the brushes in their intended relative position and orientation and to advance them in course of wear, (ii) because brush loading could be simply effected by two springs between the (a)- and (b)-side brush holders, such as 37 in FIG. 12. According to the present invention, and assuming the expected development of mass-produced brush plates and their attached brush strips, the large number of required brushes that used to be an important drawback of homopolar motors, will therefore be of no concern in regard to bipolar motors with cylindrical or cup-shaped rotors. Since also the methods of rotor winding and slip ring production discussed in preceding sections are amenable to mass production techniques, the choice of NR in bipolar machines is unlikely to greatly affect the cost and performance of bipolar machines with cup-shaped or cylindrical rotors. The voltage can accordingly be adapted to other needs, with no particular concern about large NR values, provided only that both slip ring widths and rotor wall thickness remain above some practical minimum, at present believed to be about Δ≅0.25 cm and t_{R}≅0.2 mm And also L_{b}/R_{R}=½ is at this point assumed to be a good choice. Further, two brushes and brush holders each contribute about 0.4V per rotor, provided the bridges are made with an adequately large cross sectional diameter.

(c) Internal Ohmic Machine Resistance, Loss and Machine Efficiency

With the above relationships, i.e. H=R_{R} and t_{R}=R_{R}/(3N_{R}), disregarding for the moment brushes and brush holders, one finds for the internal resistance per rotor, naming R_{R}/L_{b}=β and L_{R}/R_{R}=λ,

₁ [symbol] ᵢₙₜ=ρ[2L_{R}/Ht_{R}+πR_{R}/2L_{b}t_{R}]=(ρN_{R}/R_{R})[6λ+3πβ/2]= [symbol] ᵢₙₜ/N_{R} (31)

Next, the motor loss is

[symbol]

= [symbol] _{Ω}/V_{M}=i² [symbol] ᵢₙₜ/W_{M}=W_{M} [symbol] ᵢₙₜ/V_{M}² (32)

i.e. with V_{M}=N_{R 1}V_{R}

W_{M}=V_{M}² [symbol] / [symbol] ᵢₙₜ=V_{R}²R_{R} [symbol] /[ρ(6λ+3πβ/2)] (33)

Further, by the use of eq. 4, i.e. ₁V_{R}=2v_{R}BL_{R}=2v_{R}BλR_{R},

W_{M}=4v_{R}²R_{R}³B²λ² [symbol] /[ρ(6λ+3πβ/2)] (34a)

or if λ>>β,

W_{M}≅2/3v_{R}²R_{R}³B²λ [symbol] /ρ (34b)

Hence in a first approximation the machine power is independent of N_{R}, but proportional to [symbol] , the cube of the rotor radius, R_{R}, and the square of both velocity v_{R} and magnetic flux B.

Comparison with the corresponding eqs.23 to 27 for bipolar motors with cup-shaped rotors will reveal the considerable advantage of the arrangement with cylindrical rotors over circular rotors also in terms of achievable power density. Correspondingly it is expected that future bipolar machines will by and large be of the cylinder design, both on account of its higher power density, lower demands on cooling and greater ease of construction. Even so, when space requirements greatly favor a squat design, bipolar machines with circular rotors are an option, and in any event they are superior to previous homopolar motors.

Eq.34 is an overestimate since, firstly, 2 [symbol] _{B}=0.4V must be subtracted from the machine voltage on account of brushes and brush holders. However, this is a minor effect since with typically B≅1 tesla or larger, and even very modest values of L_{R}, e.g. 1 m, and v_{R}, e.g. 5 m/sec, yield ₁V_{R}=10V. Secondly, the resistance of the bridges has been neglected. If they are part of brush plates of thickness d_{W}, their resistance per rotor is

[symbol]

_{Bridge}≅ρπR_{R}/t_{R}d_{W}≅10ρN_{R}/d_{W} (35)

From comparison with eq. 1 it follows that, unlike the case of the bipolar machine with cup-shaped rotors, the brush and brush holder resistance is typically minor, provided that the brush plate thickness, d_{W}, is made, say, of thickness R_{R}/4 or larger. Anyway, the estimated machine efficiency is, including an estimated 2% loss through drag of ambient medium and bearings,

E_{M}≅100%(1−2%− [symbol] −0.4[V]/₁V_{R}) (36)

(d) Considerations Regarding Brushes, Brush Holders and Slip Rings

As already discussed above, the area coverage of brush foot print on slip rings, f_{B}, should not exceed 50% and a safe estimated upper limit for the current density in the brushes is j_{B}=2×10⁶ [A/m²], so that

j_{S}=f_{B}j_{B}=10⁶[A/m²] (37)

is a good value for the average current density on slip rings in both zones Moreover, in bipolar machines with cylindrical rotors, brushes can be usefully applied only in zones (a) and (b), i.e. over circumferential lengths of

Lⱼ≅H=R_{R} (38)

on each side. For a current i therefore, a slip ring area of

A_{S}=N_{R}i/j_{S} (39)

is required on each side, (a) and (b). For a given slip ring area, this results in the individual slip ring width

Δ=A_{S}/N_{R}Lⱼ=(j/j_{S}Lⱼ) (40)

and a total axial length of slip rings and hence brush plate length (neglecting separators 49 or slip ring extensions 33)

L_{S}=N_{R}Δ=N_{R}i/j_{S}Lⱼ (41)

The expected brush wear life, T_{B}, is proportional to the permissible wear length of the brushes, δL_{B} and inversely proportional to the sliding velocity (mostly assumed to be v_{R}) and the dimensionless wear rate that is conservatively estimated at 5×10⁻¹¹, i.e.

T_{B}=δL_{B}/(v_{R}5×10⁻¹¹ [seconds]) (42)

Further in regard to brushes and slip ring dimensions, the spacing of the eddy current barriers should preferably be mildly smaller than the length of the brush sections in the brush holder strips, L_{BS}. so that the current is not significantly interrupted as brushes slide from one eddy current barrier interval to the next because this could give rise to arcing. Further, since eddy current barriers add to the machine cost and cause some extra brush wear, they should be as few as otherwise possible but there should be several eddy current barriers per active slip ring length to minimize current ripple. Also, as already indicated, in a humid atmosphere, the continuous footprint of any brush in sliding direction should not exceed L_{BS}=5 cm=2″ in order not to inhibit moisture access. However, this number is subject to adjustment as experience with fiber brushes increases, and it is expected to be unlimited in liquid water.

At any rate, pending gradually accumulating information, eddy current barrier spacings between 3 and 4 cm would seem to be a good choice for machines with R_{R}>20 cm, e.g., and preferably the spacing should be mildly irregular, again to reduce current ripple. But in any event, the eddy current barriers are preferably spaced closely enough to suppress the eddy/Hall effect loss to below, say, ½%. With brushes in the form of L_{BS}=5 cm long brush strip segments, the number of brushes on N_{R} slip rings (with two brushes per slip ring, sides (a) and (b)) each of length L_{S}=R_{R} then is

N_{B}=2N_{R}(R_{R}/L_{BS}) (43)

(e) Machine Weight or Mass

Naming the thickness of the motor endplates L_{E}, the machine length is

L_{M}=L_{R}+2L_{E}+L_{b}+L_{S}≅(λ+4/3+1/β)R_{R}+L_{S} (44)

where L_{E} is assumed to be ⅔ R_{E} which is an intuitively plausible number that is used pending engineering determinations of the size and construction of the endplates. Thus the machine mass is approximately

m_{M}≅πd{(L_{R}+2L_{E}+L_{b})[(D_{M}/2)²−R_{P}²)+L_{S}(R_{R}²−R_{P}²)]=FπdR_{R}³ (45a)

with

F=[(λ+4/3+1/β)[(1.5)²−(R_{P}/R_{R})²]+(L_{S}/R_{R})[(1−(R_{P}/R_{R})²] (45b)

However, this is an overestimate if the magnetic flux density in the flux return should not be B=1 tesla but, say, 1.8 tesla as seems to be achievable, while in the gap B might remain at 1 tesla. In that case the flux return wall thickness and hence its weight, i.e.

m_{F}=dπL_{R}(1.5²R_{R}²−R_{R}²)=3.93dλR_{R}³ (45c)

is reduced to by the factor 1.8 to

m_{Fcorr}=m_{F}/1.8 (45d)

for a machine weight savings of

δm_{M}=0.44m_{F} (45e)

A much larger weight savings can be achieved by an increase of B to, say, 1.8 tesla also in the gap, i.e. its value in the rotors since thereby the induced voltage would at same magnet and rotor length be similarly increased by the factor 1.8 in accordance with eq.4. Correspondingly, for same machine power the active rotor and magnet length could be reduced by the factor of 1.8 and, except for slip rings, brushes, end-plates and mechanical structure the machine mass would be reduced by factor 1.8, i.e. down to minimally

mₘᵢₙ=m_{F}/1.8 (45f)

Alternatively, the rotor radius could be reduced or a combination of these options, and similarly for any other deviation of B from the generally assumed value of 1 tesla.

Finally, since the magnetization and geometry of magnet and flux return shall remain permanently unchanged, according to the present invention the magnets and/or flux return may be made of a permanent magnetic material of perhaps smaller density than iron and iron alloys. This could result in a substantial weight reduction of the machines. For the time being, the average density, d, of the machine's materials, is tentatively assumed to be 7.5 [tonnes/m³] as the average between the densities of steel and copper. At same dimensions, if the rotors and brush plates were made of aluminum the loss would be modestly higher and the weight lower.

Note also that with the assumed relatively large radius of the axle, i.e. R_{P}=2/3 R_{R}, the magnets (that constitute the magnetic field source and that in all but small machines should preferably be composed of several or many magnets contained in tubes or trays as in FIG. 17C) will have to bow out about the axle more strongly than shown in FIG. 25.

(f) Mechanical Stresses and Mechanical Stability of Machines

An important consideration are the shear stress, a, in the rotors and in the connection (61) between the rotors and the axle that arises from the torque, M_{M}, generated by the motor. Specifically, considering a single rotor, at the junction between the single rotor and the axle of radius R_{P}

₁M_{M}=τ2πR_{P}R_{R}t_{R}=τ2πR_{P}R_{R}²/3N_{R} (46)

But

₁M_{M}=(W_{M}/N_{R})ω=(W_{M}R_{R}/N_{R}v_{R}) (47)

so that

τ=₁M_{M}3N_{R}/2πR_{P}R_{R}²=3W_{M}/(2πR_{P}R_{R}v_{R}) (48a)

We find the resultant elastic shear strain, γₑₗ, by comparing τ with the shear modulus, G, which for copper is G=8×10¹⁰ N/m² and for aluminum G=2.7×10¹⁰ N/m². Thus. with R_{P}=2/3 R_{R} as probably a fairly typical value,

γₑₗ=3W_{M}/(2πR_{P}R_{R}v_{G})≅0.71W_{M}/(R_{R}²v_{R}G) (48b)

Adapting the above calculation to the shear stress exerted on the fastening 61 between back plate and axle, as in the design of FIG. 21A, one finds the stress in the joint between the axle and the mechanical fastening device 61, of width t₆₁, as

τ_{E}=W_{M}/2πR_{P}t₆₁v_{R}=γ₆₁G (49)

A safe value of γ₆₁=2×10⁻⁴, by the use of a hard solder joint with shear modulus, say, G₄₁=10¹⁰ N/m², would thus require

t₆₁≧W_{M}/(2πR_{P}v_{R}γ_{⊕}G) (50a)

i.e.

t₆₁≧3.7×10⁷[watt]/(2π×0.4×6.3×2×10⁻⁴×10¹⁰[N/sec[=1.2[m]=2R_{R} (50b)

The above relationships will be considered for various motors, beginning with large podded ship drives, generally assuming B=1 tesla in the gap.

H. Numerical Examples

(a) Large Motors Suitable for Ship Drives

(1A) Large Ship Drive, 50,000 hp, 100 RPM, 9000V, L_{M}=9 m, E=96.6%, 0.4 mAxle

Selected Parameters

W_{M}=50,000 hp=3.7×10⁷ watt

V_{M}=9000 Volt

i=4100 Ampere

R_{P}=2/3R_{R}=0.4 m (axle bore radius through magnet for propeller shaft)

R_{R}=0.6 m=2 ft

H=R_{R}=0.6 m (i.e. α=60°)

D_{M}=3R_{R}=1.8 m=6 ft (eq.29)

L_{b}=R_{R}/2=0.3 m=1 ft (i.e. D=2) (width of bottom strip free of eddy current barriers)

L_{E}=2/3 R_{R}=0.4 m (width of endplates)

Lⱼ=R_{R}=0.6 m=2 ft=active slip ring length on each side

L_{R}=12R_{R}=7.2 m=24 ft (i.e. λ=12)

ω=100 RPM=1.67 rev/sec=10.5 [rad/sec]

v_{R}=ωR_{R}=6.3 m/sec=21 ft/sec

[symbol] =1% (selected for computing W_{M} in accordance with eq.33)

N_{R}=100

B=1 tesla

ρ=1.65×10⁻⁸ Ωm (for copper)

L_{BS}=0.05 m=2″ (length of single brush segment in sliding direction)

δL_{B}=2 cm (permissible brush wear length)

G=8×10¹⁰ N/m² (for copper)

Derived Parameters

t_{R}=R_{R}/3N_{R}=0.2 cm=0.079″ (rotor wall thickness) (eq.30)

₁V_{R}=2v_{R}BL_{R}=90 [V] (eq.4 with n=2)

V_{M}=N_{R 1}V_{R}=9000 [V]

[symbol] ᵢₙₜ=N_{R 1} [symbol] ᵢₙₜ=(ρN_{R}²/R_{R}) [6λ+3πβ/2]≈0.023 Ω(eq.31)

W_{M}≅2/3 v_{R}²R_{R}³B²λ [symbol] /ρ=3.7×10⁷ [watt]≅50.000 hp (eq.33)

E_{M}≅100%(1−2%− [symbol] −0.4[V]/₁V_{R})=96.6% (eq.36)

M_{M}=W_{M}/ω=W_{M}R_{R}/v_{R}=3.5×10⁶[Nm]=2.6×10⁶[lb ft]

d_{W}=R_{R}/4=0.15 m (see comment to eq.35)

Lⱼ=R_{R}=0.6 m=2 ft (active slip ring length each in zone (a) and in zone (b)) (eq.38)

A_{S}=N_{R} i/10⁶[A/m²]=0.41 m²=4.6 ft² (active slip ring area) (eq.39)

Δ=A_{S}/N_{R}Lⱼ=0.68 cm=0.27″ (width of individual slip ring) (eq.40)

L_{S}=N_{R}Δ=0.68[m]=2.3 ft (total axial extent of slip ring surfaces) (eq.41)

L_{M}=L_{R}+2L_{E}+L_{b}+L_{S}=(7.2+0.8+0.3+0.68)[m]=9 m=30 ft (eq.44)

T_{B}=δL_{B}/(v_{R}×5×10⁻¹¹)=6.4×10⁷ seconds=2 years (eq. 42)

N_{B}=2N_{R}(R_{R}/L_{BS})=2400 (eq.43)

F=[(λ+4/3+1/β))[(1.5)²−(R_{P}/R_{R})²]+(L_{S}/R_{R})[(1−(R_{P}/R_{R})]=25.6 (eq.45b)

m_{M}=FπdR_{R}³=130 tonnes (eq. 45a)

m_{F}=3.93dλR_{R}³=76 tonnes (eq45c)

δm_{M}=0.44 m_{F}=33.5 tonnes (eq. 45e)

m_{corr}=m_{M}−δm_{M}=97 tonnes

mₘᵢₙ=m_{M}/1.8=72 tonnes (eq. 45f)

γₑₗ=τ/G=3 W_{M}/(2πR_{P}R_{R}v_{R}G)=3×3.7×10⁷/[2π×0.4×0.6×6.3×8×10¹⁰]=0.015% (eq.48)

Comments

The large number of brushes, N_{B}=2400, would be of a great concern if brushes were to be fitted into individual holders and placed on slip rings individually. In fact with individual holders the required Δ=A_{S}/N_{R}L_{S}=0.68 cm slip ring width would probably be unattainable. Consequently, with the use of individual brush holders, NR would have to be considerably decreased. However, according to the present invention, all brushes on the (a)-side, and similarly all brushes on the (beside, will be mounted on, and be applied through, just one or perhaps up to three brush plates on each side, which as far as the user is concerned are installed and, when worn out, replaced in a single operation. In the method of the present invention, therefore, the number of brushes on the brush plate is of only academic interest. The wall thickness, d_{W}, of the brush plate of d_{W}=R_{R}/4=15 cm is adjusted to present only a fraction of the internal resistance.

Of concern is the value of γₑₗ=0.014% as it is just about the fatigue strength limit of pure copper, whereas for aluminum with G=2.7×10¹⁰ N/m², it would be γ=0.04% and pro-bably no longer safe. Hence the above particular example of a bipolar machine with cylindrical rotors according to the present invention is feasible also mechanically, but not by a large margin. Correspondingly, and the rotors should preferably be made of some low-concentra-tion Cu alloy, such as used for commutators, in order to boost their fatigue strength.

With the present values, the shear strain in the endplates where they join the axle would be γₑₗ=0.0073 and thus safe. In this much the endplates could be substantially perforated as was envisaged for the case of direct cooling in water. A convnetional connection may be made to attach the endplates and the rotors to the axle

(1B) As 1A but Shortened to L_{M}=5.6 m

(Values Changed from the Previous Machine in Bold Italics)

Selected Parameters

W_{M}=50,000 hp=3.7×10⁷ watt

V_{M}=9000 Volt

i=4100 Ampere

R_{P}=2/3 R_{R}=0.4 m (radius of axle/bore through magnet for propeller shaft)

R_{R}=0.6 m=2 ft

H=R_{R}=0.6 m=6 ft (α=60°)

D_{M}=3R_{R}=1.8 m=6 ft (eq.29)

L_{b}=R_{R}/2=0.3 m=1 ft (i.e. β=2)(width of bottom strip free of eddy current barriers)

L_{E}=2/3 R_{R}=0.4 m=1.3 ft (width of endplates)

Lⱼ=R_{R}=0.6 m=2 ft active slip ring length on each side

L_{R}=4R_{R}=2.4 m=8 ft (i.e. λ=4)

ω=100 RPM=1.67 rev/sec

v_{R}=ωR_{R}=6.3 m/sec=21 ft/sec

[symbol] [symbol] to be computed from input values)

N_{R}=300

B=1 tesla

ρ=1.65×10⁻⁸ m (for copper)

L_{BS}=0.05 m=2″ (length of single brush segment in sliding direction)

δL_{B}=2 cm (permissible brush wear length)

G=8×10¹⁰ N/m² (for copper)

Derived Parameters

t_{R}=R_{R}/3N_{R}=0.7 mm=28 thou (including insulating barrier 48) (eq.30)

₁V_{R}=2v_{R}BL_{R}=30 [V] (eq. 4 with n=2)

V_{M}=N_{R1}V_{R}=9000 [V]

[symbol] ᵢₙₜ=N_{R1} [symbol] ᵢₙₜ=(ρN_{R}²/R_{R})[6λ+3πβ/2]≈0.083 Ω(eq.31)

[symbol] =i² [symbol] ᵢₙₜ/W_{M}=3.8% (eq.32)

E_{M}≅100%(1−2%− [symbol] −0.4[V]₁V_{R})=92.9% (eq.36)

M_{M}=W_{M}/ω=W_{M}R_{R}/v_{R}=3.5×10⁶[Nm]=2.6×10⁶[lb ft]

Lⱼ=R_{R}=0.6 m=2 ft (active slip ring length each in zone (a) and in zone (b)) (eq.38)

d_{W}=R_{R}/4=0.15 m (see comment to eq.35)

A_{S}=N_{R} i/10⁶[A/m²]=1.23 m²=14 ft² (active slip ring area) (eq.39)

Δ=A_{S}/N_{R}Lⱼ=0.68 cm=0.27″ (width of individual slip ring) (eq.40)

L_{S}=N_{R}Δ=2.05[m]=6.9 ft² (total axial extent of slip ring surfaces) (eq.41)

L_{M}=L_{R}+2L_{E}+L_{b}+L_{S}=(2.4+0.8+0.3+2.05)[m]=5.6 m=18 ft (eq.44)

T_{B}=δL_{B}/(v_{R}×5×10⁻¹¹)=6.4×10⁷ seconds=2 years (eq. 42)

N_{B}=2N_{R} (R_{R}/L_{B})=7200 (eq. 43)

F=[(λ+4/3+1/β))1.5)²−(R_{P}/R_{R})²]+(L_{S}/R_{R})[(1−(R_{P}/R_{R})²]=12.4 (eq.45b)

m_{M}=FπdR_{R}³=63 tonnes (eq. 45a)

m_{F}=3.93dλR_{R}³=25.5 tonnes (eq45c)

δm_{M}=0.44 m_{F}=11.2 tonnes (45e)

m_{corr}=m_{M}δm_{M}=52 tonnes

mₘᵢₙ=m_{M}/1.8=m_{M}/1.8=35 tonnes (eq.45f)

γₑₗ=τ/G=3W_{M}/(2πR_{P}R_{R}v_{R}G)=3×3.7×10⁷/[2π0.4×0.6×6.3×8×10¹⁰]=0.015% (eq.48)

Comments

The outstanding virtue of both of the above examples is their high voltage and thus relatively low current, so that they do not strain the electric supply system beyond the mere fact that they draw a large power. At same rotation speed, diameter, voltage, current and power output, the present modified machine has a considerably reduced length, i.e. L_{M}=18 ft as compared to 30 ft, and correspondingly reduced mass, i.e. m_{M}=63 tonnes and m_{corr}=35 tonnes as compared to 130 tonnes and 52 tonnes, respectively. This weight reduction is bought at the expense of decreased machine efficiency (from 96.6% to 92.9%) and increased number of brushes (from 2400 to 7200).

Altogether this would seem to be a very competitive design. Whether the large number of brushes poses a problem depends on the success of brush plates. At present this is believed to be a non-issue and no difficulties are foreseen. Namely, the feature of consolidating a large number of small units into one is nowadays familiar from computer chips, in particular. Based on these one may expect success subject, however, to effective production techniques and scrupulous quality control because the brush strips are in series and the failure of any one strip (i.e. failure not of a single brush segment but of a majority of all six or seven of such segments on the same strip) would cause a machine breakdown. In this connection one may want to remember, though, that unlike graphite-based brushes unanticipated sudden failures are virtually unknown for fiber brushes.

Following the present series of numerical examples, plans for mass production of brush plates in accordance with the present invention will be presented.

(1C) As 1A but with Voltage Lowered to 900V

(Again, Bold Italic Type Indicates Changes from the Previous Examples).

Selected Parameters

W_{M}=50,000 hp=3.7×10⁷ watt

V_{M}=900 Volt

i=41,000 Ampere

R_{P}=0.4 m (radius of axle/bore through magnet to accommodate the propeller shaft)

R_{R}=0.6 m=2 ft

H=R_{R}=0.6 m=6 ft (α=60°)

D_{M}=3R_{R}=1.8 m=6 ft (eq.29)

L_{b}=R_{R}/2=0.3 m=1 ft (i.e. β=2)(width of bottom strip free of eddy current barriers)

L_{E}=2/3 R_{R}=0.4 m=1.3 ft (width of endplates)

Lⱼ=R_{R}=0.6 m=2 ft active slip ring length on each side

L_{R}=12R_{R}=7.2 m=24 ft (i.e. λ=12)

ω=100 RPM=1.67 rev/sec

v_{R}=ωR_{R}=6.3 m/sec=21 ft/sec

N_{R}=10

B=1 tesla

ρ=1.65×10^{′8} Ωm (for copper)

L_{BS}=0.05 m=2″ (length of single brush segment in sliding direction)

δL_{B}=2 cm (permissible brush wear length)

G=8×10¹⁰ N/m² (for copper)

Derived Parameters

t_{R}=R_{R}/3N_{R}=2 cm=0.8″

₁V_{R}=2v_{R}BL_{R}=90 [V] (eq.4 with n=2)

V_{M}=N_{R1}V_{R}=900 [V]

[symbol] ᵢₙₜ=N_{R1} [symbol] ᵢₙₜ=(ρN_{R}²/R_{R})[6λ+3πβ/2]≈2.3×10⁻⁴Ω(eq.31)

[symbol] =i² [symbol] ᵢₙₜ/W_{M}=1% (eq.32) (same as for first example)

E_{M}≅100%(1−2%− [symbol] −0.4[V/₁V_{R})=96.6% (eq.36) (same as for 1A)

M_{M}=W_{M}/ω=W_{M}R_{R}/v_{R}=3.5×10⁶[Nm]=2.6×10⁶[lb ft]

Lⱼ=R_{R}=0.6 m=2 ft (active slip ring length each in zone (a) and in zone (b)) (eq.38)

d_{W}=R_{R}/4=0.15 m (see comment to eq.35)

A_{S}=N_{R} i/10⁶{A/m²]=0.41 m²=4.6 ft² (eq.39)) (same as for 1A)

Δ=A_{S}/N_{R}Lⱼ=6.8 cm=2.7″ (slip ring width) (eq. 40)

L_{S}=N_{R}Δ=0.68[m]=6.9 ft² (total slip ring width)(eq.41) (same as for 1A)

L_{M}=L_{R}+2L_{E}+L_{b}+L_{S}=(7.2+0.8+0.3+0.64)[m]=9 m=30 ft (same as 1A)

T_{B}=δL_{B}/(v_{R}×5×10⁻¹¹)=6.4×10⁷ seconds=2 years (eq. 42)

N_{B}=2N_{R} (R_{R}/L_{BS})=240 (eq.43)

F=[(λ+4/3+1/β))[(1.5)²−(R_{P}/R_{R})²]+(L_{S}/R_{R})[(1−(R_{P}/R_{R})²]=25.6 (Same)

m_{M}=3=130 tonnes (eq. 45a) (Same as for 1A)

m_{F}=3.93dλR_{R}³=76 tonnes (eq45c) (Same as for 1A)

δm_{M}=0.44 m_{F}=33.5 tonnes (45e) (Same as for 1A)

m_{corr}=m_{M}δm_{M}=97 tonnes (Same as for 1A) γₑₗ=τ/G=3W_{M}/(2πR_{P}R_{R}v_{R}G)=3×3.7×10⁷/[2π×0.4×0.6×6.3×8×10¹⁰]=0.015%

Comment

This version combines an undesirably large current with the undesirably high mass of the first example. Moreover, even while it has many fewer brushes, the same total brush area is required. The illusion of lessened demand for brushes arises on account of a tenfold increase of the slip ring width with only marginal advantages.

(1D) As 1B but with Voltage lowered to 900V

(Most of the Repeated Values are not Listed)

Selected Parameters

W_{M}=50,000 hp=3.7×10⁷ watt

M_{M}=3.5×10⁶[Nm]=2.6×10⁶[lb ft]

V_{M}=900 Volt

i=41,000 Ampere

R_{R}=0.6 m=2 ft

D_{M}=3R_{R}=1.8 m=6 ft (eq.29)

L_{R}=4R_{R}=2.4 m=8 ft (i.e. λ=4)

ω=100 RPM

N_{R}=30

B=1 tesla

Derived Parameters

t_{R}=6.7 cm ¼″

₁V_{R}=30 [V]

[symbol] ᵢₙₜ≈8.3×10⁻⁴ Ω

[symbol] =i² [symbol] ᵢₙₜ/W_{M}=3.8%

E_{M}≅92.9% (eq.36)

A_{S}=N_{R} i/10⁶{A/m²]=1.23 m²=14 ft² (active slip ring area)

Δ=A_{S}/N_{R}Lⱼ=0.68 cm=0.27″ (width of individual slip ring)

L_{S}=2.05 [m] (added length for slip ring area)

L_{M}=5.6 m=18 ft

T_{B}=2 years (expected interval between brush plate replacements)

m_{corr}=52 tonnes

Conclusions Regarding Large Machines

The last example (1D) shares the low weight with the short-length version of the high-voltage machine (1B). The pattern demonstrated above is clear: One may tailor machine sizes and weights in accordance with machine length. However, at same power and speed, the machine weight is not proportional to magnet length (and thus the voltage at same number of turns) on account of endplates that are determined by the machine power and total axial extent of slip rings. The latter grows in proportion with the number of rotors. The requirements on brushes for large machines as contemplated in the above example would be forbidding with individually held brushes, but are believed to be routine by the use of brush plates as already discussed in connection with 1B above. The brush plate length is essentially the same as Lₛ, the total axial extent of the slip rings and grows in proportion with the number of turns.

Contemplating actual requirements, the best choice for a 50,000 hp slow rotating, i.e. 100 RPM, ship drive motor, might be 4160V (to adapt to presently available Navy voltage supplies), with i=8900 A, with a machine length ≅18 ft and weight ≅60 tonnes.

(b) Mid-Size Motor Suitable for Podded Ship Drives

(2) Mid-Sized Ship Drive, 5000 hp, 120 RPM, 4160V, L_{M}=5.4 m, 3 ft dia, B=1 tesla ass.

Using the same parametric relationships as before (i.e. eqs.4, 31-48)

Selected Parameters

W_{M}=5,000 hp=3.7×10⁶ watt (machine power at full speed)

ω=120 RPM=4π[rad/sec] (rotation speed at fill power)

M_{R}=W_{M}/ω=2.9×10⁵ Nm=2.1×10⁵ ftlbs (torque at full current, independent of speed)

V_{M}=4160 Volt (applied voltage at maximum torque)

i=900 Ampere (current at maximum torque)

R_{R}=0.3 m=1 ft (rotor radius)

R_{P}=2/3 R_{R}=0.15 m (axle radius)

D_{M}=3R_{R}=0.9 m=3 ft (diameter of flux return=machine diameter)

L_{R}=4.5 m=15 ft (i.e. λ=15)

L_{b}=0.1 m=4″ (i.e. λ=3) (width of bottom strip free of eddy current barriers)

L_{E}=2/3 R_{R}=0.2 m=0.67 ft (width of endplates)

Lⱼ=R_{R}=0.3 m=1 ft (active slip ring length on each side)

δL_{B}=2 cm (permissible brush wear length)

v_{R}=3.8 m/s=12.6 ft/sec (brush sliding velocity at full speed)

₁V_{R}=2v_{R}BL_{R}=34V (voltage drop per rotor at full speed)

N_{R}=4160/34.2=122 (number of rotors)

t_{R}=R_{R}/3N_{R}=0.82 mm (rotor wall thickness, including insulation layer 48)

[symbol] ᵢₙₜ=(ρN_{R}²/R_{R})[6λ+3πβ/2]≈0.085 Ω (internal electrical machine resistance)

[symbol] =i² [symbol] ᵢₙₜ/W_{M}=1.9% (loss due to internal electrical resistance at fill current)

E_{M}=100%(1−2%− [symbol] −0.4[V]/₁V_{R})=94.9% (efficiency including all losses)

A_{S}=N_{R} i/10⁶{A/m²]=0.11 m²=1.2 ft² (total active slip ring area)

Δ=A_{S}/N_{R}R_{R}=3 mm=0.12″ (width of individual slip ring including separator strip)

L_{S}=N_{R}Δ=0.37 m (added motor length due to slip ring area)

L_{M}=L_{R}+2L_{E}+L_{b}+L_{S}=5.4 m=18 ft (total machine length)

T_{B}=δL_{B}/(v_{R}×5×10⁻¹¹)=1.05×10⁸ seconds=3.3 years (expected time interval between brush plate replacements)

m_{M}≈(π/8)dD_{M}²(L_{M}+L_{R})=23.6 tonnes (machine mass at B=1 tesla throughout)

m_{F}=3.93dλR_{R}³=11.2 tonnes (mass of flux return at B=1 tesla)

δm_{M}=0.44 m_{F}=5.25 tonnes (reduction of mass if B=1.8 tesla in flux return)

m_{corr}=m_{M}−δm_{M}=18.4 ton (mass with B=1 tesla in rotors and 1.8 tesla in flux return)

(c) Automotive Motors

(3) Car Motor, 150 hp, 4000 RPM, 150V, i=800A, L_{M}=0.6 m=2 ft, B=1 tesla assumed.

Using the same parametric relationships as before (i.e. eqs.4, 31-48)

Selected Parameters

W_{M}=1.2×10⁵ watt ≅150 hp (machine power at full speed)

ω=4000 RPM=419 [rad/sec] (rotation speed at full power)

M_{R}=W_{M}/ω=290 Nm=210 ftlbs (torque at full current)

V_{M}=150 Volt (applied voltage at maximum toque)

i=800 Ampere (current at maximum torque)

R_{R}=0.1 m=4″ (rotor radius)

R_{P}=1/2″=1.25 cm (axle radius)

D_{M}=3R_{R}=0.3 m=1 ft (diameter of flux return=machine diameter)

L_{R}=0.45 m=1.5 ft (i.e. λ=4.5)

L_{b}=0.05 m=2″ (i.e. λ=3) (width of bottom strip free of eddy current barriers)

L_{E}=1/4 R_{R}=0.025 m=1″ (width of endplates)

Lⱼ=R_{R}=0.1 m=1 ft (active slip ring length on each side)

δL_{B}=2 cm (permissible brush wear length)

Derived Parameter

v_{R}=ωR_{R}=42 m/s=140 ft/sec (perimeter velocity of rotors at full speed)

₁V_{R}=2v_{R}BL_{R}=37.8V (voltage drop per rotor at fill speed)

N_{R}=V_{M}/₁V_{R}=4 (number of rotors)

t_{R}=R_{R}/3N_{R}=1.67 cm (rotor wall thickness including insulation layer 48)

[symbol] ᵢₙₜ=(ρN_{R}²/R_{R})[6λ+3πβ/2]≈1.1×10⁴ Ω (internal electrical resistance of motor)

[symbol] =i² [symbol] ᵢₙₜ/W_{M}=0.1% (loss due to internal electrical resistance at full current)

E_{M}≅100%(1−2%− [symbol] −0.4[V]/₁V_{R})=97.5% (efficiency including all losses)

A_{S}=N_{R} i/10⁶{A/m²]=2×10⁻³ m²=3.1 in² (required active slip ring area)

R_{slipRing}=R_{R}/2=5 cm (reduced slip ring diameter to lower bush velocity)

v_{B}=ωR_{SliRing}=21 m/sec (brush velocity at maximum speed)

Δ=A_{S}/N_{R}R_{SlipRing}=1 cm=0.4″ (required individual slip ring width with. reduced slip ring diameter in order to reduce brush velocity)

L_{S}=N_{R}Δ=4 cm=1.6″ (added motor length due to slip ring area)

L_{M}=L_{R}+2L_{E}+L_{b}+L_{S}=0.6 m=2 ft (motor length)

T_{B}=δL_{B}/(v_{R}×5×10⁻¹¹)=2×10⁷ seconds=5500 hrs (equal to expected life time of car!)

m_{M}≈(π/8)dD_{M}²(L_{M}+L_{R})=278 kg (motor mass at B=1 tesla throughout)

m_{F}=3.93dλR_{R}³=123 kg (mass of flux return at B=1 tesla)

δm_{M}=0.44 m_{F}=55 kg (reduction of mass if B=1.8 tesla in flux return)

m_{corr}=m_{M}−δm_{M}=223 kg (mass with B=1 tesla in rotors and 1.8 tesla in flux return)

mₘᵢₙ=m_{M}/1.8=154 kg (eq.45f)(minimum of motor mass with B=1.8 tesla throughout)

Comments

This appears to be an attractive but understated design. Certainly on account of the very low value of [symbol] this motor could be driven to a much higher power output, or conversely at same power could be made lighter with somewhat lowered efficiency (compare numerical examples 1B versus 1A above).

(d) Motors Below Automotive Power

(4a) Ship Pump Motor, 10 hp, 400 RPM, 220V, i=50A, B=1 tesla assumed.

Using the same parametric relationships as before (i.e. eqs.4, 31-48)

Selected Parameters

W_{M}=7,500 watt ≅10 hp (power at full speed)

ω=400 RPM=42 [rad/sec] (rotation speed at fill power)

M_{R}=W_{M}/ω=179 Nm=131 ftlbs (torque at fill current)

V_{M}=150 Volt (applied voltage at maximum toque)

i=50 Ampere (current at maximum torque)

R_{R}=0.05 m=2″ (rotor radius)

D_{M}=3R_{R}=0.15 m=½ ft (diameter of flux return=machine diameter)

L_{R}=0.6 m=2 ft (i.e. λ=12)

L_{b}=0.025 m=1″ (i.e. β=2) (width of bottom strip free of eddy current barriers)

L_{E}=1/10 R_{R}=0.5 cm (width of endplates)

Lⱼ=R_{R}=5 cm (active slip ring length on each side)

δL_{B}=2 cm (permissible brush wear length)

Derived Parameter

v_{R}=ωR_{R}=2.1 m/s (brush sliding velocity at full speed)

₁V_{R}=2v_{R}BL_{R}=2.5V (voltage drop per rotor at full speed)

N_{R}=V_{M}/₁V_{R}=60 (number of rotors)

t_{R}=R_{R}/3N_{R}=0.83 mm (rotor wall thickness including insulation layer 48)

[symbol] ᵢₙₜ=(ρN_{R}²/R_{R})[6λ+3πβ/2]≈0.097 Ω (internal electrical resistance of motor)

[symbol] =i² [symbol] ᵢₙₜ/W_{M}=2.2% (loss due to internal electrical resistance at full current)

E_{M}≅100%(1−2%− [symbol] −0.4[V]/₁V_{R})=80% (efficiency including all losses)

A_{S}=N_{R} i/10⁶{A/m²]=3×10⁻³ m²=4.7 in² (required active slip ring area)

Δ=A_{S}/N_{R}R_{R}<Δₘᵢₙ i.e. choose Δ=Δₘᵢₙ=0.25 cm (individual slip ring width)

L_{S}=N_{R}Δₘᵢₙ=15 cm=6″ (added length due to slip ring area with Δ=Δₘᵢₙ=0.25 cm)

L_{M}=L_{R}+2L_{E}+L_{b}+L_{S}=0.79 m=2.6 ft (motor length)

T_{B}=δL_{B}/(c_{R}×5×10⁻¹¹)=1.9×10⁸ sec=6 years (exceed expected life time of pump)

m_{M}≈(π/8)dD_{M}²(L_{M}+L_{R})=92 kg=200 lbs (motor mass at B=1 tesla throughout)

m_{F}=3.93dλR_{R}³=44 kg=97 lbs (mass of flux return at B=1 tesla)

δm_{M}=0.44 m_{F}=19.5 kg (reduction of mass if B=1.8 tesla in flux return)

m_{corr}=m_{M}−δm_{M}=73 kg (mass with B=1 tesla in rotors and 1.8 tesla in flux return)

mₘᵢₙ=m_{M}/1.8=51 kg (eq.45f)(minimum of motor mass with B=1.8 tesla throughout)

(4B) Ship Pump Motor, 10 hp, 2500 RPM, 320V, i=24A, B=1 tesla assumed.

Using the same parametric relationships as before (i.e. eqs.4, 31-48)

Selected Parameters

W_{M}=7,700 watt≅10 hp (power at full speed)

ω=2500 RPM=262 [rad/sec] (rotation speed at fill power)

M_{R}=W_{M}/ω=29 Nm=21.6 ftlbs (torque at full current)

V_{M}=320 Volt (applied voltage at maximum toque)

i=24 Ampere (current at maximum torque)

R_{R}=0.05 m=2″ (rotor radius)

D_{M}=3R_{R}=0.15 m=½ fit (diameter of flux return=machine diameter)

L_{R}=0.6 m=2 ft (i.e. λ=12)

L_{b}=0.025 m=1″ (i.e. β=2) (width of bottom strip free of eddy current barriers)

L_{E}=1/10 R_{R}=0.5 cm (width of endplates)

Lⱼ=R_{R}=5 cm (active slip ring length on each side)

δL_{B}=2 cm (permissible brush wear length)

Derived Parameter

v_{R}=ωR_{R}=13.1 m/s (brush sliding velocity at fill speed)

₁V_{R}=2v_{R}BL_{R}=15.7V (voltage drop per rotor at fill speed)

N_{R}=V_{M}/₁V_{R}=20 (number of rotors)

t_{R}=R_{R}/3N_{R}=0.25 cm (rotor wall thickness including insulation layer 48)

[symbol] ᵢₙₜ=(ρN_{R}²/R_{R})[6λ+3πβ/2]≈0.011 (internal electrical resistance of motor)

[symbol] =i² [symbol] ᵢₙₜ/W_{M}=0.08% (loss due to internal electrical resistance at full current)

E_{M}≅100%(1−2%− [symbol] −0.4[V]/₁V_{R})=96% (efficiency including all losses)

A_{S}=N_{R} i/10⁶{A/m²]=4.8×10⁻⁴ m²=0.74 in² (required active slip ring area)

Δ=A_{S}/N_{R}R_{R}<Δₘᵢₙ i.e. choose Δ=Δₘᵢₙ=0.25 cm (individual slip ring width)

L_{S}=N_{R}Δₘᵢₙ=15 cm=6″ (added length due to slip ring area with Δ=Δₘᵢₙ=0.25 cm)

L_{M}=L_{R}+2L_{E}+L_{b}+L_{S}=0.79 m=2.6 ft (motor length)

T_{B}=δL_{B}/(v_{R}×5×10⁻¹¹)=1.9×10⁸ sec=6 years (exceed expected life time of pump)

m_{M}≈(π/8)dD_{M}²(L_{M}+L_{R})=92 kg=200 lbs (motor mass at B=1 tesla throughout)

m_{F}=3.93dλR_{R}³=44 kg=97 lbs (mass of flux return at B=1 tesla) δm_{M}=0.44 m=19.5 kg (reduction of mass if B=1.8 tesla in flux return)

m_{corr}=m_{M}−δm_{M}=73 kg (mass with B=1 tesla in rotors and 1.8 tesla in flux return)

mₘᵢₙ=m_{M}/1.8=51 kg (eq.45f)(minimum of motor mass with B=1.8 tesla throughout)

(5) Wheelchair Motor, ¼ hp, 5500 RPM, 24V, 7.8A, 10 cm=⅓ ft Dia (B=1 Tesla ass.)

Using the same relationships, i.e. eqs.4, 31-48, as before. For meaning of symbols see above

Selected Parameters

W_{M}=¼ hp=190 watt

V_{M}=24 Volt

i=7.8 Ampere

R_{R}=3.3 cm=1.3″

D_{M}=3R_{R}=0.1 m=⅓ ft

ω=5500 RPM=576 [rad/sec]

M_{R}=W_{M}/ω=0.34 Nm=0.24 lbft

v_{R}=19 m/sec

L_{R}=0.08 m (i.e. λ=2.4)

L_{E}=0.25 cm

L_{b}=0.3 cm (i.e. β=11)

δL_{B=1} cm (permissible brush wear length)

₁V_{R}=2v_{R}BL_{R}=3V

N_{R}=V_{M}/₁V_{R}=8

N_{B}=16 (two brushes per rotor)

Derived Parameters

t_{R}=R_{R}/3N_{R}=2.8 mm (including insulation)

[symbol] ᵢₙₜ≈(ρN_{R}²/R_{R}) 6λ≈1.4×10⁻⁵ Ω [symbol] =i² [symbol] ᵢₙₜ/W_{M}=4.5×10⁻⁶

E_{M}≅100%(1−2%− [symbol] −0.4[V]/₁V_{R})=84.7%

A_{S}=N_{B} i/10⁶[m²]=1.3 cm²=0.2 in² (required active slip ring area)

Δ=A_{S}/N_{R}R_{R}=0.47 mm<Δₘᵢₙ i.e. choose Δ=Δₘᵢₙ=0.25 cm (slip ring width)

L_{S}=N_{R}Δₘᵢₙ=0.02 m (added length for slip ring area)

L_{M}=L_{R}+2L_{E}+L_{b}+L_{S}=10.8 cm=4.25″ (motor length)

T_{B}=T_{B}=δL_{B}/(v_{R}×5×10⁻¹¹)=1.05×10⁷ sec=4 months use before brush replacement

m_{M}≈(π/8)dD_{M}² (L_{M}+L_{R})=5.5 kg=12 lbs

m_{F}=3.93dλR_{R}³=2.5 kg

δm_{M}=0.44 m_{F}=1.1 kg

m_{corr}=m_{M}−δm_{M}=4.4 kg=10 lbs

mₘᵢₙ=m_{M}/1.8=3 kg=6.7 lbs

Comment

Except for the fairly high motor mass this is a very attractive design. It is dominated by the magnet and flux return. A ceramic magnet and flux return might help. The remainder of the motor can be further lightened by using aluminum, i.e. by the factor d_{Cu}/d_{A1}=7.9/2.4=3.3

(e) Small Motors

(6) Motor for Hand-Held Tool: ⅛ hp=100 watt, 12V, 8A, 20,000 RPM, B=1 tests

Using eqs.4, 31-48, as before. For meaning of symbols see numerical example 4 above

Parameters

W_{M}=96 watt

V_{M}=12 Volt

i=8A

R_{R}=1.5 cm

D_{M}=3R_{R}=4.5 cm

L_{R}=R_{R}=12.8 cm (λ=8.5)

L_{b}=R_{R}/3=0.5 cm

ω=15,000 RPM=250 rev/sec=1570 [rad/sec]

v_{R}=ωR_{R}=23.5 m/sec

M_{R}=W_{M}/ω=0.061 [Nm]=0.53 lbin

₁V_{R}=2v_{R}BL_{R}=6 (eq.4 with n=2)

N_{R}=2

N_{B}=4

t_{R}=R_{R}/3N_{R}=0.25 cm

ρ=1.65×10⁻⁸ Ωm (for copper)

[symbol] ᵢₙₜ≈(ρN_{R}²/R_{R}) 6λ≈2.2×10⁻⁴ Ω

[symbol] =i² [symbol] ᵢₙₜ/W_{M}=0.014%

E_{M}≅100%(1−2%− [symbol] −0.4[V]/₁V_{R})=91.3%

A_{S}=N_{B} i/10⁶ [m²]=0.32 cm²=0.05 in² (required active slip ring area)

Δ=A_{S}/N_{R}R_{R}=1 mm<Δₘᵢₙ i.e. choose Δ=Δₘᵢₙ=0.25 cm (individual slip ring width)

L_{S}=N_{R}Δ=0.5 cm (added length for slip ring area)

L_{M}=L_{R}+2L_{E}+L_{b}+L_{S}=14 cm=5.55″ (motor length)

δL_{B}=0.5 cm

T_{B}=T_{B}=6L_{B}/(v_{R}×5×10⁻¹¹)=4.3×10⁶ sec=1200 hours use before brush replacement

m_{M}≈(π/8)dD_{M}²(L_{M}+L_{R})=1.6 kg =3.5 lbs m_{F}=3.93dλR_{R}³=0.84 kg

δm_{M}=0.44=0.37 kg

m_{corr}=m_{M}−δm_{M}=1.2 kg=2.7 lbs

=m_{M}/1.8=0.89 kg=2 lbs

(f) Further Comments on Numerical Estimates and Regarding Bipolar Generators

In practice, machine mass can be a very important parameter, among others for ship drives and for hand-held tools. However, it is difficult to assess, and the above data for masses as well as other variables depend on construction details that in the future will presumably be optimized from case to case. Specifically, the above estimates were based on simple relationships between rotor radius, R_{R}, and other geometrical parameters, i.e. dimensions of magnet cross section and gap width. They thus depend on the particular relationship assumed. These are subject to variations according to preferences. The data are therefore only meant to serve as broad guidelines that reveal approximate values and trends.

Machines for hand-held tools represent the extreme lower end of the size scale for bipolar motors. For these, rather high rotation speeds are desired but voltages are low and rotor diameters are restricted to, say, R_{R}=1.5 cm as assumed above. Again, it would be desirable to lighten the motor. The best approach here may be the use of ceramic magnets.

The above are just a few examples to indicate the very wide range of applicability of bipolar motors. A similarly wide range of generators is, of course, possible since all of the above conceptual designs will operate equally well as motors and generators.

J. Additional Methods to be Used in Manufacturing Bipolar Machines

(a) Preferred Methods for Mass Production of Brush Holder Strips of Brush Plates

In section D(e), discussion of how to manufacture the fibrous parts of brush strips and how to attach them to the solid parts (e.g. as in FIG. 10A, whose thickness d_{W} will typically be comparable to R_{R}/4) was deferred. Yet it is imperative for the success of bipolar machines, especially of medium to large size, that these fibrous parts be mass-produced and incorporated into brush plates, efficiently, with high quality control and at tolerable cost.

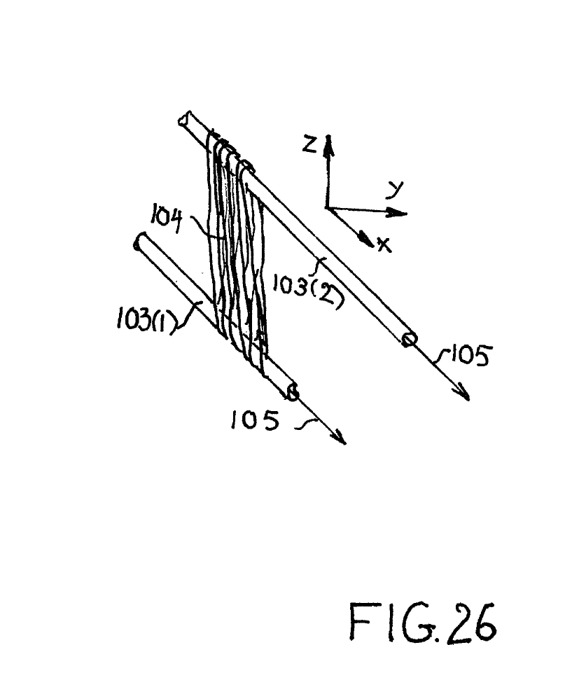

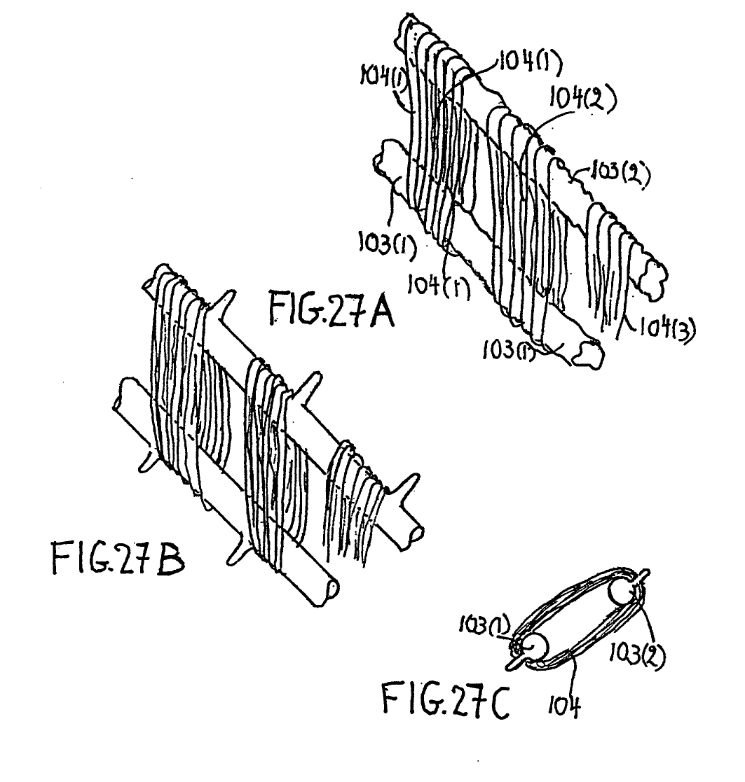

In principle—various methods are available, especially adaptations of manufacturing methods for widely used brush types of comparable morphology, e.g. tooth brushes, nail brushes, shoe brushes etc. Quite possibly future experience will show one or more of these to be satisfactory but at this point that seems doubtful. According to the present invention, therefore, the following method, which is an adaptation and expansion of a method in ref. 11 (FIGS. 9 and 12A of ref 11), is proposed, as explained below and in FIGS. 26 to 33:

Based on present best knowledge, the favored but not exclusive fiber materials are continuous metal fibers that have been kinked in order to provide “loft”(ref.11) and which have already been formed into tows of several to many individual fibers (104), so that they may be handled much like textile yarn. However, any other conductive fibers may be similarly used, singly or pre-assembled into strands. According to the present invention, such strands or tows will be wrapped or wound around parallel rails (103) of suitable size, shape and material, in a manner and orientation that will yield the desired metal fiber distribution and inclination relative to the strips as indicated in FIGS. 8 and 13 and illustrated in FIG. 26.

Typically but not necessarily, the rails (103) will be made of metal, e.g. aluminum or copper or their alloys, and the indicated winding or wrapping of the fiber tows (104) to their desired distribution along the rails will be done in a continuous fashion while the two rails advance in their long direction (105), i.e. the x-direction in FIG. 26. Advantageously, the cross section of the rails will be shaped to facilitate the wrapping/winding and/or to assure the secure subsequent positioning of the fibers in the further course of manufacture. Examples are indicated in FIG. 27, wherein the rails in FIG. 27A are roughened like concrete reinforcement bars and those in FIG. 27B have posts that are shown in cross section in FIG. 27C. Also indicated in FIG. 27 is the fact that gaps are left between sections of fiber tow wrapping 104, that in the finished brush plates will be the gaps between fibers for moist-ure access. As already indicated, such gaps will presumably not be necessary if the machine operates while immersed in water and perhaps other fluids, in agreement with section (G).

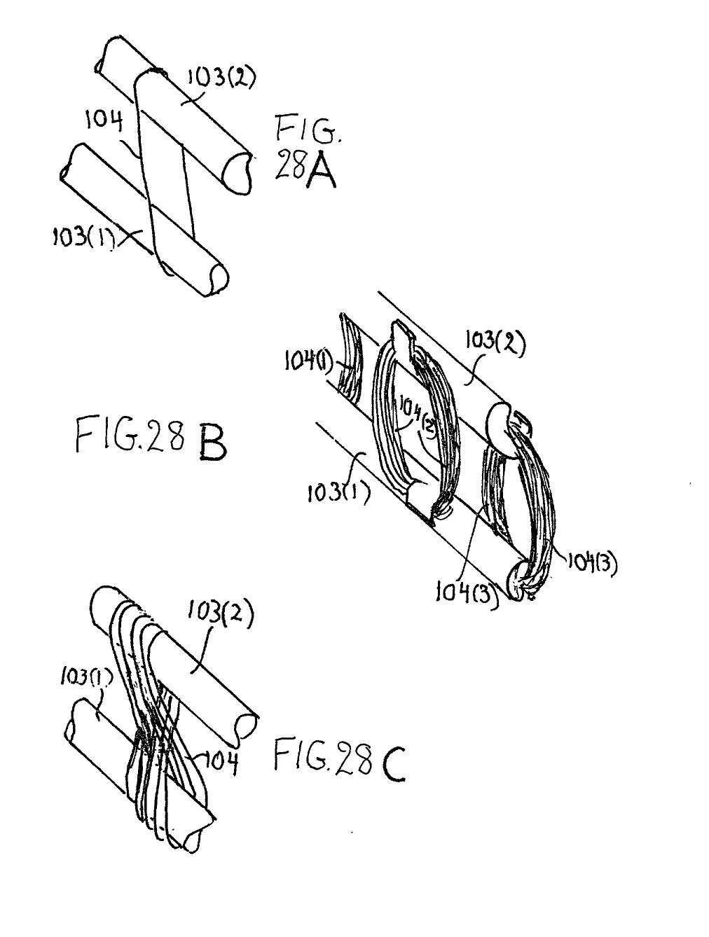

The discussed wrapping may take the form of ordinary looping about the two rails as in FIG. 28A, or it may be looping about protrusions from the rails as in FIG. 28B, or also, say, in the shape of figure eight's as in FIG. 28C. The choice among these and still other conceivable modifications of wrapping will depend on manufacturing costs and effect on the final fiber distribution and properties. Specifically, the morphology of FIG. 28C will be advantageous for eventual positioning of brush plates on closely spaced slip rings to which reference was made in section (De) and to which we shall return presently.

The indicated mechanical aids for fiber positioning may be replaced or supplemented by methods of adhesion of various forms, e.g. by coating the bars with a suitable adhesive or placing on them strips of two-sided adhesive foils etc.

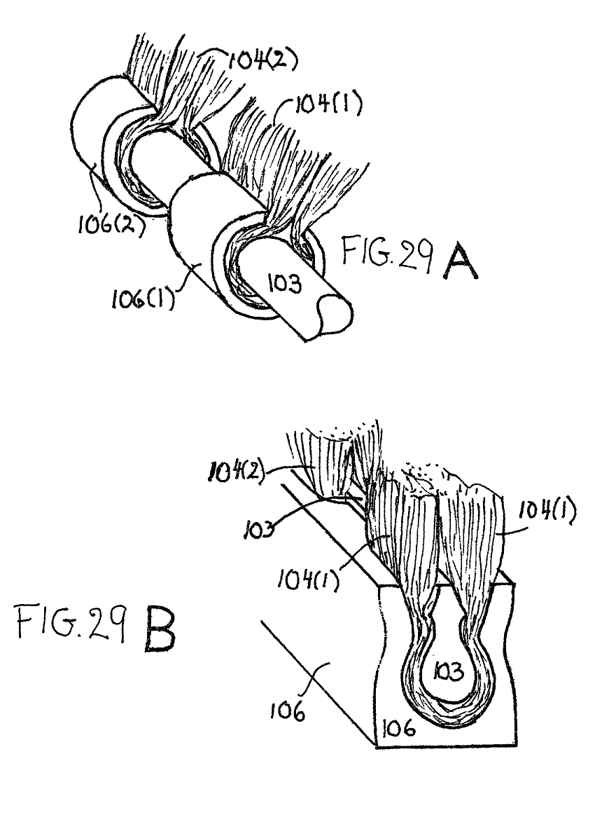

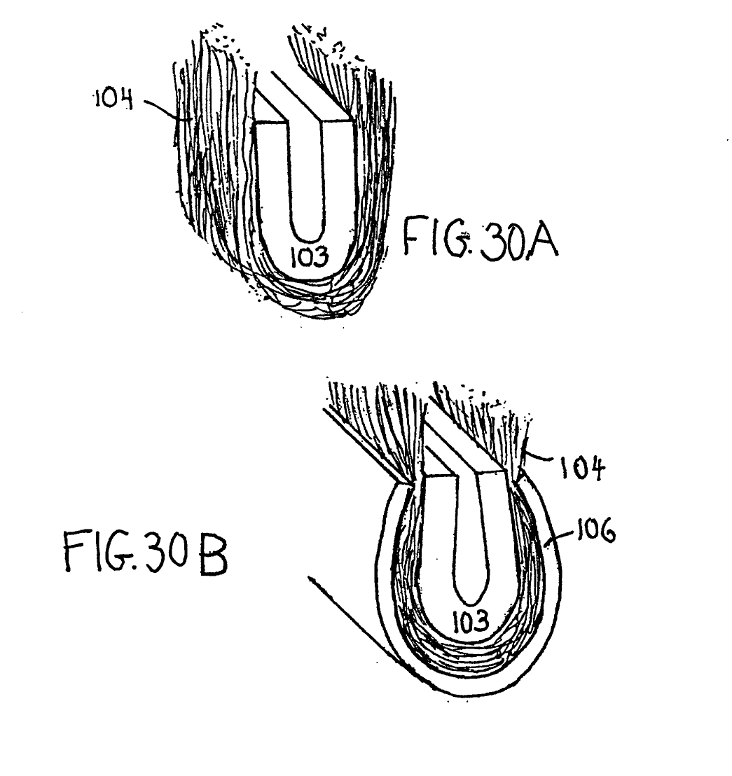

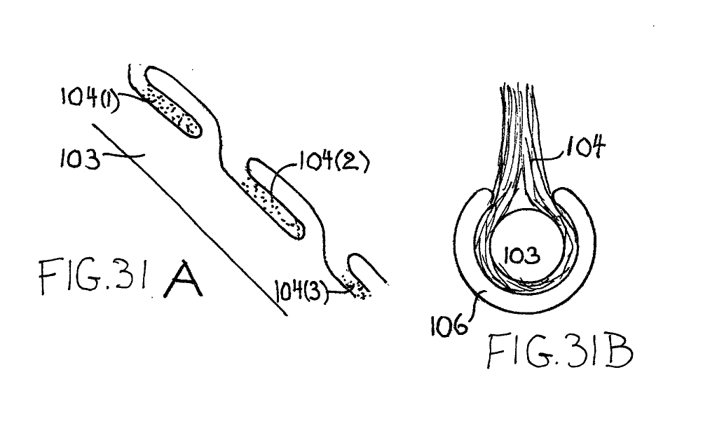

After obtaining the desired distribution of fibers on the two rails 103(1) and 103(2), they shall be covered with suitable plastically deformable metal sheath (106) either in the form of a continuous sheath as contemplated in FIG. 29B, or of pieces that are coordinated with the fiber distribution on the rails as in FIG. 29A. In either case the sheaths are crimped about the rails and fibers to form a firm mechanical, electrically conducting bond among the fibers and between the sheaths and the fibers, as indicated in FIG. 29. Possible loosening of the desired strong mechanical bond by elastic back-spring may be combated by leaving gaps in the rails as indicated in FIG. 30 showing a cross section of a rail with cavity before (FIG. 30A) and after crimping (FIG. 30B). Also, tabs and/or protrusions extending from the rails as in FIGS. 27B and 28B will be flattened against the rails as indicated in FIG. 31A and thereby add to the mechanical bonding between rails 103 and fiber sections 104(1), 104(2) etc.

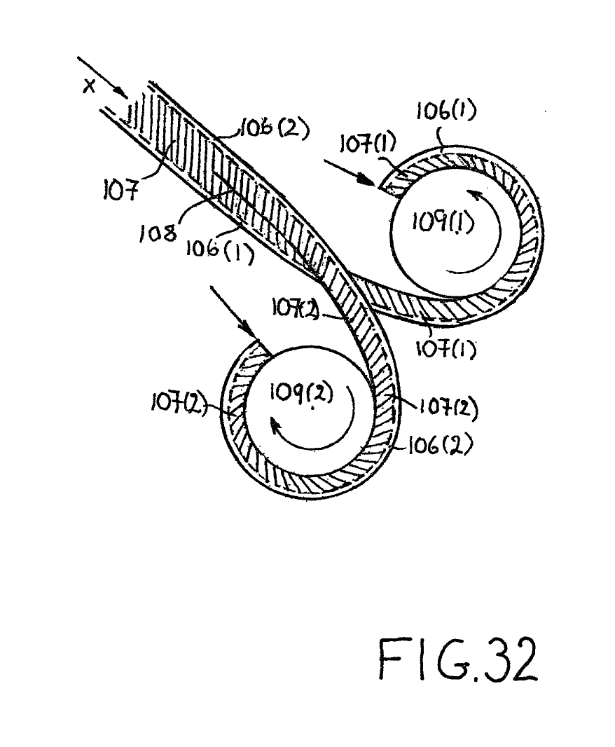

Preferably, the rails will be of a highly electrically conductive metal, e.g. copper, brass, aluminum or aluminum alloy, so that the mechanical bonding between rails and sheaths with the intervening fibers through the discussed crimping will also be conductive between sheaths and rails, thereby reducing the eventual internal resistance of the resulting brush plates. In line with the previous indication regarding the use of adhesive as an aid in, if not the means of, positioning the fibers, the mechanical bonding through crimping may be supplemented, if not replaced by conductive adhesion, e.g. by means of epoxy filled with metal or graphite powder. Also soldering, brazing or any other suitable method could be used. After the discussed crimping or other bonding method, the intended running surfaces must be shaped into rail strips. One method is to embed sheaths and fiber wrapping in a suitable hard material, or at least a zone of the fibers between the rails shall be so embedded, so as to permit making a lengthwise cut through the middle of the structure as indicated in FIG. 32. Herein label 107 indicates the embedded fiber material that is cut at position 108 in FIG. 32. At the time of cutting, the embedment material must be hard enough to permit making a clean cut through the fibers without unduly distorting their shape and distribution.

While the embedment of whatever material is still in place, the ends of the embedded fibers 107 can be machined or otherwise shaped to their final intended contour for sliding on the slip rings, with high precision, e.g. by cutting in a lathe, by grinding, by smoothing with emery paper and/or any other mechanical means. Thereafter the embedment is removed by dissolving, melting away, sublimation or any other suitable method and the fibers are cleaned from residue that might interfere with the later electrical conduction from brush plate to slip rings. Thereafter, the now completed fibrous part of the brush strip may be affixed to its designated sturdy brush plate strip 65 and on to final assembly into brush plates by any of the methods already discussed in conjunction with FIGS. 9 and 10, including soldering, conductively gluing, dove-tailing or other. The order of the steps enumerated above is given by way of example and is not exclusive. This may therefore be rearranged as may be most suitable, consistent with the production of serviceable brush plates, preferably of high precision and produced without undue expense.

(b) Fiber Embedment and Shaping the Running Surfaces of Brush Plates

Above reference was made to the proposed transient embedment of the fibers in order to permit cutting and shaping them. Such a temporary filer material is helpful at all brush sizes and is definitely necessary for fiber brushes with relatively large running surfaces, e.g. above a few millimeters diameter. Brushes of small running surface areas and relatively long lengths, may indeed be cut and shaped simply by cutting with scissors or a razor blade, e.g. while the fibers project out of a glass tubing.

(c) Preferred Filler Materials for Eddy Cuts on Slip Rings

Above, stop-off lacquer has been repeatedly named as a favored material for filing eddy cuts. For eddy cuts within the layered rotors, this is an excellent choice, especially also since it may at the same time serve as insulating layer between adjoining rotors. Many other polymers, ceramics and composites will also be found useful.

(d) Methods for Placing Brush Plates on Slip Ring Assemblies

Preferred aids in placing brush plates on slip rings have already been discussed in section (De). In one embodiment according to the present invention, the fibrous parts of brush strips will be manufactured so that initially the fibers lean inward, i.e.towards the length-wise mid-line of the slip rings so as to leave distinct gaps between adjacent brush strips before use. The winding method shown in FIG. 28C will yield that desired shape. This is indicated in FIG. 31B which shows the expected initial fiber morphology after crimping and cutting a fiber winding as in FIG. 28C. In this method, care must be taken that the initial gaps are wide enough for placing the later, perhaps rather large, brush plates onto parallel slip rings with separators 49 or slip ring extensions 33, e.g. as in the morphology of FIGS. 8, 16, 21 and 22. Care should be taken in the brush construction that, in the course of use, the fibers spread out against the adjoining slip ring separators 49 and slip ring extensions 33 as little as possible.

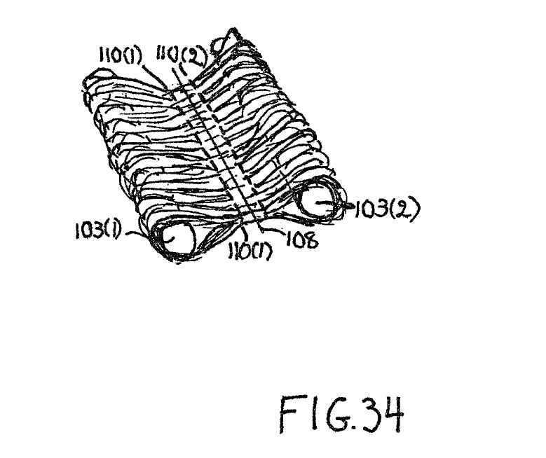

According to the present invention, another preferred method for inserting fibrous brush strip parts on brush plates between slip ring separators (49) during brush plate installation, is to stitch the fibers together in two parallel. lines before embedment. Cut (108) as in FIG. 32 will then be made between the two stitched lines, as indicated in FIG. 34. Preferably, said stitching will be made to be easily removable, e.g. as in commercial easily removed sewing sometimes used for the closure of strong paper sacks such as for bird feed. Preferably the stitching will remain in place until the brush plate has been placed and it will be pulled out as a late or perhaps the last step in brush plate installation.

(e) Protecting Machines Against Failure of Individual Brush Strips

Since the brush strips in brush plates, and similarly equi-potential brush sequences on consecutive slip rings, are “in series”, the failure of even an isolated brush strip or brush sequence would cause the failure of the whole machine. This hazard evidently rises in proportion with the number of rotors, N_{R}. In order to prevent such failures (however unlikely they might be based on the general reliability of fiber brushes, of mass production techniques for brush plates, and of stringent quality control) according to the present invention the insulation between adjacent brush strips or brush sequences shall break down and the affected brush strips thereby be automatically short-circuited once the potential drop between them increases beyond some predetermined limit, e.g. 5×V_{M}/N_{R}, and similarly for the insulation between adjacent brush sequences.

The desired automatic short-circuiting between adjacent slip rings on which the brushes fail may be accomplished by different electronic means, to be disclosed in a planned patent application. Another, most simple means to effect the discussed short-circuiting about failing brushes is the use of “dielectric breakdown bonding” (100), Le. mechanical bonding that optionally incorporates an insulating material between adjacent brush strips or brush sequences whose dielectric breakdown voltage equals a pre-determined cut-off limit, i.e. 5×V_{M}/V_{R} in the discussed specific case.

Various suitable insulators with pre-determined dielectric breakdown voltages doubtlessly exist. A specific favored embodiment according to the present invention is oxidized aluminum foils of the kind widely used in commercial capacitors. Their dielectric breakdown electric field strength may be varied through varying their thickness and/or the thickness of their oxide layer that may be controlled through electrolysis.

In the discussed method of machine protection against the failure of a minority of brushes, according to the present invention, adjacent brush plate layers, 65(n), in brush plates, e.g. as in FIG. 10, would be glued together by means of electrically conductive adhesive, e.g. as used for mounting samples in scanning electron microscopes, applied to both sides and with the insulating foil of pre-determined dielectric breakdown field, e.g. oxidized aluminum foil, sandwiched between the two thin conductive layers of adhesive. In the normal mode of operation, the foil with predetermined dielectric breakdown voltage will serve as the requisite insulating barrier among neighboring brush strips. However, should brushes fail and the voltage rise to the pre-determined limiting value, dielectric breakdown would occur and direct electrical connection be established between the nearest still functioning brush strips.

### REFERENCES

1. A. S. Langsdorf, “Principles of Direct-current Machines”, McGraw-Hill, NY 1959.

2. D. Kuhlmann-Wilsdorf; “Management of Contact Spots Between an Electrical Brush and Substrate”, U.S. and International (PCT) Patent Application, filed Oct. 22, 1999, U.S. Serial No. 60/105,319.

3. G. R. Slemon, “Magnetoelectric Devices, Transducers, Transformers and Machines”, John Wiley and Sons, NY) 1966.

4. L. J. Petersen, D. Urciuol, M. Alma, T. H. Fiske, L. D. Stubbs, W. A. Lynch and N. A. Sondergaard (Naval Surface Warfare Center), D. Kuhlmann-Wilsdorf J. T. Moore and R. B. Nelson (UVA), M. S. Bednar, W. M. Elger, R. W. Johnson and R. J. Martin (Noesis) and M. Heiberger (General Atomics Corp.), “A Study of the Magnetic Field Effects upon Metal Fiber Current Collectors in a High Critical Temperature Superconducting Homopolar Motor”, Proc. Third Naval Symposium on Electric Machines 2000, Philadelphia, Pa., Dec. 4-7, 2000. (On CD).

5. J. E. Noeggerath, Trans. AIEE, 24, 1 (1905)

6. B. G. Lamme, Trans. AWEE, 31, (part II), 1811 (1912).

7. See Jim Treible, Mroquette Engineer, April 1955.

8. A. H. Barnes, U.S. Pat. No. 2,588,466, Mar. 11, 1952.

9. D. Kuhlmann-Wilsdorf, C. M. Adkins, and H. G. F. Wilsdorf, “An Electric Brush and Method of Making”, U.S. Pat. No. 4,415,635, Nov. 15, 1983.

10. D. Kuhlmann-Wilsdorf; “A Versatile Electrical Fiber Brush and Method of Making”, U.S. Pat. No. 4,358,699, Nov. 9, 1982.

11. D. Kuhlmann-Wilsdorf, D. D. Makel and G. T. Gillies, “Continuous Metal Fiber Brushes”, U.S. Pat. No. 6,245,440, Jun. 12, 2001.

12. “Metal Fiber Brushes”, D. Kuhlmann-Wilsdorf, (Chapter 20 in “Electrical Contacts: Principles and Applications”, Ed. p. G. Slade, Marcel Deldker, NY), 1999, pp.943-1017.

13. D. Kuhlmann-Wilsdorf “Holder for Electrical Brushes and Ancillary Cables”, U.S. patent application, filed Apr. 21, 2000, Ser. No. 09/556,829.

14. D. Kuhlmann-Wilsdorf and R. J. Martin, in Proc. Naval Symp. on Electric Machines (Office of Naval Research in coordination with Carderock Div. Naval Surface Warfare Center and Naval Undersea Warfare Center, Division Newport), Oct. 26-29, 1998, Annapolis, Md.), pp. 191-198.

15. C. M. Adkins III and D. Kuhlmann-Wilsdorf, “Development of High-Performance Metal Fiber Brushes II—Testing and Properties”, Electrical Contacts—1979 (Proc. Twenty-Fifth Holm Conf on Electrical Contacts, Ill. Inst. Techn., Chicago, Ill., 1979), pp. 171-184.

16. D. Kuhlmann-Wilsdorf, “Eddy Current Barriers”, Provisional Patent Application Serial No. 60/289,123, Filed May 8, 2001.

17. D. Kuhlmann-Wilsdorf, “A Novel Tubular Brush Holder”, Provisional Patent Application Serial No. 60/286,969, Filed Apr. 30, 2001.

18. D. Kuhlmann-Wilsdorf “Optimizing Homopolar Motors/Generators”, Provisional Patent Application Serial No. 60/297,283, Filed Jun. 12, 2001.

Each of the above references (1)-(18) are incorporated by reference herein

1. A homopolar motor configured to be driven by a current source comprising:
at least one electrically conductive rotatable rotor configured to flow a current in a current path when the motor is driven by the current source;
a magnetic field source configured to apply a magnetic field penetrating the rotor and intersecting the current path when the motor is driven by the current source;
current channeling means through the thickness of said rotor provided so as to be parallel to said current path during rotation of said rotor;

2. A motor according to claim 1, wherein said rotor further comprises current channeling means defining the current path.

3. A motor according to claim 1, wherein said rotor further comprises current channeling means intersecting a circumferential surface.

4. A homopolar generator configured to generate a current when rotated by a mechanical torque comprising:
at least one electrically conductive rotatable rotor configured to flow a current in a current path when the generator is rotated by a mechanical torque;
a magnetic field source configured to apply a magnetic field penetrating the rotor and intersecting the current path when the generator is rotated by a mechanical torque; and
current channeling means through the thickness of said rotor provided so as to be parallel to said current path during rotation of said rotor;

5. A generator according to claim 4, wherein said rotor further comprises current channeling means defining the current path.

6. A generator according to claim 4, wherein said rotor further comprises current channeling means intersecting a circumferential surface.

7. A homopolar motor according to claim 1 wherein said current channeling means are plural cuts.

8. A homopolar motor according to claim 1 wherein said current channeling means are assemblies of mutually electrically insulated, substantially parallel electrical conductors that are extended in the direction of the current path but have a narrow spatial dimension at right angles to both the current path direction and the magnetic field.

9. A homopolar generator according to claim 1 wherein said current channeling means are plural cuts.

10. A homopolar generator according to claim 1 wherein said current channeling means are assemblies of mutually electrically insulated, substantially parallel electrical conductors that are extended in the direction of the current path but have a narrow spatial dimension at right angles to both the current path direction and the magnetic field.

11. A homopolar motor according to claim 1 wherein said current path passes through at least one electrical brush sliding on a slip ring that is electrically connected to said rotor and rigidly rotates with said rotor about the same axis.

12. A homopolar generator according to claim 1 wherein said current path passes through at least one electrical brush sliding on a slip ring that is electrically connected to said rotor and rigidly rotates with said rotor about the same axis.

13. A homopolar motor according to claim 1, wherein said magnetic field penetrating said at least one rotatable rotor is configured to intersect said current path twice.

14. A homopolar generator according to claim 4, wherein said magnetic field penetrating said at least one rotatable rotor is configured to intersect said current path twice.

15. A homopolar motor according to claim 1, comprising at least one electric brush configured to connect the current path to the stator;
at least one brush holder configured to make a current path between the stator and said electric brush.

16. A homopolar generator according to claim 4, comprising at least one brush holder configured to make a current path between the stator and said electric brush;
at least one brush holder configured to make a current path between the stator and said electric brush.

17. A homopolar motor according to claim 15, wherein said at least one brush holder comprises a brush plate comprising at least one rigid brush holder strip for attaching said at least one electric brush.

18. A homopolar generator according to claim 16 wherein said at least one brush holder comprises a brush plate comprising at least one rigid brush holder strip for attaching said at least one electric brush.

19. A homopolar motor according to claim 17, wherein said brush plate comprises a plurality of brush holder strips and said brush holder strips are electrically interconnected by at least one flexible joint.

20. A homopolar generator according to claim 18, wherein said brush plate comprises a plurality of brush holder strips and said brush holder strips are electrically interconnected by at least one flexible joint.

21. A pair of two similar homopolar motors according to claim 1, that are mechanically and electrically connected in tandem.

22. A pair of two similar homopolar generators according to claim 4, that are mechanically and electrically connected in tandem.

23. A pair of homopolar motors according to claim 21, that are driven by a source of alternating current by means of at least two rectifiers such that the two motors operate in unison.

24. A pair of homopolar generators according to claim 22, that are driven by a source of alternating current by means of at least two rectifiers such that the two generators operate in unison.

25. A homopolar motor according to claim 1 wherein said at least one electrically conductive rotatable rotor comprises a cylinder and the magnetic field source comprises a bar magnet that is elongated in the direction of the rotation axis of said electrically conductive rotatable rotor, whose axis of magnetization is at right angles to said rotation axis, and that is situated within said electrically conductive rotatable rotor

26. A homopolar generator according to claim 4 wherein said at least one electrically conductive rotatable rotor comprises a cylinder and the magnetic filed source comprises a bar magnet that is elongated in the direction of the rotation axis of said electrically conductive rotatable rotor, whose axis of magnetization is at right angles to said rotation axis, and that is situated within said electrically conductive rotatable rotor

27. A homopolar generator according to claim 4 wherein said at least one electrically conductive rotatable rotor comprises a circular disk and the magnetic field source comprises a pair of curved horseshoe magnets on one side of said at least one rotatable rotor and another pair of similar curved horseshoe type magnets in antisymmetric mirror position on the other side of said at least one rotatable rotors.

28. A method of making the at least one cylindrical electrically conductive rotatable rotor of claims 25 and 26 comprising winding metal sheet stock on a roller.

29. A homopolar motor according to claim 25 wherein the at least one electrically conductive rotatable rotor comprises a current channeling material.

30. A homopolar generator according to claim 26 wherein the at least one electrically conductive rotatable rotor comprises a current channeling material

31. A homopolar motor according to claim 15 and having at least two electrical brushes configured to produce multiple intersections of the current path by said magnetic field between said two brushes such as to induce electromagnetic voltage in the same sense.

32. A homopolar generator according to claim 16 and having at least two electrical brushes configured to produce multiple intersections of the current path by said magnetic field between said two brushes such as to induce electromagnetic voltage in the same sense.

33. A homopolar motor according to claims 1 or 15 immersed in an electrically insulating liquid.

34. A homopolar generator according to claims 4 or 16 immersed in and electrically insulating liquid.

35. A homopolar motor according to claims 1 or 15 immersed in water.

36. A homopolar generator according to claims 4 or 16 immersed in water

37. A homopolar motor according to claims 1 or 15 immersed in a liquid whose electrical conductivity is at least four orders of magnitude lower than the electrical conductivity of said at least one electrically conductive rotatable rotor for the purpose of cooling or for the purpose of reducing brush wear.

38. A homopolar generator according to claims 4 or 16 immersed in a liquid whose electrical conductivity is at least four orders of magnitude lower than the electrical conductivity of said at least one electrically conductive rotatable rotor for the purpose of cooling or for the purpose of reducing brush wear.

39. A homopolar motor according to claim 17, wherein said at least one rigid brush holder strip is separated from an adjoining brush holder strip by means of dielectric breakdown bonding with predetermined dielectric breakdown voltage.

40. A homopolar generator according to claim 18, wherein said at least one rigid brush holder strip is separated from an adjoining brush holder strip by means of dielectric breakdown bonding with predetermined dielectric breakdown voltage.

41. A homopolar motor according to claim 37, wherein the dielectric in said dielectric breakdown bonding comprises oxidized aluminum foil.

42. A homopolar generator according to claim 38, wherein the dielectric in said dielectric breakdown bonding comprises oxidized aluminum foil.
